(19) United States
(12) Patent Application Publication
(10) Pub. No.: US 2025/0101186 A1
(43) Pub. Date: Mar. 27, 2025

(54) HYDROGELS AND METHODS OF PREPARING THE SAME

(71) Applicant: Nanyang Technological University, Singapore (SG)

(72) Inventors: Hong Li, Singapore (SG); Jipeng Fei, Singapore (SG)

(21) Appl. No.: 18/718,165

(22) PCT Filed: Dec. 8, 2022
(86) PCT No.: PCT/SG2022/050894

§ 371 Date: Jun. 10, 2024

(30) Foreign Application Priority Data
Dec. 8, 2021 (SG) 10202113624U

(51) Int. Cl. C08J 3/075; C08J 3/24; C08K 3/30; C08K 5/07

(52) U.S. Cl. CPC C08J 3/075; C08J 3/24; C08K 3/30; C08K 5/07; C08J 2300/14; C08J 2329/04; C08K 2003/3045

(57) ABSTRACT

The present disclosure refers to a method of preparing a hydrogel, comprising: (i) preparing a mixture of water-soluble polymer, inorganic acid, and radiation-reflecting inorganic particles; (ii) adding a crosslinking agent to the mixture to form a hydrogel precursor; (iii) freezing and thawing the hydrogel precursor thereby forming a hydrogel, wherein the hydrogel precursor comprises: about 5 wt % to about 30 wt % of water-soluble polymer; about 0.3 wt % to about 2.5 wt % of inorganic acid; about 0.05 wt % to about 0.5 wt % of crosslinking agent; and about 3 wt % to about 70 wt % of a radiation-reflecting inorganic particle, wherein the wt % is based on the total weight of the hydrogel precursor. The present disclosure also refers to a hydrogel precursor, and a hydrogel obtained by the method disclosed herein. The present disclosure also refers to a hydrogel comprising: about 5 wt % to about 30 wt % of water-soluble polymer; about 0.1 wt % to about 1.5 wt % of crosslinking agent; and about 3 wt % to about 70 wt % of a radiation-reflecting inorganic particle, wherein the wt % is based on the total weight of the hydrogel.

### CROSS REFERENCE TO RELATED APPLICATIONS

This application is a national stage application of PCT/SG2022/050894 filed on Dec. 8, 2022, which claims the priority benefit of Singapore Patent Application No. 10202113624U filed on Dec. 8, 2021, the contents of which are hereby incorporated by reference in their entirety for all purposes.

### TECHNICAL FIELD

The present invention generally relates to hydrogels for use in cooling applications. The present invention also relates to a method of preparing said hydrogels.

### BACKGROUND ART

With the increase in temperatures, cooling is the fastest growing use of energy in buildings and constructions, particularly in tropical regions. Energy use for cooling in buildings has doubled since year 2000, resulting in significant energy consumption and carbon emission, especially in regions such as Singapore. In Singapore, buildings use half of Singapore's electricity, of which 95% comes from natural gas, and cooling is responsible for over 60% electricity consumption in non-residential buildings. Thus, to save energy and electricity, developing energy-saving cooling strategies is crucial. This also urgently calls for low-carbon technologies and solutions, which may also contribute to achieving 26th United Nations Climate Change Conference of the Parties (COP26)'s goal of net-zero carbon emission, carbon neutrality and sustainability.

Apart from available cooling technologies such as air conditioners, passive cooling which is free of energy consumption may be implemented to reduce and minimise energy demand for cooling. Passive cooling includes various strategies such as evaporative cooling, radiative cooling, high solar reflection, heat insulation and more. Passive cooling uses renewable and free energy to provide cooling. Evaporative cooling is one such passive cooling techniques which works on a principle where water is evaporated in air, and transits from a liquid to a gas. This transition requires energy, which is extracted from the air in the form of heat. Water evaporation absorbs heat from its surroundings and decreases its temperature. As a result of the evaporating cooling process, the air is cooled down. Typically, water evaporation on the roof of buildings and constructions may be used to cool down the indoor air and decrease the indoor temperature. For example, a 150-liter tank may be connected to a hydraulic circuit that contains a grid of ten parallel PVC tubes. Layers of gunny bag cloth may be used to cover a roof. Each PVC tube may have ten sprinklers to keep the layers of gunny bag cloth and the roof continuously wet. The wet roof may decrease the indoor temperature by 1° C. Conventionally, water evaporative cooling designs such as water-retaining roof brick on the roof could also decrease the indoor temperature. The brick may consist of a water container with maximum water depth of 12 cm. When the water evaporates under sunshine and wind blowing, the indoor temperature may be decreased by 1.9° C. However, evaporative cooling is far from optimal in terms of cooling power per unit water consumption. Furthermore, salts and mineral deposits may build up which require removal and extensive maintenance. Another drawback is that evaporative cooling is unsuitable for use in areas with high humidity.

Radiative cooling is another passive cooling technology. It is an energy-saving surficial cooling approach and is typically achieved by long-wavelength infrared (LWIR) emission into outer space through the atmospheric window, of 8 μm to 13 μm, to reach lower surficial temperature. Conventionally, these passive radiative cooling surfaces which are solar reflective, and heat emissive surfaces may be made of various material, for example, coatings, films, layers, and gels and compositions such as polymers and synthetic chemicals. Daytime sub-ambient cooling is achievable when the PRC has an ultrahigh solar reflectivity (Rₛₒₗₐᵣ) of more than 94% to reduce solar heat gain. To reach sub-ambient cooling performance at daytime, prevention of solar heat gain is regarded as preliminary request, being tackled by solar reflective structural design. Typically, the developed passive radiative cooling materials continuously dissipate heat through LWIR emission (E_{LWIR}), which is dominated by the intrinsic bond vibration. LWIR radiation strongly depends on natural atmospheric window—which is an uncontrollable factor that is affected by local weather conditions, including rain, humidity, cloud density and more. Theoretically, dry area with clear sky and consistent sunny days are most favoured for conventional radiative cooling surface.

However, one of the main challenges of these PRCs is that the LWIR emission in tropical region is significantly hindered by the high relative humidity (RH) and strong solar radiation, where the resulting cooling power may be halved. Furthermore, sub-ambient radiative cooling is not achievable with more than 1000 W/m² solar irradiance in tropic climate even with the best conventional PRC (Rₛₒₗₐᵣ=97%, E_{LWIR}=96%). Passive radiative cooling in tropical climate (e.g., in Singapore, 1.3477N 103.6816E) is challenging due to the high humidity (of 84% on average), abundant rainfall (of about 167 days annually), intense solar radiation, and strong downward atmospheric radiation, which halve the radiative cooling potential. Furthermore, there is no report of outdoor sub-ambient radiative cooling under one-Sun radiation (of about 1000 W/m² solar irradiance) in tropical climate.

Conventional radiative cooling can reflect sunlight and emit LWIR to outer space through atmospheric window. Lower surface temperature was achieved with continuous LWIR radiation, exhibiting potential cooling power up to 150 W/m² in areas with favoured weather conditions. In tropical areas like Singapore, the radiative cooling performance is largely alleviated, with a maximum 70 W/m² cooling potential left due to high humidity and downwelling atmospheric radiation, while abundant clouds further decrease it to just about 50 W/m². Though the performance of radiative cooling is much better than conventional heat isolation coating, the goal for sub-ambient cooling is hard to achieve when considering all factors including high solar power density, high humidity, high air temperature as well as frequent shower rains in tropic areas.

Hence, there is a need to provide a material that overcomes, or at least ameliorates, one or more of the disadvantages described above. Furthermore, other desirable features and characteristics will become apparent from the subsequent detailed description and the appended claims, taken in conjunction with the accompanying figures and this background of the disclosure.

### SUMMARY

According to a first aspect, there is provided a method of preparing a hydrogel, comprising:
(i) preparing a mixture of water-soluble polymer, inorganic acid, and radiation-reflecting inorganic particles;
(ii) adding a crosslinking agent to the mixture to form a hydrogel precursor;
(iii) freezing and thawing the hydrogel precursor thereby forming a hydrogel,
wherein the hydrogel precursor comprises:
   about 5 wt % to about 30 wt % of water-soluble polymer;
   about 0.3 wt % to about 2.5 wt % of inorganic acid;
   about 0.05 wt % to about 0.5 wt % of crosslinking agent; and
   about 3 wt % to about 70 wt % of a radiation-reflecting inorganic particle,
   wherein the wt % is based on the total weight of the hydrogel precursor.

Advantageously, the method of preparing the hydrogel is a simple, scalable and cost-effective manufacturing process for mass production. The method disclosed is simple and easy to perform which can be conducted easily in manufacturing facilities and laboratories.

The method of adding a crosslinking agent to the mixture to form a hydrogel precursor may produce chemical crosslinks in the hydrogel. The method of freezing and thawing the hydrogel precursor may produce physical crosslinks in the hydrogel. This advantage produces a hydrogel with multi-crosslinks, which comprises a hydrogel with both physical and chemical crosslinks. Advantageously, with both physical and chemical crosslinks in the hydrogel, this may provide a better and more stable hydrogel with longer lifetime and better structural integrity of the hydrogel.

According to another aspect, there is provided a hydrogel precursor for forming a hydrogel comprising:
about 5 wt % to about 30 wt % of water-soluble polymer;
about 0.3 wt % to about 2.5 wt % of inorganic acid;
about 0.05 wt % to about 0.5 wt % of crosslinking agent; and
about 3 wt % to about 70 wt % of a radiation-reflecting inorganic particle,
   wherein the wt % is based on the total weight of the hydrogel precursor.

Advantageously, the hydrogel precursor comprises water-soluble polymer, inorganic acid, crosslinking agent and radiation-reflecting inorganic particle which may be purchased or obtained easily. Also advantageously, the hydrogel precursor may be easily combined, mixed, incorporated or integrated with other materials in order to further enhance the hydrogel's stability and mechanical properties.

According to yet another aspect, there is provided a hydrogel obtained by the method as disclosed herein.

According to a further aspect, there is provided a hydrogel prepared by freeze-thawing the hydrogel precursor as disclosed herein.

According to another aspect, there is a hydrogel comprising:
about 5 wt % to about 30 wt % of water-soluble polymer;
about 0.1 wt % to about 1.5 wt % of crosslinking agent; and
about 3 wt % to about 70 wt % of a radiation-reflecting inorganic particle,
wherein the wt % is based on the total weight of the hydrogel.

Advantageously, the hydrogel may comprise chemical and physical crosslinks. With both physical and chemical crosslinks, the hydrogel exhibits improved stability and mechanical strength. With the improved stability and mechanical strength, this results in a hydrogel with a longer lifetime which translates to cost-efficiency and cost-effectiveness in the long run.

Also advantageously, the hydrogel may be able to act as a cooler. The hydrogel may be able to utilize both evaporative and radiative cooling techniques to cooperatively achieve passive cooling. This allows the hydrogel to cool high temperatures, for example in harsh tropical weather conditions. The combination of evaporative cooling and radiative cooling in the hydrogel may lead to unprecedented sub-ambient cooling performance even in weather conditions that are unfavored for conventional passive cooling technologies. The hydrogel may provide an efficient heat isolation layer through high radiation reflection and low thermal conductivity which enables cooling.

Further advantageously, the hydrogel may be combined, mixed, incorporated or integrated with other materials in order to further enhance its stability and mechanical properties. Furthermore, the hydrogel is easy to apply and may be used in various applications, materials and surfaces for cooling.

One such application of the hydrogel includes a use of hydrogel on buildings for cooling. The hydrogel may be applied on the walls and/or roofs of a building. Typically, cooling performance and efficiency of radiative cooling is dependent on the radiation exposure and it may be weakened on sidewalls of a building due to insufficient radiation through atmospheric window and radiation exposure arising from the tilted angle from a building. However, with the combination of both evaporative and radiative cooling in the hydrogel of the present invention, the hydrogel further advantageously offers and provides cooling even on sidewalls or blocked surfaces. The hydrogel may thus transfer heat better and enable better cooling performance and efficiency on all available sides of a building or and object applied/coated with the hydrogel. Also advantageously, the hydrogel with low solar reflectance (in turn reduces the dazzling effect under intensive sunlight), along with excellent fire-retardant performance, makes it suitable for industrial applications such as paints and coatings for buildings and construction.

Also advantageously, the hydrogel may be a simple, easy to use/apply coating that is applicable to various surfaces of buildings/constructions such as roofs, sidewalls and walls, as well as other applications, e.g., refrigerated vehicles for cold chain, PV panel cooling, or other fields.

According to yet another aspect, there is provided a fabric-supported hydrogel comprising a fabric and the hydrogel as disclosed herein.

Advantageously, the fabric-supported hydrogel may also demonstrate enhanced mechanical stability in terms of durability, foldability, flexibility, and puncture-resistance. Furthermore, the hydrogel is easy to apply and may be used in various applications, materials and surfaces for cooling.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

Unless the context requires otherwise or specifically stated to the contrary, integers, steps, or elements of the invention recited herein as singular integers, steps or elements clearly encompass both singular and plural forms of the recited integers, steps or elements.

The following words and terms used herein shall have the meaning indicated:

As used herein, the term ‘radiation-reflecting’ refers to a property where radiation is reflected. It is a property of a substance/object/medium/surface where radiation is reflected when an incoming radiation bounces off the substance/object/medium/surface and being scattered, which is not transformed into heat.

As used herein, the term ‘crosslink’ or ‘crosslinked’ is to be interpreted broadly to refer to the process of forming covalent bonds or relatively short sequences of chemical bonds or interactions to join several polymer chains together. The crosslink may either be chemically crosslinked through a chemical bond (e.g., covalent) and/or physically crosslinked through a physical bond (e.g., molecules entanglement, hydrogen bond, hydrophobic interaction, or crystallization of polymer chain) and a combination of both. Crosslinked polymers are those polymers that are obtained when a crosslink bond is formed between the monomeric units. Crosslinks may exist between separate molecules (e.g. different polymers, different monomers) and may also exist between different points of the same molecule.

The term ‘chemical crosslinking’ or ‘chemical crosslink’ refers to intermolecular or intramolecular joining of two or more molecules by a covalent bond. Chemical crosslinked polymer leads to the formation of long chains which can be either branched or linear, that can create covalent bonds between the polymeric molecules.

The term ‘physical crosslinking’ or ‘physical crosslink’ refers to formations of a bond between polymer chains through interactions (e.g., molecules entanglement, hydrogen bond, hydrophobic interaction, or crystallization of polymer chain). Physical crosslinking process may rely on the use of an external energy source (freezing, radiation and etc.) to create intermediate excited transition state species, which can decompose and create hydrogen atoms and organic free radical species.

As used herein, the term ‘multi-crosslinked’ or ‘multi-crosslinking’ is to be interpreted broadly to include both physical and chemical crosslinks.

The term ‘crosslinking agent’ or ‘crosslinker’ is to be interpreted broadly to include any chemicals added or used to form chemical bonds to join two or more polymer chains (e.g. polymers) together to form a crosslink.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is an illustration of the working principles of a moist state hydrogel of the present invention, where (a) represents LWIR emission, (b) represents water channel, (c) represents radiation-reflecting inorganic particles, and (d) represents polymer matrix.

FIG. 2 is an illustration of the working principles of a dry state hydrogel of the present invention, where (a) represents LWIR emission, (b) represents pore-air interface, (c) represents radiation-reflecting inorganic particles, (d) represents polymer matrix, and (e) indicates the pore-air interface and radiation-reflecting inorganic particles are able to reflect radiation (e.g. radiation-reflecting).

FIG. 3 is a schematic illustration of a hydrogel of the present invention where the grey section ( [symbol] ) represents free water, the circle (∘) represents a radiation-reflecting inorganic particle and the wavy lines ( [symbol] ) represents a polymeric chain.

FIG. 4 is a schematic illustration of the working principles of a hydrogel in moist state in accordance with the present invention, where (1) represents radiation reflection (e.g. solar reflection), (2) represents radiation blocking (e.g. solar blocking), (3) represents water evaporation, (4) represents LWIR emission, (5) represents heat exchange and (6) represents water transport.

FIG. 5 is a schematic illustration of the working principles of a hydrogel in dry state in accordance with the present invention, where (1) represents radiation reflection (e.g. solar reflection), (2) represents radiation blocking (e.g. solar blocking), (3) represents LWIR emission, (4) represents porous structure of the hydrogel coating, and (5) represents heat exchange.

FIG. 6 is an illustration showing a utilization of solar energy as cooling enhancement in moist hydrogel, where (a) shows the hydrogel without solar energy input with parasitic heat transfer (1) and water evaporation (2); and (b) shows the hydrogel with solar energy input (4) with parasitic heat transfer (1) and enhanced water evaporation (3).

FIG. 7a is a graph showing a comparison of water content and bound water ratio within Pure-Gel and Metagel-2.

FIG. 7b is a graph showing a storage and loss modulus of Pure-Gel and Metagel-2.

FIG. 7c is a graph showing a Differential Scanning Calorimeter (DSC) thermogram of water evaporation (a graph of heat flow (W/g) against temperature (° C.)) within Pure-Gel and Metagel-2, with insets of schematic structures.

FIG. 7d is a graph (of intensity against wavenumber) showing Raman OH stretching mode of Pure-Gel and Metagel-2, where FW indicates free water and IW indicates intermediate water.

FIG. 7e is a graph showing a comparison on cooling performance (ACD and cooling cycle duration) with controlled water quantity exhibited by a water layer and a 10-mm-thick Metagel-2.

FIG. 7f is a graph showing an indoor evaporative cooling comparison and temperature rising comparison (under solar illumination) between Pure-Gel and Metagel-2, measured at a relative humidity of 60%±3% and solar intensity of 1000 W/m².

FIG. 7g is a graph showing a theoretical ACD of Metagel-2 at different thicknesses based on average tropical climate with reference to bare concrete (black dotted line) and state-of-the-art passive radiative cooler (PRC; grey line) with Rₛₒₗₐᵣ˜98%, E_{LWIR}˜98%, and thickness˜500 μm.

FIG. 7h is a graph showing a thickness-dependent reciprocal ACD and cooling efficiency of Metagel-2 at different thicknesses.

FIG. 7i is a graph showing a solar intensity dependent output power density by evaporative (Pₑᵥₚ) and radiative (P_{rad}) cooling, and net output power density (Pₙₑₜ) of Metagel-2.

FIG. 8 is an optical image (photograph) showing the comparison of (1) hydrogel which is crosslinked with sulfuric acid, and (2) hydrogel which is crosslinked without sulfuric acid, after an hour (one hour) of adding crosslinking agent. Apart from the use of sulfuric acid, the same components are used. The (1) hydrogel which is crosslinked with sulfuric acid, is crosslinked within five minutes.

FIG. 9 (a) is an optical photograph showing the setup for precise recording, where solar shields are applied to prevent total diffused sunlight, and a pyrgeometer is used to record downwelling atmospheric radiation (DLR); and (b) is a graph showing the monitored rooftop radiations (solar and NIR-LWIR range) during a typical sunny day in Nanyang Technological University, Singapore.

FIG. 10a is a graph of concentration of NIH 3T3 fibroblast cells against cultivation time, showing the bio-compatibility test of a control and Metagel-2.

FIG. 10b is an optical image of Metagel-2 in accordance with the present invention with a dimension (18 cm×9 cm×2 mm) used in skin cooling test.

FIG. 10c is an optical image showing configuration of Metagel-2 (2 mm) that is tightly attached on skin (same configuration in FIG. 19f).

FIG. 10d is an IR image of Metagel-2 covered skin under indoor conditions where the IR images in FIG. 10d and FIG. 19f are all taken after a 20-minute stabilization.

FIG. 11a is a graph showing a 300-1300 nm reflectance of a hydrogel with increasing content of BaSO₄ particles (Pure-Gel; Metagel-1; Metagel-2; and Metagel-4).

FIG. 11b is a graph showing solar reflectance (solid line, left y-axis) and transmittance (dotted line, right y-axis) of Metagel-2 with different thicknesses.

FIG. 11c is a bar chart showing solar reflectance (grey) and transmittance (black) of Metagel-2 with different thicknesses.

FIG. 12 is a graph showing an attenuated total reflection (ATR)-Fourier-Transform Infrared (FTIR) spectrum of Pure-Gel and water-free Metagel-2, where left panel represents OH stretching mode and right panel represents OH bending mode. The peak positions and shift directions are labelled.

FIG. 13a is a bar chart showing the specific heat flow from a low temperature of −30° C. to 30° C. (left y-axis) and water mass (right y-axis) of different hydrogels from the measurements of Differential Scanning Calorimetry (DSC).

FIG. 13b is a graph showing the calculated bound water content (%) within different hydrogels.

FIG. 14 is a bar graph showing the thermal conductivity of Metagel-2 under different wet and dry states. The range of thermal conductivity of pure PVA hydrogel in dry state is shaded (M) as shown in the figure for comparison.

FIG. 15 shows heat transfer models for theoretical analysis; where (a) shows a heat transfer model based on experimental setup in field test for validating the simulation accuracy, where side evaporation is also considered; and (b) shows a periodic heat transfer model when considering a large enough surface area, where side evaporation is neglected. A human comfortable indoor temperature (Ti, =25° C.) is maintained for evaluation of active cooling demand with different surface covers. All data presented in this work are based on periodic model.

FIG. 16 shows a Raman spectrum (upper panel, where FW indicates free water and IW indicates intermediate water) and related IW/FW ratio (lower panel) within different hydrogels (Pure-Gel; Metagel-2; and Metagel-4).

FIG. 17a is a graph (upper) showing the recorded temperature of cooled aluminium (Al) substrate using two cooling systems (one using a bare aluminium with conventional spray cooling, and the other using Metagel-2), where atmospheric conditions, including ambient temperature, solar intensity and RH are recorded in the lower graph for reference.

FIG. 17b is an optical image (left) and schematic (left) of setup for comparison between hydrogel and conventional evaporative cooling by spraying water.

FIG. 18a is a schematic illustration of the setup for indoor evaporating cooling test.

FIG. 18b is a graph showing the temperature recording during indoor evaporative cooling test of Pure-Gel (4 mm).

FIG. 18c is a graph showing the temperature recording during indoor evaporative cooling test of Metagel-2 (4 mm), where the introduction of solar illumination (1000 W/m²) proves the effectiveness of sub-ambient passive cooling in Metagel-2.

FIG. 19a is a graph showing a recorded temperature profile of 24-h indoor passive cooling where the inset illustrates an IR image of Metagel-2.

FIG. 19b is a graph showing an outdoor cooling performance of Metagel-2 at daytime of a typical sunny day, where atmospheric conditions, including ambient temperature (upper graph), solar intensity and RH (in lower graph) are recorded for reference.

FIG. 19c is a graph showing an outdoor cooling performance of Metagel-2 at night-time of a typical day, where atmospheric conditions, including ambient temperature (upper graph), solar intensity and RH (in lower graph) are recorded for reference.

FIG. 19d is a graph showing a metagel-2 sidewall (outdoor) cooling performance compared with the state-of-the-art passive radiative cooler PRC (radiative cooler side wall; and radiative cooler rooftop), where atmospheric conditions, including ambient temperature (upper graph), solar intensity and RH (in lower graph) are recorded for reference.

FIG. 19e is a graph showing an outdoor sub-ambient cooling achieved by coloured Metagel-2 (green, red and yellow); where atmospheric conditions, including ambient temperature, solar intensity, RH, and downwelling radiation (DLR), are recorded for reference.

FIG. 19f is an IR image showing outdoor sub-ambient cooling on human skin (the same Metagel-2 sample as that in FIG. 10c), measured at an air temperature of 33° C., a relative humidity of 60% and solar intensity of 1000 W/m² (z 1 Sun). IR images of FIG. 10d and FIG. 19f are all taken after a 20-minute stabilization.

FIG. 20a is a graph showing the optical properties, i.e., solar reflectance (left y-axis) and LWIR emissivity (right y-axis) of Metagel-2 and the best reported radiative cooler used for sidewall cooling (e.g. Radiative Cooler Rooftop and Radiative Cooler Sidewall).

FIG. 20b is a graph showing the visible reflectance spectrum of controlled hydrogels with different BaSO₄ content (Metagel-0.1; Metagel-0.5; and Metagel-1), where the inset shows the optical images of corresponding hydrogels under sunlight.

FIG. 20c is a graph showing the visible reflectance spectrum of a typical commercial solar reflective construction paint (NIPPON SOLAREFLECT Si).

FIG. 21 is an optical photograph showing the fire safety and retardant performance evaluation of Metagel-2 under direct burning at different directions (horizontal and vertical), where the applied Metagel-2 has a thickness of 4 mm.

FIG. 22 shows several optical images (photographs) demonstrating the mechanical properties (brittleness, flexibility, elasticity and puncture-ability) of (A) free-standing chemical crosslinked metagel, (B) free-standing physical crosslinked metagel and (C) fabric-supported multi-crosslinked metagel (comprising both physical and chemical crosslinks).

FIG. 23 is a graph showing the tensile test results (Force (N) against Elongation (mm)) of a hydrogel with different crosslinking method, where chemical crosslinked is conducted with glutaraldehyde as a crosslinking agent; physical crosslinked is conducted with freeze-thawing method; and fabric-supported multi-crosslinked is with both chemical crosslinking method (with glutaraldehyde as crosslinking agent) and freeze thawing method, and fabric skeleton.

FIG. 24a is a schematic illustration showing cooling mechanisms of an APC.

FIG. 24b is a schematic illustration showing the working principles, cooling processes and active cooling demand (ACD) maintaining at comfortable indoor temperature with bare (left) and hydrogel-covered (right) concretes.

FIG. 24c is a graph showing a simulated scattering efficiency (300-1300 nm) with varying sizes of barium sulfate particles (BSP).

FIG. 24d shows a structural illustration (upper) of Metagel-2 and scanning electron microscope (SEM) image (lower left, scale bar is 1 μm) of Metagel-2, and a graph of BSP size distribution (lower right) in Metagel-2.

FIG. 24e is a graph showing a solar reflectance (%) spectrum of Pure-Gel in wet state, Metagel-2 in wet state and Metagel-2 in dry state (shaded area indicates the reflectance difference between the dry and wet Metagel-2).

FIG. 24f is a graph showing a transmittance (%) spectrum of Pure-Gel in wet state, Metagel-2 in wet state, and Metagel-2 in dry state.

FIG. 24g is an optical image (a photograph, upper) and infrared (IR) image (lower) of Metagel-2 under sunlight taken after 30-minute stabilization where ambient temperature is about 33° C., solar irradiation is about 1045 W/m², and relative humidity (RH) is at about 60%.

FIG. 24h is a graph showing a long-wave infrared (LWIR) emittance spectrum of Metagel-2 in wet (solid lines) and dry (dotted lines) states, where shaded area labels the atmospheric window.

FIG. 25 is an optical image showing a Scanning Electron Microscopic (SEM) image of Pure-Gel, showing the average pore size in Pure-Gel is much smaller than that in hydrogel.

FIG. 26 is a graph showing the heat flow of pure water and Metagel-2 from water evaporation.

FIG. 27 is a graph showing the simulated temperature difference on the top surface (solid lines) and on the interface (dotted lines) depending on various evaporation enthalpy at 1500, 2000, and 2500 J/g.

FIG. 28 is a graph showing the indoor test temperature recording of Metagel-2 at different thicknesses (4 mm, 6 mm and 8 mm). All samples were prepared with a diameter of 10 cm (circular film) to minimize the influence of edge surface.

FIG. 29 is a bar graph showing the water content monitoring of Metagel-2 with various thicknesses where the bar graph (using the left y-axis) shows the water weight of the different types of Metagel-2 (saturated, shrinking and dried) at thickness of 2 mm, 4 mm and 6 mm; and where the line graph (using the right y-axis) shows the water ratio at shrinkage point of Metagel-2 with various thicknesses of 2 mm, 4 mm and 6 mm.

FIG. 30 is a line graph showing the length of theoretical cyclic cooling duration of Metagel-2 of various thicknesses in Singapore climate (e.g. at daytime of a sunny day) measured at an ambient temperature of 32° C., a relative humidity of 60% and solar intensity of 1000 W/m² (z 1 Sun). The estimated value represents shortest length since the average solar intensity is maintained constant at 1000 W/m².

FIG. 31a is a bar chart showing the solar range optical spectrum (solar reflectance and transmittance, in percentages) of coloured Metagel-2 in a field test.

FIG. 31b is a graph showing the LWIR emittance of coloured Metagel-2 in a field test.

FIG. 32a is a schematic illustration of a cold chain truck with smart F&B storage container where an oxygen removal (OR)-regulator circuit (RC)-electrical load (EL) unit is attached to the cover; part 1 is a flexible and/or movable door/parts for maintaining the pressure inside the container when oxygen molecules are removed by the OR component; part 2 is a hydrogel coating to maintain the moisture level inside the container; part 3 is a reflective hydrogel for both indoor and outdoor cooling.

FIG. 32b is a schematic showing a circuit of an OR-RC-EL unit.

FIG. 32c is a schematic showing a redox reaction inside the OR unit.

FIG. 32d is an optical image showing a prototype of a passive water chiller where the left image is a schematic geometry of hydrogel coating copper cooling coil, and the right image shows a prototype.

FIG. 33 is a schematic illustration showing a fabric-supported hydrogel comprising a fabric and the hydrogel of the present invention.

### DETAILED DESCRIPTION OF EMBODIMENTS

The following detailed description is merely exemplary in nature and is not intended to limit the invention or the application and uses of the invention. Furthermore, there is no intention to be bound by any theory presented in the preceding background of the invention or the following detailed description. It is the intent of the present invention to present a passive radiative cooling technology and material that overcomes, or at least ameliorates, one or more of the disadvantages described earlier in the background of the disclosure.

To address the challenges discussed in the background earlier, the inventors combine water evaporation with conventional radiative cooling in a polymeric hydrogel coating. Compared to radiative cooling alone, combinational passive cooling strategy of the present invention contains dynamic evaporative cooling and radiative cooling processes, leading to greatly enhanced cooling performance.

Sub-ambient passive cooling in tropical climate may be achieved in this present invention by rational integration of various strategies in a material for cooling, which can dynamically adjust the contribution of individual cooling strategy according to the ambient conditions.

Exemplary, non-limiting embodiments of a hydrogel will now be disclosed. Hydrogels of the present invention includes a water-insoluble, three-dimensional network of polymer chains capable of holding large amounts of water. These hydrogels may swell in water and hold a large amount of water while maintaining its structure due to both physical and chemical crosslinks.

### Hydrogel Precursor

The present invention relates to a hydrogel precursor comprising about 5 wt % to about 30 wt % of water-soluble polymer; about 0.3 wt % to about 2.5 wt % of inorganic acid; about 0.05 wt % to about 0.5 wt % of crosslinking agent; and about 3 wt % to about 70 wt % of a radiation-reflecting inorganic particle, wherein the wt % is based on the total weight of the hydrogel precursor.

### Water-Soluble Polymer

The hydrogel precursor may comprise about 5 wt % to about 30 wt % of water-soluble polymer, about 5 wt % to about 29.5 wt %, about 5 wt % to about 29 wt %, about 5 wt % to about 28.5 wt %, about 5 wt % to about 28 wt %, about 5 wt % to about 27.5 wt %, about 5 wt % to about 27 wt %, about 5 wt % to about 26.5 wt %, about 5 wt % to about 26 wt %, about 5 wt % to about 25.5 wt %, about 5 wt % to about 25 wt %, about 5 wt % to about 24.5 wt %, about 5 wt % to about 24 wt %, about 5 wt % to about 23.5 wt %, about 5 wt % to about 23 wt %, about 5 wt % to about 22.5 wt %, about 5 wt % to about 22 wt %, about 5 wt % to about 21.5 wt %, about 5 wt % to about 21 wt %, about 5 wt % to about 20.5 wt %, about 5 wt % to about 20 wt %, about 5 wt % to about 19.5 wt %, about 5 wt % to about 19 wt %, about 5 wt % to about 18.5 wt %, about 5 wt % to about 18 wt %, about 5 wt % to about 17.5 wt %, about 5 wt % to about 17 wt %, about 5 wt % to about 16.5 wt %, about 5 wt % to about 16 wt %, about 5 wt % to about 15.5 wt %, about 5 wt % to about 15 wt %, about 5 wt % to about 14.5 wt %, about 5 wt % to about 14 wt %, about 5 wt % to about 13.5 wt %, about 5 wt % to about 13 wt %, about 5 wt % to about 12.5 wt %, about 5 wt % to about 12 wt %, about 5 wt % to about 11.5 wt %, about 5 wt % to about 11 wt %, about 5 wt % to about 10.5 wt %, about 5 wt % to about 10 wt %, about 5 wt % to about 9.5 wt %, about 5 wt % to about 9 wt %, about 5 wt % to about 8.5 wt %, about 5 wt % to about 8 wt %, about 5 wt % to about 7.5 wt %, about 5 wt % to about 7 wt %, about 5 wt % to about 6.5 wt %, about 5 wt % to about 6 wt %, about 5 wt % to about 5.5 wt %, about 5.5 wt % to about 30 wt %, about 6 wt % to about 30 wt %, about 6.5 wt % to about 30 wt %, about 7 wt % to about 30 wt %, about 7.5 wt % to about 30 wt %, about 8 wt % to about 30 wt %, about 8.5 wt % to about 30 wt %, about 9 wt % to about 30 wt %, about 9.5 wt % to about 30 wt %, about 10 wt % to about 30 wt %, about 10.5 wt % to about 30 wt %, about 11 wt % to about 30 wt %, about 11.5 wt % to about 30 wt %, about 12 wt % to about 30 wt %, about 12.5 wt % to about 30 wt %, about 13 wt % to about 30 wt %, about 13.5 wt % to about 30 wt %, about 14 wt % to about 30 wt %, about 14.5 wt % to about 30 wt %, about 15 wt % to about 30 wt %, about 15.5 wt % to about 30 wt %, about 16 wt % to about 30 wt %, about 16.5 wt % to about 30 wt %, about 17 wt % to about 30 wt %, about 17.5 wt % to about 30 wt %, about 18 wt % to about 30 wt %, about 18.5 wt % to about 30 wt %, about 19 wt % to about 30 wt %, about 19.5 wt % to about 30 wt %, about 20 wt % to about 30 wt %, about 20.5 wt % to about 30 wt %, about 21 wt % to about 30 wt %, about 21.5 wt % to about 30 wt %, about 22 wt % to about 30 wt %, about 22.5 wt % to about 30 wt %, about 23 wt % to about 30 wt %, about 23.5 wt % to about 30 wt %, about 24 wt % to about 30 wt %, about 24.5 wt % to about 30 wt %, about 25 wt % to about 30 wt %, about 25.5 wt % to about 30 wt %, about 26 wt % to about 30 wt %, about 26.5 wt % to about 30 wt %, about 27 wt % to about 30 wt %, about 27.5 wt % to about 30 wt %, about 28 wt % to about 30 wt %, about 28.5 wt % to about 30 wt %, about 29 wt % to about 30 wt %, about 29.5 wt % to about 30 wt %, about 5 wt %, about 5.1 wt %, about 5.2 wt %, about 5.3 wt %, about 5.4 wt %, about 5.5 wt %, about 5.6 wt %, about 5.7 wt %, about 5.8 wt %, about 5.9 wt %, about 6 wt %, about 6.1 wt %, about 6.2 wt %, about 6.3 wt %, about 6.4 wt %, about 6.5 wt %, about 6.6 wt %, about 6.7 wt %, about 6.8 wt %, about 6.9 wt %, about 7 wt %, about 7.1 wt %, about 7.2 wt %, about 7.3 wt %, about 7.4 wt %, about 7.5 wt %, about 7.6 wt %, about 7.7 wt %, about 7.8 wt %, about 7.9 wt %, about 8 wt %, about 8.1 wt %, about 8.2 wt %, about 8.3 wt %, about 8.4 wt %, about 8.5 wt %, about 8.6 wt %, about 8.7 wt %, about 8.8 wt %, about 8.9 wt %, about 9 wt %, about 9.1 wt %, about 9.2 wt %, about 9.3 wt %, about 9.4 wt %, about 9.5 wt %, about 9.6 wt %, about 9.7 wt %, about 9.8 wt %, about 9.9 wt %, about 10 wt %, about 10.1 wt %, about 10.2 wt %, about 10.3 wt %, about 10.4 wt %, about 10.5 wt %, about 10.6 wt %, about 10.7 wt %, about 10.8 wt %, about 10.9 wt %, about 11 wt %, about 11.1 wt %, about 11.2 wt %, about 11.3 wt %, about 11.4 wt %, about 11.5 wt %, about 11.6 wt %, about 11.7 wt %, about 11.8 wt %, about 11.9 wt %, about 12 wt %, about 12.1 wt %, about 12.2 wt %, about 12.3 wt %, about 12.4 wt %, about 12.5 wt %, about 12.6 wt %, about 12.7 wt %, about 12.8 wt %, about 12.9 wt %, about 13 wt %, about 13.1 wt %, about 13.2 wt %, about 13.3 wt %, about 13.4 wt %, about 13.5 wt %, about 13.6 wt %, about 13.7 wt %, about 13.8 wt %, about 13.9 wt %, about 14 wt %, about 14.1 wt %, about 14.2 wt %, about 14.3 wt %, about 14.4 wt %, about 14.5 wt %, about 14.6 wt %, about 14.7 wt %, about 14.8 wt %, about 14.9 wt %, about 15 wt %, about 15.1 wt %, about 15.2 wt %, about 15.3 wt %, about 15.4 wt %, about 15.5 wt %, about 15.6 wt %, about 15.7 wt %, about 15.8 wt %, about 15.9 wt %, about 16 wt %, about 16.1 wt %, about 16.2 wt %, about 16.3 wt %, about 16.4 wt %, about 16.5 wt %, about 16.6 wt %, about 16.7 wt %, about 16.8 wt %, about 16.9 wt %, about 17 wt %, about 17.1 wt %, about 17.2 wt %, about 17.3 wt %, about 17.4 wt %, about 17.5 wt %, about 17.6 wt %, about 17.7 wt %, about 17.8 wt %, about 17.9 wt %, about 18 wt %, about 18.1 wt %, about 18.2 wt %, about 18.3 wt %, about 18.4 wt %, about 18.5 wt %, about 18.6 wt %, about 18.7 wt %, about 18.8 wt %, about 18.9 wt %, about 19 wt %, about 19.1 wt %, about 19.2 wt %, about 19.3 wt %, about 19.4 wt %, about 19.5 wt %, about 19.6 wt %, about 19.7 wt %, about 19.8 wt %, about 19.9 wt %, about 20 wt %, about 20.1 wt %, about 20.2 wt %, about 20.3 wt %, about 20.4 wt %, about 20.5 wt %, about 20.6 wt %, about 20.7 wt %, about 20.8 wt %, about 20.9 wt %, about 21 wt %, about 21.1 wt %, about 21.2 wt %, about 21.3 wt %, about 21.4 wt %, about 21.5 wt %, about 21.6 wt %, about 21.7 wt %, about 21.8 wt %, about 21.9 wt %, about 22 wt %, about 22.1 wt %, about 22.2 wt %, about 22.3 wt %, about 22.4 wt %, about 22.5 wt %, about 22.6 wt %, about 22.7 wt %, about 22.8 wt %, about 22.9 wt %, about 23 wt %, about 23.1 wt %, about 23.2 wt %, about 23.3 wt %, about 23.4 wt %, about 23.5 wt %, about 23.6 wt %, about 23.7 wt %, about 23.8 wt %, about 23.9 wt %, about 24 wt %, about 24.1 wt %, about 24.2 wt %, about 24.3 wt %, about 24.4 wt %, about 24.5 wt %, about 24.6 wt %, about 24.7 wt %, about 24.8 wt %, about 24.9 wt %, about 25 wt %, about 25.1 wt %, about 25.2 wt %, about 25.3 wt %, about 25.4 wt %, about 25.5 wt %, about 25.6 wt %, about 25.7 wt %, about 25.8 wt %, about 25.9 wt %, about 26 wt %, about 26.1 wt %, about 26.2 wt %, about 26.3 wt %, about 26.4 wt %, about 26.5 wt %, about 26.6 wt %, about 26.7 wt %, about 26.8 wt %, about 26.9 wt %, about 27 wt %, about 27.1 wt %, about 27.2 wt %, about 27.3 wt %, about 27.4 wt %, about 27.5 wt %, about 27.6 wt %, about 27.7 wt %, about 27.8 wt %, about 27.9 wt %, about 28 wt %, about 28.1 wt %, about 28.2 wt %, about 28.3 wt %, about 28.4 wt %, about 28.5 wt %, about 28.6 wt %, about 28.7 wt %, about 28.8 wt %, about 28.9 wt %, about 29 wt %, about 29.1 wt %, about 29.2 wt %, about 29.3 wt %, about 29.4 wt %, about 29.5 wt %, about 29.6 wt %, about 29.7 wt %, about 29.8 wt %, about 29.9 wt %, about 30 wt % of water-soluble polymer or any value or range therebetween, based on the total weight of the hydrogel precursor.

The hydrogel precursor may comprise about 5 wt % to about 25 wt % of water-soluble polymer, about 5.5 wt % to about 25 wt %, about 6 wt % to about 25 wt %, about 6.5 wt % to about 25 wt %, about 7 wt % to about 25 wt %, about 7.5 wt % to about 25 wt %, about 8 wt % to about 25 wt %, about 8.5 wt % to about 25 wt %, about 9 wt % to about 25 wt %, about 9.5 wt % to about 25 wt %, about 10 wt % to about 25 wt %, about 10.5 wt % to about 25 wt %, about 11 wt % to about 25 wt %, about 11.5 wt % to about 25 wt %, about 12 wt % to about 25 wt %, about 12.5 wt % to about 25 wt %, about 13 wt % to about 25 wt %, about 13.5 wt % to about 25 wt %, about 14 wt % to about 25 wt %, about 14.5 wt % to about 25 wt %, about 15 wt % to about 25 wt %, about 15.5 wt % to about 25 wt %, about 16 wt % to about 25 wt %, about 16.5 wt % to about 25 wt %, about 17 wt % to about 25 wt %, about 17.5 wt % to about 25 wt %, about 18 wt % to about 25 wt %, about 18.5 wt % to about 25 wt %, about 19 wt % to about 25 wt %, about 19.5 wt % to about 25 wt %, about 20 wt % to about 25 wt %, about 20.5 wt % to about 25 wt %, about 21 wt % to about 25 wt %, about 21.5 wt % to about 25 wt %, about 22 wt % to about 25 wt %, about 22.5 wt % to about 25 wt %, about 23 wt % to about 25 wt %, about 23.5 wt % to about 25 wt %, about 24 wt % to about 25 wt %, about 24.5 wt % to about 25 wt %, about 5 wt % to about 24.5 wt %, about 5 wt % to about 24 wt %, about 5 wt % to about 23.5 wt %, about 5 wt % to about 23 wt %, about 5 wt % to about 22.5 wt %, about 5 wt % to about 22 wt %, about 5 wt % to about 21.5 wt %, about 5 wt % to about 21 wt %, about 5 wt % to about 20.5 wt %, about 5 wt % to about 20 wt %, about 5 wt % to about 19.5 wt %, about 5 wt % to about 19 wt %, about 5 wt % to about 18.5 wt %, about 5 wt % to about 18 wt %, about 5 wt % to about 17.5 wt %, about 5 wt % to about 17 wt %, about 5 wt % to about 16.5 wt %, about 5 wt % to about 16 wt %, about 5 wt % to about 15.5 wt %, about 5 wt % to about 15 wt %, about 5 wt % to about 14.5 wt %, about 5 wt % to about 14 wt %, about 5 wt % to about 13.5 wt %, about 5 wt % to about 13 wt %, about 5 wt % to about 12.5 wt %, about 5 wt % to about 12 wt %, about 5 wt % to about 11.5 wt %, about 5 wt % to about 11 wt %, about 5 wt % to about 10.5 wt %, about 5 wt % to about 10 wt %, about 5 wt % to about 9.5 wt %, about 5 wt % to about 9 wt %, about 5 wt % to about 8.5 wt %, about 5 wt % to about 8 wt %, about 5 wt % to about 7.5 wt %, about 5 wt % to about 7 wt %, about 5 wt % to about 6.5 wt %, about 5 wt % to about 6 wt %, about 5 wt % to about 5.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 10.5 wt %, about 11 wt %, about 11.5 wt %, about 12 wt %, about 12.5 wt %, about 13 wt %, about 13.5 wt %, about 14 wt %, about 14.5 wt %, about 15 wt %, about 15.5 wt %, about 16 wt %, about 16.5 wt %, about 17 wt %, about 17.5 wt %, about 18 wt %, about 18.5 wt %, about 19 wt %, about 19.5 wt %, about 20 wt %, about 20.5 wt %, about 21 wt %, about 21.5 wt %, about 22 wt %, about 22.5 wt %, about 23 wt %, about 23.5 wt %, about 24 wt %, about 24.5 wt %, about 25 wt % of water-soluble polymer or any value or range therebetween, based on the total weight of the hydrogel precursor.

Molecular weight (MW) of the water-soluble polymer may be about 70,000 to about 100,000, about 75,000 to about 100,000, about 80,000 to about 100,000, about 85,000 to about 100,000, about 90,000 to about 100,000, about 95,000 to about 100,000, about 70,000 to about 95,000, about 70,000 to about 90,000, about 70,000 to about 85,000, about 70,000 to about 80,000, about 70,000 to about 75,000, about 70,000, about 72,000, about 74,000, about 76,000, about 78,000, about 80,000, about 82,000, about 84,000, about 86,000, about 88,000, about 90,000, about 92,000, about 94,000, about 96,000, about 98,000, about 100,000, or any value or range therebetween.

The water-soluble polymer may be about 97.5% to about 99.5% hydrolyzed, about 97.6% to about 99.5% hydrolyzed, about 97.7% to about 99.5% hydrolyzed, about 97.8% to about 99.5% hydrolyzed, about 97.9% to about 99.5% hydrolyzed, about 98% to about 99.5% hydrolyzed, about 98.1% to about 99.5% hydrolyzed, about 98.2% to about 99.5% hydrolyzed, about 98.3% to about 99.5% hydrolyzed, about 98.4% to about 99.5% hydrolyzed, about 98.5% to about 99.5% hydrolyzed, about 98.6% to about 99.5% hydrolyzed, about 98.7% to about 99.5% hydrolyzed, about 98.8% to about 99.5% hydrolyzed, about 98.9% to about 99.5% hydrolyzed, about 99% to about 99.5% hydrolyzed, about 99.1% to about 99.5% hydrolyzed, about 99.2% to about 99.5% hydrolyzed, about 99.3% to about 99.5% hydrolyzed, about 99.4% to about 99.5% hydrolyzed, about 97.5% to about 99.4% hydrolyzed, about 97.5% to about 99.3% hydrolyzed, about 97.5% to about 99.2% hydrolyzed, about 97.5% to about 99.1% hydrolyzed, about 97.5% to about 99% hydrolyzed, about 97.5% to about 98.9% hydrolyzed, about 97.5% to about 98.8% hydrolyzed, about 97.5% to about 98.7% hydrolyzed, about 97.5% to about 98.6% hydrolyzed, about 97.5% to about 98.5% hydrolyzed, about 97.5% to about 98.4% hydrolyzed, about 97.5% to about 98.3% hydrolyzed, about 97.5% to about 98.2% hydrolyzed, about 97.5% to about 98.1% hydrolyzed, about 97.5% to about 98% hydrolyzed, about 97.5% to about 97.9% hydrolyzed, about 97.5% to about 97.8% hydrolyzed, about 97.5% to about 97.7% hydrolyzed, about 97.5% to about 97.6% hydrolyzed, at least about 97.5%, at least about 97.6%, at least about 97.7%, at least about 97.8%, at least about 97.9%, at least about 98%, at least about 98.1%, at least about 98.2%, at least about 98.3%, at least about 98.4%, at least about 98.5%, at least about 98.6%, at least about 98.7%, at least about 98.8%, at least about 98.9%, at least about 99%, at least about 99.1%, at least about 99.2%, at least about 99.3%, at least about 99.4%, at least about 99.5%, or any value or range therebetween.

The water-soluble polymer may have a molecular weight (MW) of about 70,000 to about 100,000 and/or the water-soluble polymer may be about 97.5% to about 99.5% hydrolyzed.

The water-soluble polymer may be selected from the group consisting of poly(vinyl alcohol) (PVA), sodium alginate, gelatin, polyacrylic acid, chitosan, dextran, cellulose and polyacrylamide, polyethylene glycol, poly(ethylene oxide), poly(acrylic acid), poly(maleic acid), poly(N-isopropylacrylamide), poly(allylamine), poly(N-vinylpyrrolidone), poly(N-vinyl acetamide), poly(methacrylic acid), poly(L-lysine hydrobromide), poly(vinyl alcohol)N-methyl-4(4′-formylstyryl)pyridinium methosulfate acetal, poly(vinyl acetate), poly(N-vinylpyrrolidone), poly(vinylphosphonic acid), or any combinations thereof.

### Inorganic Acid

The hydrogel precursor may comprise about 0.3 wt % to about 2.5 wt % of inorganic acid, about 0.32 wt % to about 2.5 wt %, about 0.34 wt % to about 2.5 wt %, about 0.36 wt % to about 2.5 wt %, about 0.38 wt % to about 2.5 wt %, about 0.40 wt % to about 2.5 wt %, about 0.42 wt % to about 2.5 wt %, about 0.44 wt % to about 2.5 wt %, about 0.46 wt % to about 2.5 wt %, about 0.48 wt % to about 2.5 wt %, about 0.5 wt % to about 2.5 wt %, about 0.52 wt % to about 2.5 wt %, about 0.54 wt % to about 2.5 wt %, about 0.56 wt % to about 2.5 wt %, about 0.58 wt % to about 2.5 wt %, about 0.6 wt % to about 2.5 wt %, about 0.62 wt % to about 2.5 wt %, about 0.64 wt % to about 2.5 wt %, about 0.66 wt % to about 2.5 wt %, about 0.68 wt % to about 2.5 wt %, about 0.7 wt % to about 2.5 wt %, about 0.72 wt % to about 2.5 wt %, about 0.74 wt % to about 2.5 wt %, about 0.76 wt % to about 2.5 wt %, about 0.78 wt % to about 2.5 wt %, about 0.8 wt % to about 2.5 wt %, about 0.82 wt % to about 2.5 wt %, about 0.84 wt % to about 2.5 wt %, about 0.86 wt % to about 2.5 wt %, about 0.88 wt % to about 2.5 wt %, about 0.9 wt % to about 2.5 wt %, about 0.92 wt % to about 2.5 wt %, about 0.94 wt % to about 2.5 wt %, about 0.96 wt % to about 2.5 wt %, about 0.98 wt % to about 2.5 wt %, about 1 wt % to about 2.5 wt %, about 1.02 wt % to about 2.5 wt %, about 1.04 wt % to about 2.5 wt %, about 1.06 wt % to about 2.5 wt %, about 1.08 wt % to about 2.5 wt %, about 1.1 wt % to about 2.5 wt %, about 1.12 wt % to about 2.5 wt %, about 1.14 wt % to about 2.5 wt %, about 1.16 wt % to about 2.5 wt %, about 1.18 wt % to about 2.5 wt %, about 1.2 wt % to about 2.5 wt %, about 1.22 wt % to about 2.5 wt %, about 1.24 wt % to about 2.5 wt %, about 1.26 wt % to about 2.5 wt %, about 1.28 wt % to about 2.5 wt %, about 1.3 wt % to about 2.5 wt %, about 1.32 wt % to about 2.5 wt %, about 1.34 wt % to about 2.5 wt %, about 1.36 wt % to about 2.5 wt %, about 1.38 wt % to about 2.5 wt %, about 1.4 wt % to about 2.5 wt %, about 1.42 wt % to about 2.5 wt %, about 1.44 wt % to about 2.5 wt %, about 1.46 wt % to about 2.5 wt %, about 1.48 wt % to about 2.5 wt %, about 1.5 wt % to about 2.5 wt %, about 1.52 wt % to about 2.5 wt %, about 1.54 wt % to about 2.5 wt %, about 1.56 wt % to about 2.5 wt %, about 1.58 wt % to about 2.5 wt %, about 1.6 wt % to about 2.5 wt %, about 1.62 wt % to about 2.5 wt %, about 1.64 wt % to about 2.5 wt %, about 1.66 wt % to about 2.5 wt %, about 1.68 wt % to about 2.5 wt %, about 1.7 wt % to about 2.5 wt %, about 1.72 wt % to about 2.5 wt %, about 1.74 wt % to about 2.5 wt %, about 1.76 wt % to about 2.5 wt %, about 1.78 wt % to about 2.5 wt %, about 1.8 wt % to about 2.5 wt %, about 1.82 wt % to about 2.5 wt %, about 1.84 wt % to about 2.5 wt %, about 1.86 wt % to about 2.5 wt %, about 1.88 wt % to about 2.5 wt %, about 1.9 wt % to about 2.5 wt %, about 1.92 wt % to about 2.5 wt %, about 1.94 wt % to about 2.5 wt %, about 1.96 wt % to about 2.5 wt %, about 1.98 wt % to about 2.5 wt %, about 2 wt % to about 2.5 wt %, about 2.02 wt % to about 2.5 wt %, about 2.04 wt % to about 2.5 wt %, about 2.06 wt % to about 2.5 wt %, about 2.08 wt % to about 2.5 wt %, about 2.1 wt % to about 2.5 wt %, about 2.12 wt % to about 2.5 wt %, about 2.14 wt % to about 2.5 wt %, about 2.16 wt % to about 2.5 wt %, about 2.18 wt % to about 2.5 wt %, about 2.2 wt % to about 2.5 wt %, about 2.22 wt % to about 2.5 wt %, about 2.24 wt % to about 2.5 wt %, about 2.26 wt % to about 2.5 wt %, about 2.28 wt % to about 2.5 wt %, about 2.3 wt % to about 2.5 wt %, about 2.32 wt % to about 2.5 wt %, about 2.34 wt % to about 2.5 wt %, about 2.36 wt % to about 2.5 wt %, about 2.38 wt % to about 2.5 wt %, about 2.4 wt % to about 2.5 wt %, about 2.42 wt % to about 2.5 wt %, about 2.44 wt % to about 2.5 wt %, about 2.46 wt % to about 2.5 wt %, about 2.48 wt % to about 2.5 wt %, about 0.3 wt % to about 2.48 wt %, about 0.3 wt % to about 2.46 wt %, about 0.3 wt % to about 2.44 wt %, about 0.3 wt % to about 2.42 wt %, about 0.3 wt % to about 2.4 wt %, about 0.3 wt % to about 2.38 wt %, about 0.3 wt % to about 2.36 wt %, about 0.3 wt % to about 2.34 wt %, about 2.32 wt %, about 0.3 wt % to about 2.3 wt %, about 0.3 wt % to about 2.28 wt %, about 0.3 wt % to about 2.26 wt %, about 0.3 wt % to about 2.24 wt %, about 0.3 wt % to about 2.22 wt %, about 0.3 wt % to about 2.2 wt %, about 0.3 wt % to about 2.18 wt %, about 0.3 wt % to about 2.16 wt %, about 0.3 wt % to about 2.14 wt %, about 0.3 wt % to about 2.12 wt %, about 0.3 wt % to about 2.1 wt %, about 0.3 wt % to about 2.08 wt %, about 0.3 wt % to about 2.06 wt %, about 0.3 wt % to about 2.04 wt %, about 0.3 wt % to about 2.02 wt %, about 0.3 wt % to about 2.0 wt %, about 0.3 wt % to about 1.98 wt %, about 0.3 wt % to about 1.96 wt %, about 0.3 wt % to about 1.94 wt %, about 0.3 wt % to about 1.92 wt %, about 0.3 wt % to about 1.9 wt %, about 0.3 wt % to about 1.88 wt %, about 0.3 wt % to about 1.86 wt %, about 0.3 wt % to about 1.84 wt %, about 0.3 wt % to about 1.82 wt %, about 0.3 wt % to about 1.8 wt %, about 0.3 wt % to about 1.78 wt %, about 0.3 wt % to about 1.76 wt %, about 0.3 wt % to about 1.74 wt %, about 0.3 wt % to about 1.72 wt %, about 0.3 wt % to about 1.7 wt %, about 0.3 wt % to about 1.68 wt %, about 0.3 wt % to about 1.66 wt %, about 0.3 wt % to about 1.64 wt %, about 0.3 wt % to about 1.62 wt %, about 0.3 wt % to about 1.6 wt %, about 0.3 wt % to about 1.58 wt %, about 0.3 wt % to about 1.56 wt %, about 0.3 wt % to about 1.54 wt %, about 0.3 wt % to about 1.52 wt %, about 0.3 wt % to about 1.5 wt %, about 0.3 wt % to about 1.48 wt %, about 0.3 wt % to about 1.46 wt %, about 0.3 wt % to about 1.44 wt %, about 0.3 wt % to about 1.42 wt %, about 0.3 wt % to about 1.4 wt %, about 0.3 wt % to about 1.38 wt %, about 0.3 wt % to about 1.36 wt %, about 0.3 wt % to about 1.34 wt %, about 0.3 wt % to about 1.32 wt %, about 0.3 wt % to about 1.3 wt %, about 0.3 wt % to about 1.28 wt %, about 0.3 wt % to about 1.26 wt %, about 0.3 wt % to about 1.24 wt %, about 0.3 wt % to about 1.22 wt %, about 0.3 wt % to about 1.2 wt %, about 0.3 wt % to about 1.18 wt %, about 0.3 wt % to about 1.16 wt %, about 0.3 wt % to about 1.14 wt %, about 0.3 wt % to about 1.12 wt %, about 0.3 wt % to about 1.1 wt %, about 0.3 wt % to about 1.08 wt %, about 0.3 wt % to about 1.06 wt %, about 0.3 wt % to about 1.04 wt %, about 0.3 wt % to about 1.02 wt %, about 0.3 wt % to about 1 wt %, about 0.3 wt % to about 0.98 wt %, about 0.3 wt % to about 0.96 wt %, about 0.3 wt % to about 0.94 wt %, about 0.3 wt % to about 0.92 wt %, about 0.3 wt % to about 0.9 wt %, about 0.3 wt % to about 0.88 wt %, about 0.3 wt % to about 0.86 wt %, about 0.3 wt % to about 0.84 wt %, about 0.3 wt % to about 0.82 wt %, about 0.3 wt % to about 0.8 wt %, about 0.3 wt % to about 0.78 wt %, about 0.3 wt % to about 0.76 wt %, about 0.3 wt % to about 0.74 wt %, about 0.3 wt % to about 0.72 wt %, about 0.3 wt % to about 0.7 wt %, about 0.3 wt % to about 0.68 wt %, about 0.3 wt % to about 0.66 wt %, about 0.3 wt % to about 0.64 wt %, about 0.3 wt % to about 0.62 wt %, about 0.3 wt % to about 0.6 wt %, about 0.3 wt % to about 0.58 wt %, about 0.3 wt % to about 0.56 wt %, about 0.3 wt % to about 0.54 wt %, about 0.3 wt % to about 0.52 wt %, about 0.3 wt % to about 0.5 wt %, about 0.3 wt % to about 0.48 wt %, about 0.3 wt % to about 0.46 wt %, about 0.3 wt % to about 0.44 wt %, about 0.3 wt % to about 0.42 wt %, about 0.3 wt % to about 0.4 wt %, about 0.3 wt % to about 0.38 wt %, about 0.3 wt % to about 0.36 wt %, about 0.3 wt % to about 0.34 wt %, about 0.3 wt % to about 0.32 wt %, about 0.3 wt %, about 0.32 wt %, about 0.34 wt %, about 0.36 wt %, about 0.38 wt %, about 0.4 wt %, about 0.42 wt %, about 0.44 wt %, about 0.46 wt %, about 0.48 wt %, about 0.5 wt %, about 0.52 wt %, about 0.54 wt %, about 0.56 wt %, about 0.58 wt %, about 0.6 wt %, about 0.62 wt %, about 0.64 wt %, about 0.66 wt %, about 0.68 wt %, about 0.7 wt %, about 0.72 wt %, about 0.74 wt %, about 0.76 wt %, about 0.78 wt %, about 0.8 wt %, about 0.82 wt %, about 0.84 wt %, about 0.86 wt %, about 0.88 wt %, about 0.9 wt %, about 0.92 wt %, about 0.94 wt %, about 0.96 wt %, about 0.98 wt %, about 1 wt %, about 1.02 wt %, about 1.04 wt %, about 1.06 wt %, about 1.08 wt %, about 1.1 wt %, about 1.12 wt %, about 1.14 wt %, about 1.16 wt %, about 1.18 wt %, about 1.2 wt %, about 1 wt %, about 1.02 wt %, about 1.04 wt %, about 1.06 wt %, about 1.08 wt %, about 1.1 wt %, about 1.12 wt %, about 1.14 wt %, about 1.16 wt %, about 1.18 wt %, about 1.2 wt %, about 1.22 wt %, about 1.24 wt %, about 1.26 wt %, about 1.28 wt %, about 1.3 wt %, about 1.32 wt %, about 1.34 wt %, about 1.36 wt %, about 1.38 wt %, about 1.4 wt %, about 1.42 wt %, about 1.44 wt %, about 1.46 wt %, about 1.48 wt %, about 1.5 wt %, about 1.52 wt %, about 1.54 wt %, about 1.56 wt %, about 1.58 wt %, about 1.6 wt %, about 1.62 wt %, about 1.64 wt %, about 1.66 wt %, about 1.68 wt %, about 1.7 wt %, about 1.72 wt %, about 1.74 wt %, about 1.76 wt %, about 1.78 wt %, about 1.8 wt %, about 1.82 wt %, about 1.84 wt %, about 1.86 wt %, about 1.88 wt %, about 1.9 wt %, about 1.92 wt %, about 1.94 wt %, about 1.96 wt %, about 1.98 wt %, about 2 wt %, about 2.02 wt %, about 2.04 wt %, about 2.06 wt %, about 2.08 wt %, about 2.1 wt %, about 2.12 wt %, about 2.14 wt %, about 2.16 wt %, about 2.18 wt %, about 2.2 wt %, about 2.22 wt %, about 2.24 wt %, about 2.26 wt %, about 2.28 wt %, about 2.3 wt %, about 2.32 wt %, about 2.34 wt %, about 2.36 wt %, about 2.38 wt %, about 2.4 wt %, about 2.42 wt %, about 2.44 wt %, about 2.46 wt %, about 2.48 wt %, about 2.5 wt % of inorganic acid or any value or range therebetween, based on the total weight of the hydrogel precursor.

The inorganic acid may be selected from the group consisting of hydrochloric acid, chloric acid, sulfuric acid, phosphoric acid, nitric acid, boric acid, chlorosulfonic acid, fluoroboric acid, iodic acid, hypoiodous acid, hydriodic acid, bromic acid, hydrobromic acid, hydrofluoric acid, fluoric acid, phosphorous acid, perphosphoric acid, hypophosphorous acid, molybdic acid, perchloric acid, hypochlorous acid, nitrous acid, pertnitric acid, carbonic acid, acetic acid, persulfuric acid, disulfurous acid, hydrosulfuric acid, telluric acid, terephthalic acid, or any combinations thereof.

### Crosslinking Agent

The hydrogel precursor may comprise about 0.05 wt % to about 0.5 wt % of crosslinking agent, about 0.06 wt % to about 0.5 wt %, about 0.07 wt % to about 0.5 wt %, about 0.08 wt % to about 0.5 wt %, about 0.09 wt % to about 0.5 wt %, about 0.1 wt % to about 0.5 wt %, about 0.11 wt % to about 0.5 wt %, about 0.12 wt % to about 0.5 wt %, about 0.13 wt % to about 0.5 wt %, about 0.14 wt % to about 0.5 wt %, about 0.15 wt % to about 0.5 wt %, about 0.16 wt % to about 0.5 wt %, about 0.17 wt % to about 0.5 wt %, about 0.18 wt % to about 0.5 wt %, about 0.19 wt % to about 0.5 wt %, about 0.2 wt % to about 0.5 wt %, about 0.21 wt % to about 0.5 wt %, about 0.22 wt % to about 0.5 wt %, about 0.23 wt % to about 0.5 wt %, about 0.24 wt % to about 0.5 wt %, about 0.25 wt % to about 0.5 wt %, about 0.26 wt % to about 0.5 wt %, about 0.27 wt % to about 0.5 wt %, about 0.28 wt % to about 0.5 wt %, about 0.29 wt % to about 0.5 wt %, about 0.3 wt % to about 0.5 wt %, about 0.31 wt % to about 0.5 wt %, about 0.32 wt % to about 0.5 wt %, about 0.33 wt % to about 0.5 wt %, about 0.34 wt % to about 0.5 wt %, about 0.35 wt % to about 0.5 wt %, about 0.36 wt % to about 0.5 wt %, about 0.37 wt % to about 0.5 wt %, about 0.38 wt % to about 0.5 wt %, about 0.39 wt % to about 0.5 wt %, about 0.4 wt % to about 0.5 wt %, about 0.41 wt % to about 0.5 wt %, about 0.42 wt % to about 0.5 wt %, about 0.43 wt % to about 0.5 wt %, about 0.44 wt % to about 0.5 wt %, about 0.45 wt % to about 0.5 wt %, about 0.46 wt % to about 0.5 wt %, about 0.47 wt % to about 0.5 wt %, about 0.48 wt % to about 0.5 wt %, about 0.49 wt % to about 0.5 wt %, about 0.05 wt % to about 0.49 wt %, about 0.05 wt % to about 0.48 wt %, about 0.05 wt % to about 0.47 wt %, about 0.05 wt % to about 0.46 wt %, about 0.05 wt % to about 0.45 wt %, about 0.05 wt % to about 0.44 wt %, about 0.05 wt % to about 0.43 wt %, about 0.05 wt % to about 0.42 wt %, about 0.05 wt % to about 0.41 wt %, about 0.05 wt % to about 0.4 wt %, about 0.05 wt % to about 0.39 wt %, about 0.05 wt % to about 0.38 wt %, about 0.05 wt % to about 0.37 wt %, about 0.05 wt % to about 0.36 wt %, about 0.05 wt % to about 0.35 wt %, about 0.05 wt % to about 0.34 wt %, about 0.05 wt % to about 0.33 wt %, about 0.05 wt % to about 0.32 wt %, about 0.05 wt % to about 0.31 wt %, about 0.05 wt % to about 0.3 wt %, about 0.05 wt % to about 0.29 wt %, about 0.05 wt % to about 0.28 wt %, about 0.05 wt % to about 0.27 wt %, about 0.05 wt % to about 0.26 wt %, about 0.05 wt % to about 0.25 wt %, about 0.05 wt % to about 0.24 wt %, about 0.05 wt % to about 0.23 wt %, about 0.05 wt % to about 0.22 wt %, about 0.05 wt % to about 0.21 wt %, about 0.05 wt % to about 0.2 wt %, about 0.05 wt % to about 0.19 wt %, about 0.05 wt % to about 0.18 wt %, about 0.05 wt % to about 0.17 wt %, about 0.05 wt % to about 0.16 wt %, about 0.05 wt % to about 0.15 wt %, about 0.05 wt % to about 0.14 wt %, about 0.05 wt % to about 0.13 wt %, about 0.05 wt % to about 0.12 wt %, about 0.05 wt % to about 0.11 wt %, about 0.05 wt % to about 0.1 wt %, about 0.05 wt % to about 0.09 wt %, about 0.05 wt % to about 0.08 wt %, about 0.05 wt % to about 0.07 wt %, about 0.05 wt % to about 0.06 wt %, about 0.05 wt %, about 0.06 wt %, about 0.07 wt %, about 0.08 wt %, about 0.09 wt %, about 0.1 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.2 wt %, about 0.21 wt %, about 0.22 wt %, about 0.23 wt %, about 0.24 wt %, about 0.25 wt %, about 0.26 wt %, about 0.27 wt %, about 0.28 wt %, about 0.29 wt %, about 0.3 wt %, about 0.31 wt %, about 0.32 wt %, about 0.33 wt %, about 0.34 wt %, about 0.35 wt %, about 0.36 wt %, about 0.37 wt %, about 0.38 wt %, about 0.39 wt %, about 0.4 wt %, about 0.41 wt %, about 0.42 wt %, about 0.43 wt %, about 0.44 wt %, about 0.45 wt %, about 0.46 wt %, about 0.47 wt %, about 0.48 wt %, about 0.49 wt %, about 0.5 wt % of crosslinking agent or any value or range therebetween, based on the total weight of the hydrogel precursor.

The hydrogel precursor may comprise about 0.05 wt % to about 0.25 wt % of crosslinking agent, about 0.06 wt % to about 0.25 wt %, about 0.07 wt % to about 0.25 wt %, about 0.08 wt % to about 0.25 wt %, about 0.09 wt % to about 0.25 wt %, about 0.1 wt % to about 0.25 wt %, about 0.11 wt % to about 0.25 wt %, about 0.12 wt % to about 0.25 wt %, about 0.13 wt % to about 0.25 wt %, about 0.14 wt % to about 0.25 wt %, about 0.15 wt % to about 0.25 wt %, about 0.16 wt % to about 0.25 wt %, about 0.17 wt % to about 0.25 wt %, about 0.18 wt % to about 0.25 wt %, about 0.19 wt % to about 0.25 wt %, about 0.2 wt % to about 0.25 wt %, about 0.21 wt % to about 0.25 wt %, about 0.22 wt % to about 0.25 wt %, about 0.23 wt % to about 0.25 wt %, about 0.24 wt % to about 0.25 wt %, about 0.05 wt % to about 0.24 wt %, about 0.05 wt % to about 0.23 wt %, about 0.05 wt % to about 0.22 wt %, about 0.05 wt % to about 0.21 wt %, about 0.05 wt % to about 0.2 wt %, about 0.05 wt % to about 0.19 wt %, about 0.05 wt % to about 0.18 wt %, about 0.05 wt % to about 0.17 wt %, about 0.05 wt % to about 0.16 wt %, about 0.05 wt % to about 0.15 wt %, about 0.05 wt % to about 0.14 wt %, about 0.05 wt % to about 0.13 wt %, about 0.05 wt % to about 0.12 wt %, about 0.05 wt % to about 0.11 wt %, about 0.05 wt % to about 0.1 wt %, about 0.05 wt % to about 0.09 wt %, about 0.05 wt % to about 0.08 wt %, about 0.05 wt % to about 0.07 wt %, about 0.05 wt % to about 0.06 wt %, about 0.05 wt %, about 0.06 wt %, about 0.07 wt %, about 0.08 wt %, about 0.09 wt %, about 0.1 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.2 wt %, about 0.21 wt %, about 0.22 wt %, about 0.23 wt %, about 0.24 wt %, about 0.25 wt % of crosslinking agent or any value or range therebetween, based on the total weight of the hydrogel precursor.

Crosslinking agent may be selected from the group consisting of glutaraldehyde, calcium chloride (CaCl₂), sodium triphosphate, N—N′-methylenebisacrylamide (C₇H₁₀N₂O₂), acetic acid, cucurbit[7]uril (C₄₂H₄₂N₂₈O₁₄) and/or any combinations thereof.

In some embodiments, photo-initiators may be used to initiate crosslinking. For example, photo-crosslinking may be used for some polymers containing double bonds in structure where photo-crosslinking may be used to form a hydrogel matrix. These photo-initiators may accelerate the reaction and stabilize the whole structure of the crosslinking and hydrogel matrix. Examples of photo-initiators may include diphenyl (2,4,6-trimethyl benzoyl) phosphine oxide (TPO photo initiator), ultraviolet (UV) light and more.

### Radiation-Reflecting Inorganic Particle

The hydrogel precursor may comprise about 3 wt % to about 70 wt % of a radiation-reflecting inorganic particle, about 4 wt % to about 70 wt %, about 5 wt % to about 70 wt %, about 6 wt % to about 70 wt %, about 7 wt % to about 70 wt %, about 8 wt % to about 70 wt %, about 9 wt % to about 70 wt %, about 10 wt % to about 70 wt %, about 11 wt % to about 70 wt %, about 12 wt % to about 70 wt %, about 13 wt % to about 70 wt %, about 14 wt % to about 70 wt %, about 15 wt % to about 70 wt %, about 16 wt % to about 70 wt %, about 17 wt % to about 70 wt %, about 18 wt % to about 70 wt %, about 19 wt % to about 70 wt %, about 20 wt % to about 70 wt %, about 21 wt % to about 70 wt %, about 22 wt % to about 70 wt %, about 23 wt % to about 70 wt %, about 24 wt % to about 70 wt %, about 25 wt % to about 70 wt %, about 26 wt % to about 70 wt %, about 27 wt % to about 70 wt %, about 28 wt % to about 70 wt %, about 29 wt % to about 70 wt %, about 30 wt % to about 70 wt %, about 31 wt % to about 70 wt %, about 32 wt % to about 70 wt %, about 33 wt % to about 70 wt %, about 34 wt % to about 70 wt %, about 35 wt % to about 70 wt %, about 36 wt % to about 70 wt %, about 37 wt % to about 70 wt %, about 38 wt % to about 70 wt %, about 39 wt % to about 70 wt %, about 40 wt % to about 70 wt %, about 41 wt % to about 70 wt %, about 42 wt % to about 70 wt %, about 43 wt % to about 70 wt %, about 44 wt % to about 70 wt %, about 45 wt % to about 70 wt %, about 46 wt % to about 70 wt %, about 47 wt % to about 70 wt %, about 48 wt % to about 70 wt %, about 49 wt % to about 70 wt %, about 50 wt % to about 70 wt %, about 51 wt % to about 70 wt %, about 52 wt % to about 70 wt %, about 53 wt % to about 70 wt %, about 54 wt % to about 70 wt %, about 55 wt % to about 70 wt %, about 56 wt % to about 70 wt %, about 57 wt % to about 70 wt %, about 58 wt % to about 70 wt %, about 59 wt % to about 70 wt %, about 60 wt % to about 70 wt %, about 61 wt % to about 70 wt %, about 62 wt % to about 70 wt %, about 63 wt % to about 70 wt %, about 64 wt % to about 70 wt %, about 65 wt % to about 70 wt %, about 66 wt % to about 70 wt %, about 67 wt % to about 70 wt %, about 68 wt % to about 70 wt %, about 69 wt % to about 70 wt %, about 3 wt % to about 69 wt %, about 3 wt % to about 68 wt %, about 3 wt % to about 67 wt %, about 3 wt % to about 66 wt %, about 3 wt % to about 65 wt %, about 3 wt % to about 64 wt %, about 3 wt % to about 63 wt %, about 3 wt % to about 62 wt %, about 3 wt % to about 61 wt %, about 3 wt % to about 60 wt %, about 3 wt % to about 59 wt %, about 3 wt % to about 58 wt %, about 3 wt % to about 57 wt %, about 3 wt % to about 56 wt %, about 3 wt % to about 55 wt %, about 3 wt % to about 54 wt %, about 3 wt % to about 53 wt %, about 3 wt % to about 52 wt %, about 3 wt % to about 51 wt %, about 3 wt % to about 50 wt %, about 3 wt % to about 49 wt %, about 3 wt % to about 48 wt %, about 3 wt % to about 47 wt %, about 3 wt % to about 46 wt %, about 3 wt % to about 45 wt %, about 3 wt % to about 44 wt %, about 3 wt % to about 43 wt %, about 3 wt % to about 42 wt %, about 3 wt % to about 41 wt %, about 3 wt % to about 40 wt %, about 3 wt % to about 39 wt %, about 3 wt % to about 38 wt %, about 3 wt % to about 37 wt %, about 3 wt % to about 36 wt %, about 3 wt % to about 35 wt %, about 3 wt % to about 34 wt %, about 3 wt % to about 33 wt %, about 3 wt % to about 32 wt %, about 3 wt % to about 31 wt %, about 3 wt % to about 30 wt %, about 3 wt % to about 29 wt %, about 3 wt % to about 28 wt %, about 3 wt % to about 27 wt %, about 3 wt % to about 26 wt %, about 3 wt % to about 25 wt %, about 3 wt % to about 24 wt %, about 3 wt % to about 23 wt %, about 3 wt % to about 22 wt %, about 3 wt % to about 21 wt %, about 3 wt % to about 20 wt %, about 3 wt % to about 19 wt %, about 3 wt % to about 18 wt %, about 3 wt % to about 17 wt %, about 3 wt % to about 16 wt %, about 3 wt % to about 15 wt %, about 3 wt % to about 14 wt %, about 3 wt % to about 13 wt %, about 3 wt % to about 12 wt %, about 3 wt % to about 11 wt %, about 3 wt % to about 10 wt %, about 3 wt % to about 9 wt %, about 3 wt % to about 8 wt %, about 3 wt % to about 7 wt %, about 3 wt % to about 6 wt %, about 3 wt % to about 5 wt %, about 3 wt % to about 4 wt %, about 3 wt %, about 4 wt %, about 5 wt %, about 6 wt %, about 7 wt %, about 8 wt %, about 9 wt %, about 10 wt %, about 11 wt %, about 12 wt/o, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt % of a radiation-reflecting inorganic particle, or any value or range therebetween, based on the total weight of the hydrogel precursor.

The hydrogel precursor may comprise about 30 wt % to about 70 wt % of a radiation-reflecting inorganic particle, about 35 wt % to about 70 wt %, about 40 wt % to about 70 wt %, about 45 wt % to about 70 wt %, about 50 wt % to about 70 wt %, about 55 wt % to about 70 wt %, about 60 wt % to about 70 wt %, about 65 wt % to about 70 wt %, about 30 wt % to about 65 wt %, about 30 wt % to about 60 wt %, about 30 wt % to about 55 wt %, about 30 wt % to about 50 wt %, about 30 wt % to about 45 wt %, about 30 wt % to about 40 wt %, about 30 wt % to about 35 wt %, about 30 wt %, about 32 wt %, about 34 wt %, about 36 wt %, about 38 wt %, about 40 wt %, about 42 wt %, about 44 wt %, about 46 wt %, about 48 wt %, about 50 wt %, about 52 wt %, about 54 wt %, about 56 wt %, about 58 wt %, about 60 wt %, about 62 wt %, about 64 wt %, about 66 wt %, about 68 wt %, about 70 wt % of a radiation-reflecting inorganic particle, or any value or range therebetween, based on the total weight of the hydrogel precursor.

A radiation-reflecting inorganic particle may be selected from the group consisting of barium sulfate, titanium dioxide, calcium carbonate, alumina, zirconia, calcium silicate, silicon dioxide, zinc oxide, zirconium silicate, zinc aluminate, magnesium hydroxide, aluminum hydroxide, zinc stannate, aluminum silicate, zinc silicate, calcium molybdate, magnesium carbonate, zinc carbonate, potassium titanate, sodium aluminum silicate, calcium phosphate, aluminum phosphate, zinc phosphate, magnesium phosphate, magnesium oxide, and combinations thereof. A solar-reflector is a type of radiation-reflecting inorganic particle.

The radiation-reflecting inorganic particle may have an average diameter of about 0.1 μm to about 1 μm, about 0.12 μm to about 1 μm, about 0.14 μm to about 1 μm, about 0.16 μm to about 1 μm, about 0.18 μm to about 1 μm, about 0.2 μm to about 1 μm, about 0.22 μm to about 1 μm, about 0.24 μm to about 1 μm, about 0.26 μm to about 1 μm, about 0.28 μm to about 1 μm, about 0.3 μm to about 1 μm, about 0.32 μm to about 1 μm, about 0.34 μm to about 1 μm, about 0.36 μm to about 1 μm, about 0.38 μm to about 1 μm, about 0.4 μm to about 1 μm, about 0.42 μm to about 1 μm, about 0.44 μm to about 1 μm, about 0.46 μm to about 1 μm, about 0.48 μm to about 1 μm, about 0.5 μm to about 1 μm, about 0.52 μm to about 1 μm, about 0.54 μm to about 1 μm, about 0.56 μm to about 1 μm, about 0.58 μm to about 1 μm, about 0.6 μm to about 1 μm, about 0.62 μm to about 1 μm, about 0.64 μm to about 1 μm, about 0.66 μm to about 1 μm, about 0.68 μm to about 1 μm, about 0.7 μm to about 1 μm, about 0.78 μm to about 1 μm, about 0.8 μm to about 1 μm, about 0.82 μm to about 1 μm, about 0.84 μm to about 1 μm, about 0.86 μm to about 1 μm, about 0.88 μm to about 1 μm, about 0.9 μm to about 1 μm, about 0.92 μm to about 1 μm, about 0.94 μm to about 1 μm, about 0.96 μm to about 1 μm, about 0.98 μm to about 1 μm, about 0.1 μm to about 0.98 μm, about 0.1 μm to about 0.96 μm, about 0.1 μm to about 0.94 μm, about 0.1 μm to about 0.92 μm, about 0.1 μm to about 0.9 μm, about 0.1 μm to about 0.88 μm, about 0.1 μm to about 0.86 μm, about 0.1 μm to about 0.84 μm, about 0.1 μm to about 0.82 μm, about 0.1 μm to about 0.8 μm, about 0.1 μm to about 0.78 μm, about 0.1 μm to about 0.76 μm, about 0.1 μm to about 0.74 μm, about 0.1 μm to about 0.72 μm, about 0.1 μm to about 0.7 μm, about 0.1 μm to about 0.68 μm, about 0.1 μm to about 0.66 μm, about 0.1 μm to about 0.64 μm, about 0.1 μm to about 0.62 μm, about 0.1 μm to about 0.6 μm, about 0.1 μm to about 0.58 μm, about 0.1 μm to about 0.56 μm, about 0.1 μm to about 0.54 μm, about 0.1 μm to about 0.52 μm, about 0.1 μm to about 0.5 μm, about 0.1 μm to about 0.48 μm, about 0.1 μm to about 0.46 μm, about 0.1 μm to about 0.44 μm, about 0.1 μm to about 0.42 μm, about 0.1 μm to about 0.4 μm, about 0.1 μm to about 0.38 μm, about 0.1 μm to about 0.36 μm, about 0.1 μm to about 0.34 μm, about 0.1 μm to about 0.32 μm, about 0.1 μm to about 0.3 μm, about 0.1 μm to about 0.28 μm, about 0.1 μm to about 0.26 μm, about 0.1 μm to about 0.24 μm, about 0.1 μm to about 0.22 μm, about 0.1 μm to about 0.2 μm, about 0.1 μm to about 0.18 μm, about 0.1 μm to about 0.16 μm, about 0.1 μm to about 0.14 μm, about 0.1 μm to about 0.12 μm, about 0.1 μm, about 0.12 μm, about 0.14 μm, about 0.16 μm, about 0.18 μm, about 0.2 μm, about 0.22 μm, about 0.24 μm, about 0.26 μm, about 0.28 μm, about 0.3 μm, about 0.32 μm, about 0.32 μm, about 0.34 μm, about 0.36 μm, about 0.38 μm, about 0.4 μm, about 0.42 μm, about 0.44 μm, about 0.46 μm, about 0.48 μm, about 0.5 μm, about 0.52 μm, about 0.54 μm, about 0.56 μm, about 0.58 μm, about 0.6 μm, about 0.62 μm, about 0.64 μm, about 0.66 μm, about 0.68 μm, about 0.7 μm, about 0.72 μm, about 0.74 μm, about 0.76 μm, about 0.78 μm, about 0.8 μm, about 0.82 μm, about 0.84 μm, about 0.86 μm, about 0.88 μm, about 0.9 μm, about 0.92 μm, about 0.94 μm, about 0.96 μm, about 0.98 μm, about 1 μm, or any value or range therebetween.

The present invention also relates to a hydrogel precursor comprising about 5 wt % to about 25 wt % of water-soluble polymer; about 0.3 wt % to about 1.2 wt % of inorganic acid; about 0.05 wt % to about 0.25 wt % of crosslinking agent; and about 30 wt % to about 70 wt % of a radiation-reflecting inorganic particle, wherein the wt % is based on the total weight of the hydrogel precursor.

### Water

The hydrogel precursor may comprise water.

Water in a hydrogel precursor or hydrogel refers to total water, which includes free water (FW), intermediate water (IW) and bound water (BW). The term “free water (FW)” is to be interpreted broadly to refer to water that is not bound to an inorganic surface (e.g. polymer) and can flow freely. The term “bound water (BW)” refers to water molecules which are tightly bound to an inorganic surface (e.g. polymer) and cannot flow freely. The term “intermediate water (IW)” refers to water that is weakly or loosely bound to an inorganic surface (e.g. polymer molecule) or to tightly bound water. Evaporable water may refer to free water and intermediate water.

The amount of IW highly depends on the hydration ability of polymer networks within the hydrogel precursor or hydrogel. The IW can form hydrogen bonds with the bound water, which weakens the hydrogen bonds among IW molecules and reduces the energy demand for water evaporation. IW is commonly known to be effectively evaporated with significantly reduced energy demand.

The hydrogel precursor may comprise about 20 wt % to about 70 wt % of total water (e.g. bound water, free water and intermediate water), about 21 wt % to about 70 wt %, about 22 wt % to about 70 wt %, about 23 wt % to about 70 wt %, about 24 wt % to about 70 wt %, about 25 wt % to about 70 wt %, about 26 wt % to about 70 wt %, about 27 wt % to about 70 wt %, about 28 wt % to about 70 wt %, about 29 wt % to about 70 wt %, about 30 wt % to about 70 wt %, about 31 wt % to about 70 wt %, about 32 wt % to about 70 wt %, about 33 wt % to about 70 wt %, about 34 wt % to about 70 wt %, about 35 wt % to about 70 wt %, about 36 wt % to about 70 wt %, about 37 wt % to about 70 wt %, about 38 wt % to about 70 wt %, about 39 wt % to about 70 wt %, about 40 wt % to about 70 wt %, about 41 wt % to about 70 wt %, about 42 wt % to about 70 wt %, about 43 wt % to about 70 wt %, about 44 wt % to about 70 wt %, about 45 wt % to about 70 wt %, about 46 wt % to about 70 wt %, about 47 wt % to about 70 wt %, about 48 wt % to about 70 wt %, about 49 wt % to about 70 wt %, about 50 wt % to about 70 wt %, about 51 wt % to about 70 wt %, about 52 wt % to about 70 wt %, about 53 wt % to about 70 wt %, about 54 wt % to about 70 wt %, about 55 wt % to about 70 wt %, about 56 wt % to about 70 wt %, about 57 wt % to about 70 wt %, about 58 wt % to about 70 wt %, about 59 wt % to about 70 wt %, about 60 wt % to about 70 wt %, about 61 wt % to about 70 wt %, about 62 wt % to about 70 wt %, about 63 wt % to about 70 wt %, about 64 wt % to about 70 wt %, about 65 wt % to about 70 wt %, about 66 wt % to about 70 wt %, about 67 wt % to about 70 wt %, about 68 wt % to about 70 wt %, about 69 wt % to about 70 wt %, about 20 wt % to about 69 wt %, about 20 wt % to about 68 wt %, about 20 wt % to about 67 wt %, about 20 wt % to about 66 wt %, about 20 wt % to about 65 wt %, about 20 wt % to about 64 wt %, about 20 wt % to about 63 wt %, about 20 wt % to about 62 wt %, about 20 wt % to about 61 wt %, about 20 wt % to about 60 wt %, about 20 wt % to about 59 wt %, about 20 wt % to about 58 wt %, about 20 wt % to about 57 wt %, about 20 wt % to about 56 wt %, about 20 wt % to about 55 wt %, about 20 wt % to about 54 wt %, about 20 wt % to about 53 wt %, about 20 wt % to about 52 wt %, about 20 wt % to about 51 wt %, about 20 wt % to about 50 wt %, about 20 wt % to about 49 wt %, about 20 wt % to about 48 wt %, about 20 wt % to about 47 wt %, about 20 wt % to about 46 wt %, about 20 wt % to about 45 wt %, about 20 wt % to about 44 wt %, about 20 wt % to about 43 wt %, about 20 wt % to about 42 wt %, about 20 wt % to about 41 wt %, about 20 wt % to about 40 wt %, about 20 wt % to about 39 wt %, about 20 wt % to about 38 wt %, about 20 wt % to about 37 wt %, about 20 wt % to about 36 wt %, about 20 wt % to about 35 wt %, about 20 wt % to about 34 wt %, about 20 wt % to about 33 wt %, about 20 wt % to about 32 wt %, about 20 wt % to about 31 wt %, about 20 wt % to about 30 wt %, about 20 wt % to about 29 wt %, about 20 wt % to about 28 wt %, about 20 wt % to about 27 wt %, about 20 wt % to about 26 wt %, about 20 wt % to about 25 wt %, about 20 wt % to about 24 wt %, about 20 wt % to about 23 wt %, about 20 wt % to about 22 wt %, about 20 wt % to about 21 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt % of total water, or any value or range therebetween, based on the total weight of hydrogel precursor.

The hydrogel precursor may comprise about 20 wt % to about 50 wt % of total water (e.g. bound water, free water and intermediate water), about 25 wt % to about 50 wt %, about 30 wt % to about 50 wt %, about 35 wt % to about 50 wt %, about 40 wt % to about 50 wt %, about 45 wt % to about 50 wt %, about 20 wt % to about 45 wt %, about 20 wt % to about 40 wt %, about 20 wt % to about 35 wt %, about 20 wt % to about 30 wt %, about 20 wt % to about 25 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, of total water, or any value or range therebetween, based on the total weight of hydrogel precursor.

The hydrogel precursor may comprise about 15 wt % to about 65 wt % of free water and intermediate water, about 15 wt % to about 64 wt %, about 15 wt % to about 63 wt %, about 15 wt % to about 62 wt %, about 15 wt % to about 61 wt %, about 15 wt % to about 60 wt %, about 15 wt % to about 59 wt %, about 15 wt % to about 58 wt %, about 15 wt % to about 57 wt %, about 15 wt % to about 56 wt %, about 15 wt % to about 55 wt %, about 15 wt % to about 54 wt %, about 15 wt % to about 53 wt %, about 15 wt % to about 52 wt %, about 15 wt % to about 51 wt %, about 15 wt % to about 50 wt %, about 15 wt % to about 49 wt %, about 15 wt % to about 48 wt %, about 15 wt % to about 47 wt %, about 15 wt % to about 46 wt %, about 15 wt % to about 45 wt %, about 15 wt % to about 44 wt %, about 15 wt % to about 43 wt %, about 15 wt % to about 42 wt %, about 15 wt % to about 41 wt %, about 15 wt % to about 40 wt %, about 15 wt % to about 39 wt %, about 15 wt % to about 38 wt %, about 15 wt % to about 37 wt %, about 15 wt % to about 36 wt %, about 15 wt % to about 35 wt %, about 15 wt % to about 34 wt %, about 15 wt % to about 33 wt %, about 15 wt % to about 32 wt %, about 15 wt % to about 31 wt %, about 15 wt % to about 30 wt %, about 15 wt % to about 29 wt %, about 15 wt % to about 28 wt %, about 15 wt % to about 27 wt %, about 15 wt % to about 26 wt %, about 15 wt % to about 25 wt %, about 15 wt % to about 24 wt %, about 15 wt % to about 23 wt %, about 15 wt % to about 22 wt %, about 15 wt % to about 21 wt %, about 15 wt % to about 20 wt %, about 15 wt % to about 19 wt %, about 15 wt % to about 18 wt %, about 15 wt % to about 17 wt %, about 15 wt % to about 16 wt %, about 15 wt % to about 65 wt %, about 16 wt % to about 65 wt %, about 17 wt % to about 65 wt %, about 18 wt % to about 65 wt %, about 19 wt % to about 65 wt %, about 20 wt % to about 65 wt %, about 21 wt % to about 65 wt %, about 22 wt % to about 65 wt %, about 23 wt % to about 65 wt %, about 24 wt % to about 65 wt %, about 25 wt % to about 65 wt %, about 26 wt % to about 65 wt %, about 27 wt % to about 65 wt %, about 28 wt % to about 65 wt %, about 29 wt % to about 65 wt %, about 30 wt % to about 65 wt %, about 31 wt % to about 65 wt %, about 32 wt % to about 65 wt %, about 33 wt % to about 65 wt %, about 34 wt % to about 65 wt %, about 35 wt % to about 65 wt %, about 36 wt % to about 65 wt %, about 37 wt % to about 65 wt %, about 38 wt % to about 65 wt %, about 39 wt % to about 65 wt %, about 40 wt % to about 65 wt %, about 41 wt % to about 65 wt %, about 42 wt % to about 65 wt %, about 43 wt % to about 65 wt %, about 44 wt % to about 65 wt %, about 45 wt % to about 65 wt %, about 46 wt % to about 65 wt %, about 47 wt % to about 65 wt %, about 48 wt % to about 65 wt %, about 49 wt % to about 65 wt %, about 50 wt % to about 65 wt %, about 51 wt % to about 65 wt %, about 52 wt % to about 65 wt %, about 53 wt % to about 65 wt %, about 54 wt % to about 65 wt %, about 55 wt % to about 65 wt %, about 56 wt % to about 65 wt %, about 57 wt % to about 65 wt %, about 58 wt % to about 65 wt %, about 59 wt % to about 65 wt %, about 60 wt % to about 65 wt %, about 61 wt % to about 65 wt %, about 62 wt % to about 65 wt %, about 63 wt % to about 65 wt %, about 64 wt % to about 65 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt % of free water and intermediate water, or any value or range therebetween, based on the total weight of hydrogel precursor.

The hydrogel precursor may comprise about 15 wt % to about 45 wt % of free water and intermediate water, about 15 wt % to about 40 wt %, about 15 wt % to about 35 wt %, about 15 wt % to about 30 wt %, about 15 wt % to about 25 wt %, about 15 wt % to about 20 wt %, about 20 wt % to about 45 wt %, about 25 wt % to about 45 wt %, about 30 wt % to about 45 wt %, about 35 wt % to about 45 wt %, about 40 wt % to about 45 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, of free water and intermediate water, or any value or range therebetween, based on the total weight of hydrogel precursor.

### Hydrogel

The present invention relates to a hydrogel comprising about 5 wt % to about 30 wt % of water-soluble polymer; about 0.1 wt % to about 1.5 wt % of crosslinking agent; and about 3 wt % to about 70 wt % of a radiation-reflecting inorganic particle, wherein the wt % is based on the total weight of the hydrogel.

### Water-Soluble Polymer

The hydrogel may comprise about 5 wt % to about 30 wt % of water-soluble polymer, about 5 wt % to about 29.5 wt %, about 5 wt % to about 29 wt %, about 5 wt % to about 28.5 wt %, about 5 wt % to about 28 wt %, about 5 wt % to about 27.5 wt %, about 5 wt % to about 27 wt %, about 5 wt % to about 26.5 wt %, about 5 wt % to about 26 wt %, about 5 wt % to about 25.5 wt %, about 5 wt % to about 25 wt %, about 5 wt % to about 24.5 wt %, about 5 wt % to about 24 wt %, about 5 wt % to about 23.5 wt %, about 5 wt % to about 23 wt %, about 5 wt % to about 22.5 wt %, about 5 wt % to about 22 wt %, about 5 wt % to about 21.5 wt %, about 5 wt % to about 21 wt %, about 5 wt % to about 20.5 wt %, about 5 wt % to about 20 wt %, about 5 wt % to about 19.5 wt %, about 5 wt % to about 19 wt %, about 5 wt % to about 18.5 wt %, about 5 wt % to about 18 wt %, about 5 wt % to about 17.5 wt %, about 5 wt % to about 17 wt %, about 5 wt % to about 16.5 wt %, about 5 wt % to about 16 wt %, about 5 wt % to about 15.5 wt %, about 5 wt % to about 15 wt %, about 5 wt % to about 14.5 wt %, about 5 wt % to about 14 wt %, about 5 wt % to about 13.5 wt %, about 5 wt % to about 13 wt %, about 5 wt % to about 12.5 wt %, about 5 wt % to about 12 wt %, about 5 wt % to about 11.5 wt %, about 5 wt % to about 11 wt %, about 5 wt % to about 10.5 wt %, about 5 wt % to about 10 wt %, about 5 wt % to about 9.5 wt %, about 5 wt % to about 9 wt %, about 5 wt % to about 8.5 wt %, about 5 wt % to about 8 wt %, about 5 wt % to about 7.5 wt %, about 5 wt % to about 7 wt %, about 5 wt % to about 6.5 wt %, about 5 wt % to about 6 wt %, about 5 wt % to about 5.5 wt %, about 5.5 wt % to about 30 wt %, about 6 wt % to about 30 wt %, about 6.5 wt % to about 30 wt %, about 7 wt % to about 30 wt %, about 7.5 wt % to about 30 wt %, about 8 wt % to about 30 wt %, about 8.5 wt % to about 30 wt %, about 9 wt % to about 30 wt %, about 9.5 wt % to about 30 wt %, about 10 wt % to about 30 wt %, about 10.5 wt % to about 30 wt %, about 11 wt % to about 30 wt %, about 11.5 wt % to about 30 wt %, about 12 wt % to about 30 wt %, about 12.5 wt % to about 30 wt %, about 13 wt % to about 30 wt %, about 13.5 wt % to about 30 wt %, about 14 wt % to about 30 wt %, about 14.5 wt % to about 30 wt %, about 15 wt % to about 30 wt %, about 15.5 wt % to about 30 wt %, about 16 wt % to about 30 wt %, about 16.5 wt % to about 30 wt %, about 17 wt % to about 30 wt %, about 17.5 wt % to about 30 wt %, about 18 wt % to about 30 wt %, about 18.5 wt % to about 30 wt %, about 19 wt % to about 30 wt %, about 19.5 wt % to about 30 wt %, about 20 wt % to about 30 wt %, about 20.5 wt % to about 30 wt %, about 21 wt % to about 30 wt %, about 21.5 wt % to about 30 wt %, about 22 wt % to about 30 wt %, about 22.5 wt % to about 30 wt %, about 23 wt % to about 30 wt %, about 23.5 wt % to about 30 wt %, about 24 wt % to about 30 wt %, about 24.5 wt % to about 30 wt %, about 25 wt % to about 30 wt %, about 25.5 wt % to about 30 wt %, about 26 wt % to about 30 wt %, about 26.5 wt % to about 30 wt %, about 27 wt % to about 30 wt %, about 27.5 wt % to about 30 wt %, about 28 wt % to about 30 wt %, about 28.5 wt % to about 30 wt %, about 29 wt % to about 30 wt %, about 29.5 wt % to about 30 wt %, about 5 wt %, about 5.1 wt %, about 5.2 wt %, about 5.3 wt %, about 5.4 wt %, about 5.5 wt %, about 5.6 wt %, about 5.7 wt %, about 5.8 wt %, about 5.9 wt %, about 6 wt %, about 6.1 wt %, about 6.2 wt %, about 6.3 wt %, about 6.4 wt %, about 6.5 wt %, about 6.6 wt %, about 6.7 wt %, about 6.8 wt %, about 6.9 wt %, about 7 wt %, about 7.1 wt %, about 7.2 wt %, about 7.3 wt %, about 7.4 wt %, about 7.5 wt %, about 7.6 wt %, about 7.7 wt %, about 7.8 wt %, about 7.9 wt %, about 8 wt %, about 8.1 wt %, about 8.2 wt %, about 8.3 wt %, about 8.4 wt %, about 8.5 wt %, about 8.6 wt %, about 8.7 wt %, about 8.8 wt %, about 8.9 wt %, about 9 wt %, about 9.1 wt %, about 9.2 wt %, about 9.3 wt %, about 9.4 wt %, about 9.5 wt %, about 9.6 wt %, about 9.7 wt %, about 9.8 wt %, about 9.9 wt %, about 10 wt %, about 10.1 wt %, about 10.2 wt %, about 10.3 wt %, about 10.4 wt %, about 10.5 wt %, about 10.6 wt %, about 10.7 wt %, about 10.8 wt %, about 10.9 wt %, about 11 wt %, about 11.1 wt %, about 11.2 wt %, about 11.3 wt %, about 11.4 wt %, about 11.5 wt %, about 11.6 wt %, about 11.7 wt %, about 11.8 wt %, about 11.9 wt %, about 12 wt %, about 12.1 wt %, about 12.2 wt %, about 12.3 wt %, about 12.4 wt %, about 12.5 wt %, about 12.6 wt %, about 12.7 wt %, about 12.8 wt %, about 12.9 wt %, about 13 wt %, about 13.1 wt %, about 13.2 wt %, about 13.3 wt %, about 13.4 wt %, about 13.5 wt %, about 13.6 wt %, about 13.7 wt %, about 13.8 wt %, about 13.9 wt %, about 14 wt %, about 14.1 wt %, about 14.2 wt %, about 14.3 wt %, about 14.4 wt %, about 14.5 wt %, about 14.6 wt %, about 14.7 wt %, about 14.8 wt %, about 14.9 wt %, about 15 wt %, about 15.1 wt %, about 15.2 wt %, about 15.3 wt %, about 15.4 wt %, about 15.5 wt %, about 15.6 wt %, about 15.7 wt %, about 15.8 wt %, about 15.9 wt %, about 16 wt %, about 16.1 wt %, about 16.2 wt %, about 16.3 wt %, about 16.4 wt %, about 16.5 wt %, about 16.6 wt %, about 16.7 wt %, about 16.8 wt %, about 16.9 wt %, about 17 wt %, about 17.1 wt %, about 17.2 wt %, about 17.3 wt %, about 17.4 wt %, about 17.5 wt %, about 17.6 wt %, about 17.7 wt %, about 17.8 wt %, about 17.9 wt %, about 18 wt %, about 18.1 wt %, about 18.2 wt %, about 18.3 wt %, about 18.4 wt %, about 18.5 wt %, about 18.6 wt %, about 18.7 wt %, about 18.8 wt %, about 18.9 wt %, about 19 wt %, about 19.1 wt %, about 19.2 wt %, about 19.3 wt %, about 19.4 wt %, about 19.5 wt %, about 19.6 wt %, about 19.7 wt %, about 19.8 wt %, about 19.9 wt %, about 20 wt %, about 20.1 wt %, about 20.2 wt %, about 20.3 wt %, about 20.4 wt %, about 20.5 wt %, about 20.6 wt %, about 20.7 wt %, about 20.8 wt %, about 20.9 wt %, about 21 wt %, about 21.1 wt %, about 21.2 wt %, about 21.3 wt %, about 21.4 wt %, about 21.5 wt %, about 21.6 wt %, about 21.7 wt %, about 21.8 wt %, about 21.9 wt %, about 22 wt %, about 22.1 wt %, about 22.2 wt %, about 22.3 wt %, about 22.4 wt %, about 22.5 wt %, about 22.6 wt %, about 22.7 wt %, about 22.8 wt %, about 22.9 wt %, about 23 wt %, about 23.1 wt %, about 23.2 wt %, about 23.3 wt %, about 23.4 wt %, about 23.5 wt %, about 23.6 wt %, about 23.7 wt %, about 23.8 wt %, about 23.9 wt %, about 24 wt %, about 24.1 wt %, about 24.2 wt %, about 24.3 wt %, about 24.4 wt %, about 24.5 wt %, about 24.6 wt %, about 24.7 wt %, about 24.8 wt %, about 24.9 wt %, about 25 wt %, about 25.1 wt %, about 25.2 wt %, about 25.3 wt %, about 25.4 wt %, about 25.5 wt %, about 25.6 wt %, about 25.7 wt %, about 25.8 wt %, about 25.9 wt %, about 26 wt %, about 26.1 wt %, about 26.2 wt %, about 26.3 wt %, about 26.4 wt %, about 26.5 wt %, about 26.6 wt %, about 26.7 wt %, about 26.8 wt %, about 26.9 wt %, about 27 wt %, about 27.1 wt %, about 27.2 wt %, about 27.3 wt %, about 27.4 wt %, about 27.5 wt %, about 27.6 wt %, about 27.7 wt %, about 27.8 wt %, about 27.9 wt %, about 28 wt %, about 28.1 wt %, about 28.2 wt %, about 28.3 wt %, about 28.4 wt %, about 28.5 wt %, about 28.6 wt %, about 28.7 wt %, about 28.8 wt %, about 28.9 wt %, about 29 wt %, about 29.1 wt %, about 29.2 wt %, about 29.3 wt %, about 29.4 wt %, about 29.5 wt %, about 29.6 wt %, about 29.7 wt %, about 29.8 wt %, about 29.9 wt %, about 30 wt % of water-soluble polymer or any value or range therebetween, based on the total weight of the hydrogel.

Molecular weight (MW) of the water-soluble polymer may be about 70,000 to about 100,000, about 75,000 to about 100,000, about 80,000 to about 100,000, about 85,000 to about 100,000, about 90,000 to about 100,000, about 95,000 to about 100,000, about 70,000 to about 95,000, about 70,000 to about 90,000, about 70,000 to about 85,000, about 70,000 to about 80,000, about 70,000 to about 75,000, about 70,000, about 72,000, about 74,000, about 76,000, about 78,000, about 80,000, about 82,000, about 84,000, about 86,000, about 88,000, about 90,000, about 92,000, about 94,000, about 96,000, about 98,000, about 100,000, or any value or range therebetween.

The water-soluble polymer may be about 97.5% to about 99.5% hydrolyzed, about 97.6% to about 99.5% hydrolyzed, about 97.7% to about 99.5% hydrolyzed, about 97.8% to about 99.5% hydrolyzed, about 97.9% to about 99.5% hydrolyzed, about 98% to about 99.5% hydrolyzed, about 98.1% to about 99.5% hydrolyzed, about 98.2% to about 99.5% hydrolyzed, about 98.3% to about 99.5% hydrolyzed, about 98.4% to about 99.5% hydrolyzed, about 98.5% to about 99.5% hydrolyzed, about 98.6% to about 99.5% hydrolyzed, about 98.7% to about 99.5% hydrolyzed, about 98.8% to about 99.5% hydrolyzed, about 98.9% to about 99.5% hydrolyzed, about 99% to about 99.5% hydrolyzed, about 99.1% to about 99.5% hydrolyzed, about 99.2% to about 99.5% hydrolyzed, about 99.3% to about 99.5% hydrolyzed, about 99.4% to about 99.5% hydrolyzed, about 97.5% to about 99.4% hydrolyzed, about 97.5% to about 99.3% hydrolyzed, about 97.5% to about 99.2% hydrolyzed, about 97.5% to about 99.1% hydrolyzed, about 97.5% to about 99% hydrolyzed, about 97.5% to about 98.9% hydrolyzed, about 97.5% to about 98.8% hydrolyzed, about 97.5% to about 98.7% hydrolyzed, about 97.5% to about 98.6% hydrolyzed, about 97.5% to about 98.5% hydrolyzed, about 97.5% to about 98.4% hydrolyzed, about 97.5% to about 98.3% hydrolyzed, about 97.5% to about 98.2% hydrolyzed, about 97.5% to about 98.1% hydrolyzed, about 97.5% to about 98% hydrolyzed, about 97.5% to about 97.9% hydrolyzed, about 97.5% to about 97.8% hydrolyzed, about 97.5% to about 97.7% hydrolyzed, about 97.5% to about 97.6% hydrolyzed, at least about 97.5%, at least about 97.6%, at least about 97.7%, at least about 97.8%, at least about 97.9%, at least about 98%, at least about 98.1%, at least about 98.2%, at least about 98.3%, at least about 98.4%, at least about 98.5%, at least about 98.6%, at least about 98.7%, at least about 98.8%, at least about 98.9%, at least about 99%, at least about 99.1%, at least about 99.2%, at least about 99.3%, at least about 99.4%, at least about 99.5%, or any value or range therebetween.

The water-soluble polymer may have a molecular weight (MW) of about 70,000 to about 100,000 and/or the water-soluble polymer may be about 97.5% to about 99.5% hydrolyzed.

The water-soluble polymer may be selected from the group consisting of poly(vinyl alcohol) (PVA), sodium alginate, gelatin, polyacrylic acid, chitosan, dextran, cellulose and polyacrylamide, polyethylene glycol, poly(ethylene oxide), poly(acrylic acid), poly(maleic acid), poly(N-isopropylacrylamide), poly(allylamine), poly(N-vinylpyrrolidone), poly(N-vinyl acetamide), poly(methacrylic acid), poly(L-lysine hydrobromide), poly(vinyl alcohol)N-methyl-4(4′-formylstyryl)pyridinium methosulfate acetal, poly(vinyl acetate), poly(N-vinylpyrrolidone), poly(vinylphosphonic acid), or any combinations thereof.

### Crosslinking Agent

The hydrogel may comprise about 0.1 wt % to about 1.5 wt % of crosslinking agent, about 0.1 wt % to about 1.5 wt %, about 0.11 wt % to about 1.5 wt %, about 0.12 wt % to about 1.5 wt %, about 0.13 wt % to about 1.5 wt %, about 0.14 wt % to about 1.5 wt %, about 0.15 wt % to about 1.5 wt %, about 0.16 wt % to about 1.5 wt %, about 0.17 wt % to about 1.5 wt %, about 0.18 wt % to about 1.5 wt %, about 0.19 wt % to about 1.5 wt %, about 0.2 wt % to about 1.5 wt %, about 0.21 wt % to about 1.5 wt %, about 0.22 wt % to about 1.5 wt %, about 0.23 wt % to about 1.5 wt %, about 0.24 wt % to about 1.5 wt %, about 0.25 wt % to about 1.5 wt %, about 0.26 wt % to about 1.5 wt %, about 0.27 wt % to about 1.5 wt %, about 0.28 wt % to about 1.5 wt %, about 0.29 wt % to about 1.5 wt %, about 0.3 wt % to about 1.5 wt %, about 0.31 wt % to about 1.5 wt %, about 0.32 wt % to about 1.5 wt %, about 0.33 wt % to about 1.5 wt %, about 0.34 wt % to about 1.5 wt %, about 0.35 wt % to about 1.5 wt %, about 0.36 wt % to about 1.5 wt %, about 0.37 wt % to about 1.5 wt %, about 0.38 wt % to about 1.5 wt %, about 0.39 wt % to about 1.5 wt %, about 0.4 wt % to about 1.5 wt %, about 0.41 wt % to about 1.5 wt %, about 0.42 wt % to about 1.5 wt %, about 0.43 wt % to about 1.5 wt %, about 0.44 wt % to about 1.5 wt %, about 0.45 wt % to about 1.5 wt %, about 0.46 wt % to about 1.5 wt %, about 0.47 wt % to about 1.5 wt %, about 0.48 wt % to about 1.5 wt %, about 0.49 wt % to about 1.5 wt %, about 0.5 wt % to about 1.5 wt %, about 0.51 wt % to about 1.5 wt %, about 0.52 wt % to about 1.5 wt %, about 0.53 wt % to about 1.5 wt %, about 0.54 wt % to about 1.5 wt %, about 0.55 wt % to about 1.5 wt %, about 0.56 wt % to about 1.5 wt %, about 0.57 wt % to about 1.5 wt %, about 0.58 wt % to about 1.5 wt %, about 0.59 wt % to about 1.5 wt %, about 0.6 wt % to about 1.5 wt %, about 0.61 wt % to about 1.5 wt %, about 0.62 wt % to about 1.5 wt %, about 0.63 wt % to about 1.5 wt %, about 0.64 wt % to about 1.5 wt %, about 0.65 wt % to about 1.5 wt %, about 0.66 wt % to about 1.5 wt %, about 0.67 wt % to about 1.5 wt %, about 0.68 wt % to about 1.5 wt %, about 0.69 wt % to about 1.5 wt %, about 0.7 wt % to about 1.5 wt %, about 0.71 wt % to about 1.5 wt %, about 0.72 wt % to about 1.5 wt %, about 0.73 wt % to about 1.5 wt %, about 0.74 wt % to about 1.5 wt %, about 0.75 wt % to about 1.5 wt %, about 0.76 wt % to about 1.5 wt %, about 0.77 wt % to about 1.5 wt %, about 0.78 wt % to about 1.5 wt %, about 0.79 wt % to about 1.5 wt %, about 0.8 wt % to about 1.5 wt %, about 0.81 wt % to about 1.5 wt %, about 0.82 wt % to about 1.5 wt %, about 0.83 wt % to about 1.5 wt %, about 0.84 wt % to about 1.5 wt %, about 0.85 wt % to about 1.5 wt %, about 0.86 wt % to about 1.5 wt %, about 0.87 wt % to about 1.5 wt %, about 0.88 wt % to about 1.5 wt %, about 0.89 wt % to about 1.5 wt %, about 0.9 wt % to about 1.5 wt %, about 0.91 wt % to about 1.5 wt %, about 0.92 wt % to about 1.5 wt %, about 0.93 wt % to about 1.5 wt %, about 0.94 wt % to about 1.5 wt %, about 0.95 wt % to about 1.5 wt %, about 0.96 wt % to about 1.5 wt %, about 0.97 wt % to about 1.5 wt %, about 0.98 wt % to about 1.5 wt %, about 0.99 wt % to about 1.5 wt %, about 1.0 wt % to about 1.5 wt %, about 1.01 wt % to about 1.5 wt %, about 1.02 wt % to about 1.5 wt %, about 1.03 wt % to about 1.5 wt %, about 1.04 wt % to about 1.5 wt %, about 1.05 wt % to about 1.5 wt %, about 1.06 wt % to about 1.5 wt %, about 1.07 wt % to about 1.5 wt %, about 1.08 wt % to about 1.5 wt %, about 1.09 wt % to about 1.5 wt %, about 1.1 wt % to about 1.5 wt %, about 1.11 wt % to about 1.5 wt %, about 1.12 wt % to about 1.5 wt %, about 1.13 wt % to about 1.5 wt %, about 1.14 wt % to about 1.5 wt %, about 1.15 wt % to about 1.5 wt %, about 1.16 wt % to about 1.5 wt %, about 1.17 wt % to about 1.5 wt %, about 1.18 wt % to about 1.5 wt %, about 1.19 wt % to about 1.5 wt %, about 1.2 wt % to about 1.5 wt %, about 1.21 wt % to about 1.5 wt %, about 1.22 wt % to about 1.5 wt %, about 1.23 wt % to about 1.5 wt %, about 1.24 wt % to about 1.5 wt %, about 1.25 wt % to about 1.5 wt %, about 1.26 wt % to about 1.5 wt %, about 1.27 wt % to about 1.5 wt %, about 1.28 wt % to about 1.5 wt %, about 1.29 wt % to about 1.5 wt %, about 1.3 wt % to about 1.5 wt %, about 1.31 wt % to about 1.5 wt %, about 1.32 wt % to about 1.5 wt %, about 1.33 wt % to about 1.5 wt %, about 1.34 wt % to about 1.5 wt %, about 1.35 wt % to about 1.5 wt %, about 1.36 wt % to about 1.5 wt %, about 1.37 wt % to about 1.5 wt %, about 1.38 wt % to about 1.5 wt %, about 1.39 wt % to about 1.5 wt %, about 1.4 wt % to about 1.5 wt %, about 1.41 wt % to about 1.5 wt %, about 1.42 wt % to about 1.5 wt %, about 1.43 wt % to about 1.5 wt %, about 1.44 wt % to about 1.5 wt %, about 1.45 wt % to about 1.5 wt %, about 1.46 wt % to about 1.5 wt %, about 1.47 wt % to about 1.5 wt %, about 1.48 wt % to about 1.5 wt %, about 1.49 wt % to about 1.5 wt %, about 0.1 wt % to about 1.5 wt %, about 0.1 wt % to about 1.49 wt %, about 0.1 wt % to about 1.48 wt %, about 0.1 wt % to about 1.47 wt %, about 0.1 wt % to about 1.46 wt %, about 0.1 wt % to about 1.45 wt %, about 0.1 wt % to about 1.44 wt %, about 0.1 wt % to about 1.43 wt %, about 0.1 wt % to about 1.42 wt %, about 0.1 wt % to about 1.41 wt %, about 0.1 wt % to about 1.4 wt %, about 0.1 wt % to about 1.39 wt %, about 0.1 wt % to about 1.38 wt %, about 0.1 wt % to about 1.37 wt %, about 0.1 wt % to about 1.36 wt %, about 0.1 wt % to about 1.35 wt %, about 0.1 wt % to about 1.34 wt %, about 0.1 wt % to about 1.33 wt %, about 0.1 wt % to about 1.32 wt %, about 0.1 wt % to about 1.31 wt %, about 0.1 wt % to about 1.3 wt %, about 0.1 wt % to about 1.29 wt %, about 0.1 wt % to about 1.28 wt %, about 0.1 wt % to about 1.27 wt %, about 0.1 wt % to about 1.26 wt %, about 0.1 wt % to about 1.25 wt %, about 0.1 wt % to about 1.24 wt %, about 0.1 wt % to about 1.23 wt %, about 0.1 wt % to about 1.22 wt %, about 0.1 wt % to about 1.21 wt %, about 0.1 wt % to about 1.2 wt %, about 0.1 wt % to about 1.19 wt %, about 0.1 wt % to about 1.18 wt %, about 0.1 wt % to about 1.17 wt %, about 0.1 wt % to about 1.16 wt %, about 0.1 wt % to about 1.15 wt %, about 0.1 wt % to about 1.14 wt %, about 0.1 wt % to about 1.13 wt %, about 0.1 wt % to about 1.12 wt %, about 0.1 wt % to about 1.11 wt %, about 0.1 wt % to about 1.1 wt %, about 0.1 wt % to about 1.09 wt %, about 0.1 wt % to about 1.08 wt %, about 0.1 wt % to about 1.07 wt %, about 0.1 wt % to about 1.06 wt %, about 0.1 wt % to about 1.05 wt %, about 0.1 wt % to about 1.04 wt %, about 0.1 wt % to about 1.03 wt %, about 0.1 wt % to about 1.02 wt %, about 0.1 wt % to about 1.01 wt %, about 0.1 wt % to about 1.0 wt %, about 0.1 wt % to about 0.99 wt %, about 0.1 wt % to about 0.98 wt %, about 0.1 wt % to about 0.97 wt %, about 0.1 wt % to about 0.96 wt %, about 0.1 wt % to about 0.95 wt %, about 0.1 wt % to about 0.94 wt %, about 0.1 wt % to about 0.93 wt %, about 0.1 wt % to about 0.92 wt %, about 0.1 wt % to about 0.91 wt %, about 0.1 wt % to about 0.9 wt %, about 0.1 wt % to about 0.89 wt %, about 0.1 wt % to about 0.88 wt %, about 0.1 wt % to about 0.87 wt %, about 0.1 wt % to about 0.86 wt %, about 0.1 wt % to about 0.85 wt %, about 0.1 wt % to about 0.84 wt %, about 0.1 wt % to about 0.83 wt %, about 0.1 wt % to about 0.82 wt %, about 0.1 wt % to about 0.81 wt %, about 0.1 wt % to about 0.8 wt %, about 0.1 wt % to about 0.79 wt %, about 0.1 wt % to about 0.78 wt %, about 0.1 wt % to about 0.77 wt %, about 0.1 wt % to about 0.76 wt %, about 0.1 wt % to about 0.75 wt %, about 0.1 wt % to about 0.74 wt %, about 0.1 wt % to about 0.73 wt %, about 0.1 wt % to about 0.72 wt %, about 0.1 wt % to about 0.71 wt %, about 0.1 wt % to about 0.7 wt %, about 0.1 wt % to about 0.69 wt %, about 0.1 wt % to about 0.68 wt %, about 0.1 wt % to about 0.67 wt %, about 0.1 wt % to about 0.66 wt %, about 0.1 wt % to about 0.65 wt %, about 0.1 wt % to about 0.64 wt %, about 0.1 wt % to about 0.63 wt %, about 0.1 wt % to about 0.62 wt %, about 0.1 wt % to about 0.61 wt %, about 0.1 wt % to about 0.6 wt %, about 0.1 wt % to about 0.59 wt %, about 0.1 wt % to about 0.58 wt %, about 0.1 wt % to about 0.57 wt %, about 0.1 wt % to about 0.56 wt %, about 0.1 wt % to about 0.55 wt %, about 0.1 wt % to about 0.54 wt %, about 0.1 wt % to about 0.53 wt %, about 0.1 wt % to about 0.52 wt %, about 0.1 wt % to about 0.51 wt %, about 0.1 wt % to about 0.5 wt %, about 0.1 wt % to about 0.49 wt %, about 0.1 wt % to about 0.48 wt %, about 0.1 wt % to about 0.47 wt %, about 0.1 wt % to about 0.46 wt %, about 0.1 wt % to about 0.45 wt %, about 0.1 wt % to about 0.44 wt %, about 0.1 wt % to about 0.43 wt %, about 0.1 wt % to about 0.42 wt %, about 0.1 wt % to about 0.41 wt %, about 0.1 wt % to about 0.4 wt %, about 0.1 wt % to about 0.39 wt %, about 0.1 wt % to about 0.38 wt %, about 0.1 wt % to about 0.37 wt %, about 0.1 wt % to about 0.36 wt %, about 0.1 wt % to about 0.35 wt %, about 0.1 wt % to about 0.34 wt %, about 0.1 wt % to about 0.33 wt %, about 0.1 wt % to about 0.32 wt %, about 0.1 wt % to about 0.31 wt %, about 0.1 wt % to about 0.3 wt %, about 0.1 wt % to about 0.29 wt %, about 0.1 wt % to about 0.28 wt %, about 0.1 wt % to about 0.27 wt %, about 0.1 wt % to about 0.26 wt %, about 0.1 wt % to about 0.25 wt %, about 0.1 wt % to about 0.24 wt %, about 0.1 wt % to about 0.23 wt %, about 0.1 wt % to about 0.22 wt %, about 0.1 wt % to about 0.21 wt %, about 0.1 wt % to about 0.2 wt %, about 0.1 wt % to about 0.19 wt %, about 0.1 wt % to about 0.18 wt %, about 0.1 wt % to about 0.17 wt %, about 0.1 wt % to about 0.16 wt %, about 0.1 wt % to about 0.15 wt %, about 0.1 wt % to about 0.14 wt %, about 0.1 wt % to about 0.13 wt %, about 0.1 wt % to about 0.12 wt %, about 0.1 wt % to about 0.11 wt %, about 0.1 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.2 wt %, about 0.21 wt %, about 0.22 wt %, about 0.23 wt %, about 0.24 wt %, about 0.25 wt %, about 0.26 wt %, about 0.27 wt %, about 0.28 wt %, about 0.29 wt %, about 0.3 wt %, about 0.31 wt %, about 0.22 wt %, about 0.33 wt %, about 0.34 wt %, about 0.35 wt %, about 0.36 wt %, about 0.37 wt %, about 0.38 wt %, about 0.39 wt %, about 0.4 wt %, about 0.41 wt %, about 0.42 wt %, about 0.43 wt %, about 0.44 wt %, about 0.45 wt %, about 0.46 wt %, about 0.47 wt %, about 0.48 wt %, about 0.49 wt %, about 0.5 wt %, about 0.51 wt %, about 0.52 wt %, about 0.53 wt %, about 0.54 wt %, about 0.55 wt %, about 0.56 wt %, about 0.57 wt %, about 0.58 wt %, about 0.59 wt %, about 0.6 wt %, about 0.61 wt %, about 0.62 wt %, about 0.63 wt %, about 0.64 wt %, about 0.65 wt %, about 0.66 wt %, about 0.67 wt %, about 0.68 wt %, about 0.69 wt %, about 0.7 wt %, about 0.71 wt %, about 0.72 wt %, about 0.73 wt %, about 0.74 wt %, about 0.75 wt %, about 0.76 wt %, about 0.77 wt %, about 0.78 wt %, about 0.79 wt %, about 0.8 wt %, about 0.81 wt %, about 0.82 wt %, about 0.83 wt %, about 0.84 wt %, about 0.85 wt %, about 0.86 wt %, about 0.87 wt %, about 0.88 wt %, about 0.89 wt %, about 0.9 wt %, about 0.91 wt %, about 0.92 wt %, about 0.93 wt %, about 0.94 wt %, about 0.95 wt %, about 0.96 wt %, about 0.97 wt %, about 0.98 wt %, about 0.99 wt %, about 1.0 wt %, about 1.01 wt %, about 1.02 wt %, about 1.03 wt %, about 1.04 wt %, about 1.05 wt %, about 1.06 wt %, about 1.07 wt %, about 1.08 wt %, about 1.09 wt %, about 1.1 wt %, about 1.11 wt %, about 1.12 wt %, about 1.13 wt %, about 1.14 wt %, about 1.15 wt %, about 1.16 wt %, about 1.17 wt %, about 1.18 wt %, about 1.19 wt %, about 1.2 wt %, about 1.21 wt %, about 1.22 wt %, about 1.23 wt %, about 1.24 wt %, about 1.25 wt %, about 1.26 wt %, about 1.27 wt %, about 1.28 wt %, about 1.29 wt %, about 1.3 wt %, about 1.31 wt %, about 1.32 wt %, about 1.33 wt %, about 1.34 wt %, about 1.35 wt %, about 1.36 wt %, about 1.37 wt %, about 1.38 wt %, about 1.39 wt %, about 1.4 wt %, about 1.41 wt %, about 1.42 wt %, about 1.43 wt %, about 1.44 wt %, about 1.45 wt %, about 1.46 wt %, about 1.47 wt %, about 1.48 wt %, about 1.49 wt %, about 1.5 wt % of crosslinking agent or any value or range therebetween, based on the total weight of the hydrogel.

Crosslinking agent may be selected from the group consisting of glutaraldehyde, calcium chloride (CaCl₂)), sodium triphosphate, N—N′-methylenebisacrylamide (C₇H₁₀N₂O₂), acetic acid, cucurbit[7]uril (C₄₂H₄₂N₂₈O₁₄) and/or any combinations thereof.

In some embodiments, photo-initiators may be used to initiate crosslinking. For example, photo-crosslinking may be used for some polymers containing double bonds in structure where photo-crosslinking may be used to form a hydrogel matrix. These photo-initiators may accelerate the reaction and stabilize the whole structure of the crosslinking and hydrogel matrix. Examples of photo-initiators may include diphenyl (2,4,6-trimethyl benzoyl) phosphine oxide (TPO photo initiator), ultraviolet (UV) light and more.

### Radiation-Reflecting Inorganic Particle

The hydrogel may comprise about 3 wt % to about 70 wt % of a radiation-reflecting inorganic particle, about 4 wt % to about 70 wt %, about 5 wt % to about 70 wt %, about 6 wt % to about 70 wt %, about 7 wt % to about 70 wt %, about 8 wt % to about 70 wt %, about 9 wt % to about 70 wt %, about 10 wt % to about 70 wt %, about 11 wt % to about 70 wt %, about 12 wt % to about 70 wt %, about 13 wt % to about 70 wt %, about 14 wt % to about 70 wt %, about 15 wt % to about 70 wt %, about 16 wt % to about 70 wt %, about 17 wt % to about 70 wt %, about 18 wt % to about 70 wt %, about 19 wt % to about 70 wt %, about 20 wt % to about 70 wt %, about 21 wt % to about 70 wt %, about 22 wt % to about 70 wt %, about 23 wt % to about 70 wt %, about 24 wt % to about 70 wt %, about 25 wt % to about 70 wt %, about 26 wt % to about 70 wt %, about 27 wt % to about 70 wt %, about 28 wt % to about 70 wt %, about 29 wt % to about 70 wt %, about 30 wt % to about 70 wt %, about 31 wt % to about 70 wt %, about 32 wt % to about 70 wt %, about 33 wt % to about 70 wt %, about 34 wt % to about 70 wt %, about 35 wt % to about 70 wt %, about 36 wt % to about 70 wt %, about 37 wt % to about 70 wt %, about 38 wt % to about 70 wt %, about 39 wt % to about 70 wt %, about 40 wt % to about 70 wt %, about 41 wt % to about 70 wt %, about 42 wt % to about 70 wt %, about 43 wt % to about 70 wt %, about 44 wt % to about 70 wt %, about 45 wt % to about 70 wt %, about 46 wt % to about 70 wt %, about 47 wt % to about 70 wt %, about 48 wt % to about 70 wt %, about 49 wt % to about 70 wt %, about 50 wt % to about 70 wt %, about 51 wt % to about 70 wt %, about 52 wt % to about 70 wt %, about 53 wt % to about 70 wt %, about 54 wt % to about 70 wt %, about 55 wt % to about 70 wt %, about 56 wt % to about 70 wt %, about 57 wt % to about 70 wt %, about 58 wt % to about 70 wt %, about 59 wt % to about 70 wt %, about 60 wt % to about 70 wt %, about 61 wt % to about 70 wt %, about 62 wt % to about 70 wt %, about 63 wt % to about 70 wt %, about 64 wt % to about 70 wt %, about 65 wt % to about 70 wt %, about 66 wt % to about 70 wt %, about 67 wt % to about 70 wt %, about 68 wt % to about 70 wt %, about 69 wt % to about 70 wt %, about 3 wt % to about 69 wt %, about 3 wt % to about 68 wt %, about 3 wt % to about 67 wt %, about 3 wt % to about 66 wt %, about 3 wt % to about 65 wt %, about 3 wt % to about 64 wt %, about 3 wt % to about 63 wt %, about 3 wt % to about 62 wt %, about 3 wt % to about 61 wt %, about 3 wt % to about 60 wt %, about 3 wt % to about 59 wt %, about 3 wt % to about 58 wt %, about 3 wt % to about 57 wt %, about 3 wt % to about 56 wt %, about 3 wt % to about 55 wt %, about 3 wt % to about 54 wt %, about 3 wt % to about 53 wt %, about 3 wt % to about 52 wt %, about 3 wt % to about 51 wt %, about 3 wt % to about 50 wt %, about 3 wt % to about 49 wt %, about 3 wt % to about 48 wt %, about 3 wt % to about 47 wt %, about 3 wt % to about 46 wt %, about 3 wt % to about 45 wt %, about 3 wt % to about 44 wt %, about 3 wt % to about 43 wt %, about 3 wt % to about 42 wt %, about 3 wt % to about 41 wt %, about 3 wt % to about 40 wt %, about 3 wt % to about 39 wt %, about 3 wt % to about 38 wt %, about 3 wt % to about 37 wt %, about 3 wt % to about 36 wt %, about 3 wt % to about 35 wt %, about 3 wt % to about 34 wt %, about 3 wt % to about 33 wt %, about 3 wt % to about 32 wt %, about 3 wt % to about 31 wt %, about 3 wt % to about 30 wt %, about 3 wt % to about 29 wt %, about 3 wt % to about 28 wt %, about 3 wt % to about 27 wt %, about 3 wt % to about 26 wt %, about 3 wt % to about 25 wt %, about 3 wt % to about 24 wt %, about 3 wt % to about 23 wt %, about 3 wt % to about 22 wt %, about 3 wt % to about 21 wt %, about 3 wt % to about 20 wt %, about 3 wt % to about 19 wt %, about 3 wt % to about 18 wt %, about 3 wt % to about 17 wt %, about 3 wt % to about 16 wt %, about 3 wt % to about 15 wt %, about 3 wt % to about 14 wt %, about 3 wt % to about 13 wt %, about 3 wt % to about 12 wt %, about 3 wt % to about 11 wt %, about 3 wt % to about 10 wt %, about 3 wt % to about 9 wt %, about 3 wt % to about 8 wt %, about 3 wt % to about 7 wt %, about 3 wt % to about 6 wt %, about 3 wt % to about 5 wt %, about 3 wt % to about 4 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt % of a radiation-reflecting inorganic particle, or any value or range therebetween, based on the total weight of the hydrogel.

A radiation-reflecting inorganic particle may be selected from the group consisting of barium sulfate, titanium dioxide, calcium carbonate, alumina, zirconia, calcium silicate, silicon dioxide, zinc oxide, zirconium silicate, zinc aluminate, magnesium hydroxide, aluminum hydroxide, zinc stannate, aluminum silicate, zinc silicate, calcium molybdate, magnesium carbonate, zinc carbonate, potassium titanate, sodium aluminum silicate, calcium phosphate, aluminum phosphate, zinc phosphate, magnesium phosphate, magnesium oxide, and combinations thereof. A solar-reflector is a type of radiation-reflecting inorganic particle.

The radiation-reflecting inorganic particle may have an average diameter of about 0.1 μm to about 1 μm, about 0.12 μm to about 1 μm, about 0.14 μm to about 1 μm, about 0.16 μm to about 1 μm, about 0.18 μm to about 1 μm, about 0.2 μm to about 1 μm, about 0.22 μm to about 1 μm, about 0.24 μm to about 1 μm, about 0.26 μm to about 1 μm, about 0.28 μm to about 1 μm, about 0.3 μm to about 1 μm, about 0.32 μm to about 1 μm, about 0.34 μm to about 1 μm, about 0.36 μm to about 1 μm, about 0.38 μm to about 1 μm, about 0.4 μm to about 1 μm, about 0.42 μm to about 1 μm, about 0.44 μm to about 1 μm, about 0.46 μm to about 1 μm, about 0.48 μm to about 1 μm, about 0.5 μm to about 1 μm, about 0.52 μm to about 1 μm, about 0.54 μm to about 1 μm, about 0.56 μm to about 1 μm, about 0.58 μm to about 1 μm, about 0.6 μm to about 1 μm, about 0.62 μm to about 1 μm, about 0.64 μm to about 1 μm, about 0.66 μm to about 1 μm, about 0.68 μm to about 1 μm, about 0.7 μm to about 1 μm, about 0.78 μm to about 1 μm, about 0.8 μm to about 1 μm, about 0.82 μm to about 1 μm, about 0.84 μm to about 1 μm, about 0.86 μm to about 1 μm, about 0.88 μm to about 1 μm, about 0.9 μm to about 1 μm, about 0.92 μm to about 1 μm, about 0.94 μm to about 1 μm, about 0.96 μm to about 1 μm, about 0.98 μm to about 1 μm, about 0.1 μm to about 0.98 μm, about 0.1 μm to about 0.96 μm, about 0.1 μm to about 0.94 μm, about 0.1 μm to about 0.92 μm, about 0.1 μm to about 0.9 μm, about 0.1 μm to about 0.88 μm, about 0.1 μm to about 0.86 μm, about 0.1 μm to about 0.84 μm, about 0.1 μm to about 0.82 μm, about 0.1 μm to about 0.8 μm, about 0.1 μm to about 0.78 μm, about 0.1 μm to about 0.76 μm, about 0.1 μm to about 0.74 μm, about 0.1 μm to about 0.72 μm, about 0.1 μm to about 0.7 μm, about 0.1 μm to about 0.68 μm, about 0.1 μm to about 0.66 μm, about 0.1 μm to about 0.64 μm, about 0.1 μm to about 0.62 μm, about 0.1 μm to about 0.6 μm, about 0.1 μm to about 0.58 μm, about 0.1 μm to about 0.56 μm, about 0.1 μm to about 0.54 μm, about 0.1 μm to about 0.52 μm, about 0.1 μm to about 0.5 μm, about 0.1 μm to about 0.48 μm, about 0.1 μm to about 0.46 μm, about 0.1 μm to about 0.44 μm, about 0.1 μm to about 0.42 μm, about 0.1 μm to about 0.4 μm, about 0.1 μm to about 0.38 μm, about 0.1 μm to about 0.36 μm, about 0.1 μm to about 0.34 μm, about 0.1 μm to about 0.32 μm, about 0.1 μm to about 0.3 μm, about 0.1 μm to about 0.28 μm, about 0.1 μm to about 0.26 μm, about 0.1 μm to about 0.24 μm, about 0.1 μm to about 0.22 μm, about 0.1 μm to about 0.2 μm, about 0.1 μm to about 0.18 μm, about 0.1 μm to about 0.16 μm, about 0.1 μm to about 0.14 μm, about 0.1 μm to about 0.12 μm, about 0.1 μm, about 0.12 μm, about 0.14 μm, about 0.16 μm, about 0.18 μm, about 0.2 μm, about 0.22 μm, about 0.24 μm, about 0.26 μm, about 0.28 μm, about 0.3 μm, about 0.32 μm, about 0.32 μm, about 0.34 μm, about 0.36 μm, about 0.38 μm, about 0.4 μm, about 0.42 μm, about 0.44 μm, about 0.46 μm, about 0.48 μm, about 0.5 μm, about 0.52 μm, about 0.54 μm, about 0.56 μm, about 0.58 μm, about 0.6 μm, about 0.62 μm, about 0.64 μm, about 0.66 μm, about 0.68 μm, about 0.7 μm, about 0.72 μm, about 0.74 μm, about 0.76 μm, about 0.78 μm, about 0.8 μm, about 0.82 μm, about 0.84 μm, about 0.86 μm, about 0.88 μm, about 0.9 μm, about 0.92 μm, about 0.94 μm, about 0.96 μm, about 0.98 μm, about 1 μm, or any value or range therebetween.

### Water

The hydrogel may comprise water.

The hydrogel may comprise about 20 wt % to about 75 wt % of total water (e.g. bound water, free water and intermediate water), about 21 wt % to about 75 wt %, about 22 wt % to about 75 wt %, about 23 wt % to about 75 wt %, about 24 wt % to about 75 wt %, about 25 wt % to about 75 wt %, about 26 wt % to about 75 wt %, about 27 wt % to about 75 wt %, about 28 wt % to about 75 wt %, about 29 wt % to about 75 wt %, about 30 wt % to about 75 wt %, about 31 wt % to about 75 wt %, about 32 wt % to about 75 wt %, about 33 wt % to about 75 wt %, about 34 wt % to about 75 wt %, about 35 wt % to about 75 wt %, about 36 wt % to about 75 wt %, about 37 wt % to about 75 wt %, about 38 wt % to about 75 wt %, about 39 wt % to about 75 wt %, about 40 wt % to about 75 wt %, about 41 wt % to about 75 wt %, about 42 wt % to about 75 wt %, about 43 wt % to about 75 wt %, about 44 wt % to about 75 wt %, about 45 wt % to about 75 wt %, about 46 wt % to about 75 wt %, about 47 wt % to about 75 wt %, about 48 wt % to about 75 wt %, about 49 wt % to about 75 wt %, about 50 wt % to about 75 wt %, about 51 wt % to about 75 wt %, about 52 wt % to about 75 wt %, about 53 wt % to about 75 wt %, about 54 wt % to about 75 wt %, about 55 wt % to about 75 wt %, about 56 wt % to about 75 wt %, about 57 wt % to about 75 wt %, about 58 wt % to about 75 wt %, about 59 wt % to about 75 wt %, about 60 wt % to about 75 wt %, about 61 wt % to about 75 wt %, about 62 wt % to about 75 wt %, about 63 wt % to about 75 wt %, about 64 wt % to about 75 wt %, about 65 wt % to about 75 wt %, about 66 wt % to about 75 wt %, about 67 wt % to about 75 wt %, about 68 wt % to about 75 wt %, about 69 wt % to about 75 wt %, about 70 wt % to about 75 wt %, about 71 wt % to about 75 wt %, about 72 wt % to about 75 wt %, about 73 wt % to about 75 wt %, about 74 wt % to about 75 wt %, about 20 wt % to about 74 wt %, about 20 wt % to about 73 wt %, about 20 wt % to about 72 wt %, about 20 wt % to about 71 wt %, about 20 wt % to about 70 wt %, about 20 wt % to about 69 wt %, about 20 wt % to about 68 wt %, about 20 wt % to about 67 wt %, about 20 wt % to about 66 wt %, about 20 wt % to about 65 wt %, about 20 wt % to about 64 wt %, about 20 wt % to about 63 wt %, about 20 wt % to about 62 wt %, about 20 wt % to about 61 wt %, about 20 wt % to about 60 wt %, about 20 wt % to about 59 wt %, about 20 wt % to about 58 wt %, about 20 wt % to about 57 wt %, about 20 wt % to about 56 wt %, about 20 wt % to about 55 wt %, about 20 wt % to about 54 wt %, about 20 wt % to about 53 wt %, about 20 wt % to about 52 wt %, about 20 wt % to about 51 wt %, about 20 wt % to about 50 wt %, about 20 wt % to about 49 wt %, about 20 wt % to about 48 wt %, about 20 wt % to about 47 wt %, about 20 wt % to about 46 wt %, about 20 wt % to about 45 wt %, about 20 wt % to about 44 wt %, about 20 wt % to about 43 wt %, about 20 wt % to about 42 wt %, about 20 wt % to about 41 wt %, about 20 wt % to about 40 wt %, about 20 wt % to about 39 wt %, about 20 wt % to about 38 wt %, about 20 wt % to about 37 wt %, about 20 wt % to about 36 wt %, about 20 wt % to about 35 wt %, about 20 wt % to about 34 wt %, about 20 wt % to about 33 wt %, about 20 wt % to about 32 wt %, about 20 wt % to about 31 wt %, about 20 wt % to about 30 wt %, about 20 wt % to about 29 wt %, about 20 wt % to about 28 wt %, about 20 wt % to about 27 wt %, about 20 wt % to about 26 wt %, about 20 wt % to about 25 wt %, about 20 wt % to about 24 wt %, about 20 wt % to about 23 wt %, about 20 wt % to about 22 wt %, about 20 wt % to about 21 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt %, about 71 wt %, about 72 wt %, about 73 wt %, about 74 wt %, about 75 wt % of total water, or any value or range therebetween, based on the total weight of hydrogel.

The hydrogel may comprise about 20 wt % to about 50 wt % of total water (e.g. bound water, free water and intermediate water), about 25 wt % to about 50 wt %, about 30 wt % to about 50 wt %, about 35 wt % to about 50 wt %, about 40 wt % to about 50 wt %, about 45 wt % to about 50 wt %, about 20 wt % to about 45 wt %, about 20 wt % to about 40 wt %, about 20 wt % to about 35 wt %, about 20 wt % to about 30 wt %, about 20 wt % to about 25 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, of total water, or any value or range therebetween, based on the total weight of hydrogel.

The hydrogel may comprise about 15 wt % to about 65 wt % of free water and intermediate water, about 15 wt % to about 64 wt %, about 15 wt % to about 63 wt %, about 15 wt % to about 62 wt %, about 15 wt % to about 61 wt %, about 15 wt % to about 60 wt %, about 15 wt % to about 59 wt %, about 15 wt % to about 58 wt %, about 15 wt % to about 57 wt %, about 15 wt % to about 56 wt %, about 15 wt % to about 55 wt %, about 15 wt % to about 54 wt %, about 15 wt % to about 53 wt %, about 15 wt % to about 52 wt %, about 15 wt % to about 51 wt %, about 15 wt % to about 50 wt %, about 15 wt % to about 49 wt %, about 15 wt % to about 48 wt %, about 15 wt % to about 47 wt %, about 15 wt % to about 46 wt %, about 15 wt % to about 45 wt %, about 15 wt % to about 44 wt %, about 15 wt % to about 43 wt %, about 15 wt % to about 42 wt %, about 15 wt % to about 41 wt %, about 15 wt % to about 40 wt %, about 15 wt % to about 39 wt %, about 15 wt % to about 38 wt %, about 15 wt % to about 37 wt %, about 15 wt % to about 36 wt %, about 15 wt % to about 35 wt %, about 15 wt % to about 34 wt %, about 15 wt % to about 33 wt %, about 15 wt % to about 32 wt %, about 15 wt % to about 31 wt %, about 15 wt % to about 30 wt %, about 15 wt % to about 29 wt %, about 15 wt % to about 28 wt %, about 15 wt % to about 27 wt %, about 15 wt % to about 26 wt %, about 15 wt % to about 25 wt %, about 15 wt % to about 24 wt %, about 15 wt % to about 23 wt %, about 15 wt % to about 22 wt %, about 15 wt % to about 21 wt %, about 15 wt % to about 20 wt %, about 15 wt % to about 19 wt %, about 15 wt % to about 18 wt %, about 15 wt % to about 17 wt %, about 15 wt % to about 16 wt %, about 15 wt % to about 65 wt %, about 16 wt % to about 65 wt %, about 17 wt % to about 65 wt %, about 18 wt % to about 65 wt %, about 19 wt % to about 65 wt %, about 20 wt % to about 65 wt %, about 21 wt % to about 65 wt %, about 22 wt % to about 65 wt %, about 23 wt % to about 65 wt %, about 24 wt % to about 65 wt %, about 25 wt % to about 65 wt %, about 26 wt % to about 65 wt %, about 27 wt % to about 65 wt %, about 28 wt % to about 65 wt %, about 29 wt % to about 65 wt %, about 30 wt % to about 65 wt %, about 31 wt % to about 65 wt %, about 32 wt % to about 65 wt %, about 33 wt % to about 65 wt %, about 34 wt % to about 65 wt %, about 35 wt % to about 65 wt %, about 36 wt % to about 65 wt %, about 37 wt % to about 65 wt %, about 38 wt % to about 65 wt %, about 39 wt % to about 65 wt %, about 40 wt % to about 65 wt %, about 41 wt % to about 65 wt %, about 42 wt % to about 65 wt %, about 43 wt % to about 65 wt %, about 44 wt % to about 65 wt %, about 45 wt % to about 65 wt %, about 46 wt % to about 65 wt %, about 47 wt % to about 65 wt %, about 48 wt % to about 65 wt %, about 49 wt % to about 65 wt %, about 50 wt % to about 65 wt %, about 51 wt % to about 65 wt %, about 52 wt % to about 65 wt %, about 53 wt % to about 65 wt %, about 54 wt % to about 65 wt %, about 55 wt % to about 65 wt %, about 56 wt % to about 65 wt %, about 57 wt % to about 65 wt %, about 58 wt % to about 65 wt %, about 59 wt % to about 65 wt %, about 60 wt % to about 65 wt %, about 61 wt % to about 65 wt %, about 62 wt % to about 65 wt %, about 63 wt % to about 65 wt %, about 64 wt % to about 65 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt % of free water and intermediate water, or any value or range therebetween, based on the total weight of hydrogel.

The hydrogel may comprise about 15 wt % to about 45 wt % of free water and intermediate water, about 15 wt % to about 40 wt %, about 15 wt % to about 35 wt %, about 15 wt % to about 30 wt %, about 15 wt % to about 25 wt %, about 15 wt % to about 20 wt %, about 20 wt % to about 45 wt %, about 25 wt % to about 45 wt %, about 30 wt % to about 45 wt %, about 35 wt % to about 45 wt %, about 40 wt % to about 45 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, of free water and intermediate water, or any value or range therebetween, based on the total weight of hydrogel.

The hydrogel may comprise chemical and/or physical crosslinks. The hydrogel may comprise multi-crosslinks which are chemical and physical crosslinks.

The multi-crosslinked hydrogel may comprise a framework comprising crosslinked polymeric chains that form a polymeric matrix, radiation-reflecting inorganic particles homogenously distributed in the polymeric matrix, and hydrogen bonds among the radiation-reflecting inorganic particles, and the polymeric matrix.

The hydrogel may comprise pores with an average pore diameter of about 1 μm to about 10 μm, about 1.2 μm to about 10 μm, about 1.4 μm to about 10 μm, about 1.6 μm to about 10 μm, about 1.8 μm to about 10 μm, about 2 μm to about 10 μm, about 2.2 μm to about 10 μm, about 2.4 μm to about 10 μm, about 2.6 μm to about 10 μm, about 2.8 μm to about 10 μm, about 3 μm to about 10 μm, about 3.2 μm to about 10 μm, about 3.4 μm to about 10 μm, about 3.6 μm to about 10 μm, about 3.8 μm to about 10 μm, about 4 μm to about 10 μm, about 4.2 μm to about 10 μm, about 4.4 μm to about 10 μm, about 4.6 μm to about 10 μm, about 4.8 μm to about 10 μm, about 5 μm to about 10 μm, about 5.2 μm to about 10 μm, about 5.4 μm to about 10 μm, about 5.6 μm to about 10 μm, about 5.8 μm to about 10 μm, about 6 μm to about 10 μm, about 6.2 μm to about 10 μm, about 6.4 μm to about 10 μm, about 6.6 μm to about 10 μm, about 6.8 μm to about 10 μm, about 7 μm to about 10 μm, about 7.2 μm to about 10 μm, about 7.4 μm to about 10 μm, about 7.6 μm to about 10 μm, about 7.8 μm to about 10 μm, about 8 μm to about 10 μm, about 8.2 μm to about 10 μm, about 8.4 μm to about 10 μm, about 8.6 μm to about 10 μm, about 8.8 μm to about 10 μm, about 9 μm to about 10 μm, about 9.2 μm to about 10 μm, about 9.4 μm to about 10 μm, about 0.6 μm to about 10 μm, about 9.8 μm to about 10 μm, about 1 μm to about 9.8 μm, about 1 μm to about 9.6 μm, about 1 μm to about 9.4 μm, about 1 μm to about 9.2 μm, about 1 μm to about 8 μm, about 1 μm to about 8.8 μm, about 1 μm to about 8.6 μm, about 1 μm to about 8.4 μm, about 1 μm to about 8.2 μm, about 1 μm to about 8 μm, about 1 μm to about 7.8 μm, about 1 μm to about 7.6 μm, about 1 μm to about 7.4 μm, about 1 μm to about 7.2 μm, about 1 μm to about 7 μm, about 1 μm to about 6.8 μm, about 1 μm to about 6.6 μm, about 1 μm to about 6.4 μm, about 1 μm to about 6.2 μm, about 1 μm to about 6 μm, about 1 μm to about 5.8 μm, about 1 μm to about 5.6 μm, about 1 μm to about 5.4 μm, about 1 μm to about 5.2 μm, about 1 μm to about 5 μm, about 1 μm to about 4.8 μm, about 1 μm to about 4.6 μm, about 1 μm to about 4.4 μm, about 1 μm to about 4.2 μm, about 1 μm to about 4 μm, about 1 μm to about 3.8 μm, about 1 μm to about 3.6 μm, about 1 μm to about 3.4 μm, about 1 μm to about 3.2 μm, about 1 μm to about 3 μm, about 1 μm to about 2.8 μm, about 1 μm to about 2.6 μm, about 1 μm to about 2.4 μm, about 1 μm to about 2.2 μm, about 1 μm to about 2 μm, about 1 μm to about 1.8 μm, about 1 μm to about 1.6 μm, about 1 μm to about 1.4 μm, about 1 μm to about 1.2 μm, about 1 μm, about 1.2 μm, about 1.4 μm, about 1.6 μm, about 1.8 μm, about 2 μm, about 2.2 μm, about 2.4 μm, about 2.6 μm, about 2.8 μm, about 3 μm, about 3.2 μm, about 3.4 μm, about 3.6 μm, about 3.8 μm, about 4 μm, about 4.2 μm, about 4.4 μm, about 4.6 μm, about 4.8 μm, about 5 μm, about 5.2 μm, about 5.4 μm, about 5.6 μm, about 5.8 μm, about 6 μm, about 6.2 μm, about 6.4 μm, about 6.6 μm, about 6.8 μm, about 7 μm, about 7.2 μm, about 7.4 μm, about 7.6 μm, about 7.8 μm, about 8 μm, about 8.2 μm, about 8.4 μm, about 8.6 μm, about 8.8 μm, about 9 μm, about 9.2 μm, about 9.4 μm, about 9.6 μm, about 9.8 μm, about 10 μm, or any value or range therebetween.

The hydrogel may have a thickness of about 1 mm to about 20 mm, about 2 mm to about 20 mm, about 3 mm to about 20 mm, about 4 mm to about 20 mm, about 5 mm to about 20 mm, about 6 mm to about 20 mm, about 7 mm to about 20 mm, about 8 mm to about 20 mm, about 9 mm to about 20 mm, about 10 mm to about 20 mm, about 11 mm to about 20 mm, about 12 mm to about 20 mm, about 13 mm to about 20 mm, about 14 mm to about 20 mm, about 15 mm to about 20 mm, about 16 mm to about 20 mm, about 17 mm to about 20 mm, about 18 mm to about 20 mm, about 19 mm to about 20 mm, about 1 mm to about 19 mm, about 1 mm to about 18 mm, about 1 mm to about 17 mm, about 1 mm to about 16 mm, about 1 mm to about 15 mm, about 1 mm to about 14 mm, about 1 mm to about 13 mm, about 1 mm to about 12 mm, about 1 mm to about 11 mm, about 1 mm to about 10 mm, about 1 mm to about 9 mm, about 1 mm to about 8 mm, about 1 mm to about 7 mm, about 1 mm to about 6 mm, about 1 mm to about 5 mm, about 1 mm to about 4 mm, about 1 mm to about 3 mm, about 1 mm to about 2 mm, about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, or any value or range therebetween.

The hydrogel may comprise PVA, glutaraldehyde, and barium sulfate. The hydrogel may comprise water, PVA, glutaraldehyde, and barium sulfate.

### Method of Preparing Hydrogel

The present invention relates to a method of preparing a hydrogel, wherein the method may comprise the following steps: (i) preparing a mixture of water-soluble polymer, inorganic acid, and radiation-reflecting inorganic particles; (ii) adding a crosslinking agent to the mixture to form a hydrogel precursor; (iii) freezing and thawing the hydrogel precursor thereby forming a hydrogel, wherein the hydrogel precursor may comprise about 5 wt % to about 30 wt % of water-soluble polymer; about 0.3 wt % to about 2.5 wt % of inorganic acid; about 0.05 wt % to about 0.5 wt % of crosslinking agent; and about 3 wt % to about 70 wt % of a radiation-reflecting inorganic particle, wherein the wt % is based on the total weight of the hydrogel precursor.

The present invention also relates to a method of preparing a hydrogel, wherein the method may comprise the following steps: (i) preparing a mixture of water-soluble polymer, inorganic acid, and radiation-reflecting inorganic particles; (ii) adding a crosslinking agent to the mixture to form a hydrogel precursor; (iii) freezing and thawing the hydrogel precursor thereby forming a hydrogel, wherein the hydrogel precursor may comprise about 5 wt % to about 25 wt % of water-soluble polymer; about 0.3 wt % to about 1.2 wt % of inorganic acid; about 0.05 wt % to about 0.25 wt % of crosslinking agent; and about 30 wt % to about 70 wt % of a radiation-reflecting inorganic particle, wherein the wt % is based on the total weight of the hydrogel precursor.

The hydrogel prepared using the method may be a hydrogel disclosed above.

Step (i) may comprise preparing a mixture of water-soluble polymer, inorganic acid, and radiation-reflecting inorganic particles. Step (i) may be performed at an acidic pH, which may be pH of 7 or lower; pH of 6 or lower; pH of 5 or lower; pH of 4 or lower; pH of 3 or lower; pH of 2 or lower; or pH 1 or lower.

Step (i) may further comprise (ia) preparing a mixture of inorganic acid and radiation-reflecting inorganic particles to form a dispersion; and (ib) mixing the dispersion with water-soluble polymer.

Step (ii) may comprise adding a crosslinking agent to the mixture of step (i) to form a hydrogel precursor. Chemical crosslinks within the hydrogel may be formed in step (ii).

Chemical crosslinking is the formation of a covalent chemical bonds between polymer chains. These crosslinks form by chemical reactions may be initiated through crosslinking agents, heat, pressure, change in pH, or irradiation. In one embodiment, glutaraldehyde (GA) may be used as a crosslinking agent for forming a crosslinked hydrogel matrix. The reaction may be under acidic condition.

Step (iii) comprises freezing and thawing the hydrogel precursor. Physical crosslinks within the hydrogel may be formed in step (iii). During the freezing and thawing process, the polymeric chains of a water-soluble polymer may be bent and entangled even more in the hydrogel. When the hydrogel precursor undergoes freezing, the hydrogel precursor may form more hydrogen bonds and form stronger interactions. After repeating the processing of freezing and thawing, the hydrogel may be entangled even further, leaving small void spaces and pore sizes with more hydrogen bonding, and produce a more stable hydrogel. Hence, a freeze-thawing process may provide mechanical enhancement. The freeze-thawing process may be cycled (or repeated) to form more physical crosslinks and hence increased mechanical enhancement.

Physical crosslinking is the formation of interactions (e.g., molecules entanglement, ionic bonds, hydrogen bond, hydrophobic interaction, or crystallization of polymer chain) between polymer chains.

The hydrogel of the present invention may be fabricated to comprise both chemical and physical crosslinking. When these physical and chemical crosslinks are formed, it improves the mechanical strength/properties (such as mechanical stability in terms of durability, foldability, flexibility, and puncture-resistance) and elasticity of the hydrogel.

The freezing and thawing in step (iii) may be repeated where the hydrogel of the present invention undergoes freezing and then subsequently thawing, followed by freezing and then thawing and so on. The freeze-thawing process may be repeated at least once, at least twice, at least thrice and more (e.g. four, five, six and more) times.

Step (iii) may comprise freezing the mixture at a temperature of about −40° C. to about −20° C. The temperature for freezing the mixture may be of about −40° C. to about −20° C., of about −35° C. to about −20° C., of about −30° C. to about −20° C., of about −25° C. to about −20° C., of about −40° C. to about −25° C., of about −40° C. to about −30° C., of about −40° C. to about −35° C., of about −40° C., of about −35° C., of about −30° C., of about −25° C., of about −20° C., or any value or range therebetween.

Step (iii) may comprise freezing the mixture for a duration of about 6 hours to about 12 hours The duration for freezing the mixture may be of about 6 hours to about 12 hours, of about 6.5 hours to about 12 hours, of about 7 hours to about 12 hours, of about 7.5 hours to about 12 hours, of about 8 hours to about 12 hours, of about 8.5 hours to about 12 hours, of about 9 hours to about 12 hours, of about 9.5 hours to about 12 hours, of about 9.5 hours to about 12 hours, of about 10 hours to about 12 hours, of about 10.5 hours to about 12 hours, of about 11 hours to about 12 hours, of about 11.5 hours to about 12 hours, of about 6 hours to about 11.5 hours, of about 6 hours to about 11 hours, of about 6 hours to about 10.5 hours, of about 6 hours to about 10 hours, of about 6 hours to about 9.5 hours, of about 6 hours to about 9 hours, of about 6 hours to about 8.5 hours, of about 6 hours to about 8 hours, of about 6 hours to about 7.5 hours, of about 6 hours to about 7 hours, of about 6 hours to about 6.5 hours, of about 6 hours, of about 6.5 hours, of about 7 hours, of about 7.5 hours, of about 8 hours, of about 8.5 hours, of about 9 hours, of about 9.5 hours, of about 10 hours, of about 10.5 hours, of about 11 hours, of about 11.5 hours, of about 12 hours, or any value or range therebetween.

Step (iii) may comprise thawing the mixture at a temperature of about 20° C. to about 30° C. The temperature for thawing the mixture may be of about 20° C. to about 30° C., of about 21° C. to about 30° C., of about 22° C. to about 30° C., of about 23° C. to about 30° C., of about 24° C. to about 30° C., of about 25° C. to about 30° C., of about 26° C. to about 30° C., of about 27° C. to about 30° C., of about 28° C. to about 30° C., of about 29° C. to about 30° C., of about 20° C. to about 29° C., of about 20° C. to about 28° C., of about 20° C. to about 27° C., of about 20° C. to about 26° C., of about 20° C. to about 25° C., of about 20° C. to about 24° C., of about 20° C. to about 23° C., of about 20° C. to about 22° C., of about 20° C. to about 21° C., about 20° C., about 21° C., about 22° C., about 23° C., about 24° C., about 25° C., about 26° C., about 27° C., about 28° C., about 29° C., about 30° C., or any value or range therebetween.

Step (iii) may comprise thawing the mixture for a duration of about 0.5 hours to about 3.5 hours. The duration for thawing the mixture may be of about 0.5 hours to about 3.5 hours, of about 1 hours to about 3.5 hours, of about 1.5 hours to about 3.5 hours, of about 2 hours to about 3.5 hours, of about 2.5 hours to about 3.5 hours, of about 3 hours to about 3.5 hours, of about 0.5 hours to about 3 hours, of about 0.5 hours to about 2.5 hours, of about 0.5 hours to about 2 hours, of about 0.5 hours to about 1.5 hours, of about 0.5 hours to about 1 hours, of about 0.5 hours, of about 1 hours, of about 1.5 hours, of about 2 hours, of about 2.5 hours, of about 3 hours, of about 3.5 hours, or any value or range therebetween.

### Hydrogel Prepared by the Method

The present invention relates to a hydrogel obtained by the method as disclosed herein. The present invention also relates to a hydrogel prepared by freeze-thawing the hydrogel precursor as disclosed herein.

The hydrogel obtained by the method may comprise chemical and/or physical crosslinks. The hydrogel obtained by the method may comprise multi-crosslinks which are chemical and physical crosslinks.

The multi-crosslinked hydrogel obtained by the method as disclosed herein may comprise a framework comprising crosslinked polymeric chains that form a polymeric matrix, radiation-reflecting inorganic particles homogenously distributed in the polymeric matrix, and hydrogen bonds among the radiation-reflecting inorganic particles, and the polymeric matrix.

The hydrogel obtained by the method as disclosed herein may comprise pores with an average pore diameter of about 1 μm to about 10 μm, about 1.2 μm to about 10 μm, about 1.4 μm to about 10 μm, about 1.6 μm to about 10 μm, about 1.8 μm to about 10 μm, about 2 μm to about 10 μm, about 2.2 μm to about 10 μm, about 2.4 μm to about 10 μm, about 2.6 μm to about 10 μm, about 2.8 μm to about 10 μm, about 3 μm to about 10 μm, about 3.2 μm to about 10 μm, about 3.4 μm to about 10 μm, about 3.6 μm to about 10 μm, about 3.8 μm to about 10 μm, about 4 μm to about 10 μm, about 4.2 μm to about 10 μm, about 4.4 μm to about 10 μm, about 4.6 μm to about 10 μm, about 4.8 μm to about 10 μm, about 5 μm to about 10 μm, about 5.2 μm to about 10 μm, about 5.4 μm to about 10 μm, about 5.6 μm to about 10 μm, about 5.8 μm to about 10 μm, about 6 μm to about 10 μm, about 6.2 μm to about 10 μm, about 6.4 μm to about 10 μm, about 6.6 μm to about 10 μm, about 6.8 μm to about 10 μm, about 7 μm to about 10 μm, about 7.2 μm to about 10 μm, about 7.4 μm to about 10 μm, about 7.6 μm to about 10 μm, about 7.8 μm to about 10 μm, about 8 μm to about 10 μm, about 8.2 μm to about 10 μm, about 8.4 μm to about 10 μm, about 8.6 μm to about 10 μm, about 8.8 μm to about 10 μm, about 9 μm to about 10 μm, about 9.2 μm to about 10 μm, about 9.4 μm to about 10 μm, about 0.6 μm to about 10 μm, about 9.8 μm to about 10 μm, about 1 μm to about 9.8 μm, about 1 μm to about 9.6 μm, about 1 μm to about 9.4 μm, about 1 μm to about 9.2 μm, about 1 μm to about 8 μm, about 1 μm to about 8.8 μm, about 1 μm to about 8.6 μm, about 1 μm to about 8.4 μm, about 1 μm to about 8.2 μm, about 1 μm to about 8 μm, about 1 μm to about 7.8 μm, about 1 μm to about 7.6 μm, about 1 μm to about 7.4 μm, about 1 μm to about 7.2 μm, about 1 μm to about 7 μm, about 1 μm to about 6.8 μm, about 1 μm to about 6.6 μm, about 1 μm to about 6.4 μm, about 1 μm to about 6.2 μm, about 1 μm to about 6 μm, about 1 μm to about 5.8 μm, about 1 μm to about 5.6 μm, about 1 μm to about 5.4 μm, about 1 μm to about 5.2 μm, about 1 μm to about 5 μm, about 1 μm to about 4.8 μm, about 1 μm to about 4.6 μm, about 1 μm to about 4.4 μm, about 1 μm to about 4.2 μm, about 1 μm to about 4 μm, about 1 μm to about 3.8 μm, about 1 μm to about 3.6 μm, about 1 μm to about 3.4 μm, about 1 μm to about 3.2 μm, about 1 μm to about 3 μm, about 1 μm to about 2.8 μm, about 1 μm to about 2.6 μm, about 1 μm to about 2.4 μm, about 1 μm to about 2.2 μm, about 1 μm to about 2 μm, about 1 μm to about 1.8 μm, about 1 μm to about 1.6 μm, about 1 μm to about 1.4 μm, about 1 μm to about 1.2 μm, about 1 μm, about 1.2 μm, about 1.4 μm, about 1.6 μm, about 1.8 μm, about 2 μm, about 2.2 μm, about 2.4 μm, about 2.6 μm, about 2.8 μm, about 3 μm, about 3.2 μm, about 3.4 μm, about 3.6 μm, about 3.8 μm, about 4 μm, about 4.2 μm, about 4.4 μm, about 4.6 μm, about 4.8 μm, about 5 μm, about 5.2 μm, about 5.4 μm, about 5.6 μm, about 5.8 μm, about 6 μm, about 6.2 μm, about 6.4 μm, about 6.6 μm, about 6.8 μm, about 7 μm, about 7.2 μm, about 7.4 μm, about 7.6 μm, about 7.8 μm, about 8 μm, about 8.2 μm, about 8.4 μm, about 8.6 μm, about 8.8 μm, about 9 μm, about 9.2 μm, about 9.4 μm, about 9.6 μm, about 9.8 μm, about 10 μm, or any value or range therebetween.

The hydrogel obtained by the method as disclosed herein may have a thickness of about 1 mm to about 20 mm, about 2 mm to about 20 mm, about 3 mm to about 20 mm, about 4 mm to about 20 mm, about 5 mm to about 20 mm, about 6 mm to about 20 mm, about 7 mm to about 20 mm, about 8 mm to about 20 mm, about 9 mm to about 20 mm, about 10 mm to about 20 mm, about 11 mm to about 20 mm, about 12 mm to about 20 mm, about 13 mm to about 20 mm, about 14 mm to about 20 mm, about 15 mm to about 20 mm, about 16 mm to about 20 mm, about 17 mm to about 20 mm, about 18 mm to about 20 mm, about 19 mm to about 20 mm, about 1 mm to about 19 mm, about 1 mm to about 18 mm, about 1 mm to about 17 mm, about 1 mm to about 16 mm, about 1 mm to about 15 mm, about 1 mm to about 14 mm, about 1 mm to about 13 mm, about 1 mm to about 12 mm, about 1 mm to about 11 mm, about 1 mm to about 10 mm, about 1 mm to about 9 mm, about 1 mm to about 8 mm, about 1 mm to about 7 mm, about 1 mm to about 6 mm, about 1 mm to about 5 mm, about 1 mm to about 4 mm, about 1 mm to about 3 mm, about 1 mm to about 2 mm, about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, or any value or range therebetween.

The hydrogel obtained by the method as disclosed herein may comprise PVA, glutaraldehyde, and barium sulfate. The hydrogel as disclosed herein may comprise water, PVA, glutaraldehyde, and barium sulfate.

The hydrogel obtained by the method as disclosed herein may comprise water.

The hydrogel obtained by the method as disclosed herein may comprise about 20 wt % to about 75 wt % of total water (e.g. bound water, free water and intermediate water), about 21 wt % to about 75 wt %, about 22 wt % to about 75 wt %, about 23 wt % to about 75 wt %, about 24 wt % to about 75 wt %, about 25 wt % to about 75 wt %, about 26 wt % to about 75 wt %, about 27 wt % to about 75 wt %, about 28 wt % to about 75 wt %, about 29 wt % to about 75 wt %, about 30 wt % to about 75 wt %, about 31 wt % to about 75 wt %, about 32 wt % to about 75 wt %, about 33 wt % to about 75 wt %, about 34 wt % to about 75 wt %, about 35 wt % to about 75 wt %, about 36 wt % to about 75 wt %, about 37 wt % to about 75 wt %, about 38 wt % to about 75 wt %, about 39 wt % to about 75 wt %, about 40 wt % to about 75 wt %, about 41 wt % to about 75 wt %, about 42 wt % to about 75 wt %, about 43 wt % to about 75 wt %, about 44 wt % to about 75 wt %, about 45 wt % to about 75 wt %, about 46 wt % to about 75 wt %, about 47 wt % to about 75 wt %, about 48 wt % to about 75 wt %, about 49 wt % to about 75 wt %, about 50 wt % to about 75 wt %, about 51 wt % to about 75 wt %, about 52 wt % to about 75 wt %, about 53 wt % to about 75 wt %, about 54 wt % to about 75 wt %, about 55 wt % to about 75 wt %, about 56 wt % to about 75 wt %, about 57 wt % to about 75 wt %, about 58 wt % to about 75 wt %, about 59 wt % to about 75 wt %, about 60 wt % to about 75 wt %, about 61 wt % to about 75 wt %, about 62 wt % to about 75 wt %, about 63 wt % to about 75 wt %, about 64 wt % to about 75 wt %, about 65 wt % to about 75 wt %, about 66 wt % to about 75 wt %, about 67 wt % to about 75 wt %, about 68 wt % to about 75 wt %, about 69 wt % to about 75 wt %, about 70 wt % to about 75 wt %, about 71 wt % to about 75 wt %, about 72 wt % to about 75 wt %, about 73 wt % to about 75 wt %, about 74 wt % to about 75 wt %, about 20 wt % to about 74 wt %, about 20 wt % to about 73 wt %, about 20 wt % to about 72 wt %, about 20 wt % to about 71 wt %, about 20 wt % to about 70 wt %, about 20 wt % to about 69 wt %, about 20 wt % to about 68 wt %, about 20 wt % to about 67 wt %, about 20 wt % to about 66 wt %, about 20 wt % to about 65 wt %, about 20 wt % to about 64 wt %, about 20 wt % to about 63 wt %, about 20 wt % to about 62 wt %, about 20 wt % to about 61 wt %, about 20 wt % to about 60 wt %, about 20 wt % to about 59 wt %, about 20 wt % to about 58 wt %, about 20 wt % to about 57 wt %, about 20 wt % to about 56 wt %, about 20 wt % to about 55 wt %, about 20 wt % to about 54 wt %, about 20 wt % to about 53 wt %, about 20 wt % to about 52 wt %, about 20 wt % to about 51 wt %, about 20 wt % to about 50 wt %, about 20 wt % to about 49 wt %, about 20 wt % to about 48 wt %, about 20 wt % to about 47 wt %, about 20 wt % to about 46 wt %, about 20 wt % to about 45 wt %, about 20 wt % to about 44 wt %, about 20 wt % to about 43 wt %, about 20 wt % to about 42 wt %, about 20 wt % to about 41 wt %, about 20 wt % to about 40 wt %, about 20 wt % to about 39 wt %, about 20 wt % to about 38 wt %, about 20 wt % to about 37 wt %, about 20 wt % to about 36 wt %, about 20 wt % to about 35 wt %, about 20 wt % to about 34 wt %, about 20 wt % to about 33 wt %, about 20 wt % to about 32 wt %, about 20 wt % to about 31 wt %, about 20 wt % to about 30 wt %, about 20 wt % to about 29 wt %, about 20 wt % to about 28 wt %, about 20 wt % to about 27 wt %, about 20 wt % to about 26 wt %, about 20 wt % to about 25 wt %, about 20 wt % to about 24 wt %, about 20 wt % to about 23 wt %, about 20 wt % to about 22 wt %, about 20 wt % to about 21 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt %, about 71 wt %, about 72 wt %, about 73 wt %, about 74 wt %, about 75 wt % of total water, or any value or range therebetween, based on the total weight of hydrogel.

The hydrogel obtained by the method as disclosed herein may comprise about 15 wt % to about 65 wt % of free water and intermediate water, about 15 wt % to about 64 wt %, about 15 wt % to about 63 wt %, about 15 wt % to about 62 wt %, about 15 wt % to about 61 wt %, about 15 wt % to about 60 wt %, about 15 wt % to about 59 wt %, about 15 wt % to about 58 wt %, about 15 wt % to about 57 wt %, about 15 wt % to about 56 wt %, about 15 wt % to about 55 wt %, about 15 wt % to about 54 wt %, about 15 wt % to about 53 wt %, about 15 wt % to about 52 wt %, about 15 wt % to about 51 wt %, about 15 wt % to about 50 wt %, about 15 wt % to about 49 wt %, about 15 wt % to about 48 wt %, about 15 wt % to about 47 wt %, about 15 wt % to about 46 wt %, about 15 wt % to about 45 wt %, about 15 wt % to about 44 wt %, about 15 wt % to about 43 wt %, about 15 wt % to about 42 wt %, about 15 wt % to about 41 wt %, about 15 wt % to about 40 wt %, about 15 wt % to about 39 wt %, about 15 wt % to about 38 wt %, about 15 wt % to about 37 wt %, about 15 wt % to about 36 wt %, about 15 wt % to about 35 wt %, about 15 wt % to about 34 wt %, about 15 wt % to about 33 wt %, about 15 wt % to about 32 wt %, about 15 wt % to about 31 wt %, about 15 wt % to about 30 wt %, about 15 wt % to about 29 wt %, about 15 wt % to about 28 wt %, about 15 wt % to about 27 wt %, about 15 wt % to about 26 wt %, about 15 wt % to about 25 wt %, about 15 wt % to about 24 wt %, about 15 wt % to about 23 wt %, about 15 wt % to about 22 wt %, about 15 wt % to about 21 wt %, about 15 wt % to about 20 wt %, about 15 wt % to about 19 wt %, about 15 wt % to about 18 wt %, about 15 wt % to about 17 wt %, about 15 wt % to about 16 wt %, about 15 wt % to about 65 wt %, about 16 wt % to about 65 wt %, about 17 wt % to about 65 wt %, about 18 wt % to about 65 wt %, about 19 wt % to about 65 wt %, about 20 wt % to about 65 wt %, about 21 wt % to about 65 wt %, about 22 wt % to about 65 wt %, about 23 wt % to about 65 wt %, about 24 wt % to about 65 wt %, about 25 wt % to about 65 wt %, about 26 wt % to about 65 wt %, about 27 wt % to about 65 wt %, about 28 wt % to about 65 wt %, about 29 wt % to about 65 wt %, about 30 wt % to about 65 wt %, about 31 wt % to about 65 wt %, about 32 wt % to about 65 wt %, about 33 wt % to about 65 wt %, about 34 wt % to about 65 wt %, about 35 wt % to about 65 wt %, about 36 wt % to about 65 wt %, about 37 wt % to about 65 wt %, about 38 wt % to about 65 wt %, about 39 wt % to about 65 wt %, about 40 wt % to about 65 wt %, about 41 wt % to about 65 wt %, about 42 wt % to about 65 wt %, about 43 wt % to about 65 wt %, about 44 wt % to about 65 wt %, about 45 wt % to about 65 wt %, about 46 wt % to about 65 wt %, about 47 wt % to about 65 wt %, about 48 wt % to about 65 wt %, about 49 wt % to about 65 wt %, about 50 wt % to about 65 wt %, about 51 wt % to about 65 wt %, about 52 wt % to about 65 wt %, about 53 wt % to about 65 wt %, about 54 wt % to about 65 wt %, about 55 wt % to about 65 wt %, about 56 wt % to about 65 wt %, about 57 wt % to about 65 wt %, about 58 wt % to about 65 wt %, about 59 wt % to about 65 wt %, about 60 wt % to about 65 wt %, about 61 wt % to about 65 wt %, about 62 wt % to about 65 wt %, about 63 wt % to about 65 wt %, about 64 wt % to about 65 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt % of free water and intermediate water, or any value or range therebetween, based on the total weight of hydrogel.

### Fabric-Supported Hydrogel

The present invention also relates to a fabric-supported hydrogel comprising a fabric and a hydrogel as disclosed herein. In one embodiment, the present invention relates to a fabric-supported hydrogel having a framework comprising a fabric skeleton, crosslinked polymeric chains that form a polymeric matrix, radiation-reflecting inorganic particles homogenously distributed in the polymeric matrix, and hydrogen bonds between the radiation-reflecting inorganic particles, the polymeric matrix and the fabric skeleton. The term ‘fabric skeleton’ may refer to a supportive or protective structure of a fabric which functions as a structure frame (e.g. skeleton) of a fabric.

The hydrogel in accordance with the present invention and method of preparing the said hydrogel exhibits at least the following advantages and benefits discussed below.

The most important advantage is its cooling performance under the harsh tropical weather conditions. Other advantages include mechanical stability, cost-effectiveness, scalable manufacturing process. Also, combinational evaporative and radiative cooling may realize below air temperature under direct sunshine in tropic areas with high humidity and high solar irradiation (more than 1000 W/m²), which is impossible with existing passive cooling technologies. Combinational evaporative and radiative cooling may cooperatively achieve passive cooling under dynamic weather conditions. It is a simple, easy to use and apply coating that is applicable to various surfaces of buildings/constructions such as roof and sidewall, as well as other applications, e.g., refrigerated vehicles for cold chain, PV panel cooling, or other fields. Furthermore, high solar reflection is integrated within the hydrogel porous structure, realizing dynamic light scattering induced by the embedded particles and porous structure depending on water content. Influence from unfavoured factors such as high humidity, rain, sunlight, and high ambient temperature are alleviated or turned to positive impact through water evaporation within radiative cooler.

A rationally integration of various cooling mechanisms leads to adaptive passive cooling that automatically adjusts contributions of various passive cooling mechanisms (evaporative cooling, radiative cooling, high solar reflection, heat isolation etc.) to achieve a stable sub-ambient temperature regardless of the fluctuating ambient conditions, e.g., fluctuating solar irradiance.

### EXAMPLES

Non-limiting examples of the invention and a comparative example will be further described in greater detail by reference to specific Examples, which should not be construed as in any way limiting the scope of the invention.

### Chemicals And Materials

Chemicals used in this invention includes polyvinyl alcohol (PVA) with molecular weight (MW) of about 89000 to 99000, glutaraldehyde (50% aqueous solution), barium sulfate (BaSO₄) powder (of an average size of about 350 nm), and sulfuric acid (95%) were all purchased from Sigma-Aldrich. All chemicals were used without further purification. Silicone oil from KOYA® was applied as a mould-release agent to prevent mechanical deformation during gelation. The dyes used for coloured hydrogel fabrication was food dyes from Starbrand®.

The hydrolyzation rate and molecular weight of water-soluble polymer (or polymeric matrix) act importantly, usually a 99% hydrolyzation with high molecular weight (molecular weight of more than (>) 15 W) is favoured.

### Example 1: Preparation of Hydrogels

### Hydrogel Fabrication Procedure

PVA solution was prepared at 100° C. with stirring in a sealed beaker (to prevent water loss) until a total homogeneous solution appears. The prepared PVA solution was cooled down to room temperature for further use. PVA solution was mixed with sulfuric acid with stirring for 1 hour. Barium sulfate (BaSO₄) was added to the mixture. glutaraldehyde solution was slowly added and stirred for 30 seconds. During the entire process, stirring speed was controlled properly to avoid formation of bubbles. The sample (hydrogel precursor) was moved into a mould for 24-hour gelation.

The mould was put into a freezer for freezing or deep freezing at a temperature of between about −40° C. to about −20° C. for a duration from about six hours to twelve hours depending on the thickness of the hydrogel. Afterwards, a layer of normal temperature water was added into the mould for thawing. A water bath may also be used for thawing. The frozen mixture may be thawed at a temperature of about 20° C. to about 30° C. for a duration of about 0.5 hours to about 3.5 hours. The freezing and thawing process may be repeated multiple times. The freeze-thaw process produces physical crosslinks. The resulting product is a multi-crosslinked hydrogel containing both chemical and physical crosslinks. During the process of thawing the hydrogel in water or water bath, sulfuric acid is washed off and removed from the hydrogel.

To ensure exactly the same components were used, barium sulfate may be first dispersed in the H₂SO₄ solution before mixing with PVA solution.

Various types of moulds may be used, for example, plastic moulds, metal moulds, or polytetrafluoroethylene (PTFE) moulds. A release agent may be used in combination with the mould. For example, silicone oil may be used when using plastic.

The above method is compatible with continuous production, where skeleton materials (such as porous fabric or foam) can be composited with the hydrogel for further enhancement of mechanical modulus.

Through an integrated crosslinking process (to give physical and chemical cross linkings), a cost-effective, high-water content, mechanically stable and low swelling ratio hydrogel can be obtained. The method is highly distinct from traditional hydrogel fabrication where the main materials choice is strict due to integrated process.

### Pure-Gel Fabrication Procedure

A comparative sample (Pure-Gel) was also prepared. Pure-Gel sample was prepared by mixing PVA solution with sulfuric acid with stirring for 1 hour. glutaraldehyde solution was slowly added and stirred for 30 seconds. The prepared Pure-Gel sample was further moved into a silicone oil coated polytetrafluoroethylene (PTFE) mould for 24-hour gelation.

The mould was put into a freezer for freezing or deep freezing at a temperature of between about −40° C. to about −20° C. for a duration from about six hours to twelve hours depending on the thickness of the hydrogel. Afterwards, a layer of normal temperature water was added into the mould for thawing. A water bath may also be used for thawing. The frozen mixture may be thawed at a temperature of about 20° C. to about 30° C. for a duration of about 0.5 hours to about 3.5 hours. The freezing and thawing process may be repeated multiple times. The freeze-thaw process produces physical crosslinks. The resulting product is a multi-crosslinked hydrogel containing both chemical and physical crosslinks.

### Example 2: Hydrogels

Herein, the hydrogel is not a pure polymeric material since radiation-reflecting inorganic particles was added in the hydrogel to provide radiating-reflecting properties. The hydrogel samples were labelled a metagel, i.e., a metamaterial based on hydrogel. The names of the samples were labelled as “Metagel-x”, where x defines the critical parameters of the specific metagel sample. The hydrogel with pure polymeric components was named as “Pure-Gel”.

### Example 2a: Hydrogel Precursor

Hydrogel precursors (precursor of Metagel-0.1, precursor of Metagel-0.5, precursor of Metagel-1, precursor of Metagel-2, precursor of Metagel-4) were prepared using the method in Example 1. The weight percentage of the hydrogel precursor components in Metagel-0.1, Metagel-0.5, Metagel-1, Metagel-2, Metagel-4, based on the total weight of hydrogel, is tabulated in Table 1a.

Hydrogel precursors were named/labelled according to the ratio of each component, particularly the barium sulfate (BaSO₄) component. For example, precursor of Metagel-2 indicates 2 g of barium sulfate. Precursor of Metagel-4 indicates 4 g of barium sulfate. Hydrogels with different thicknesses were all prepared based on these component ratios.

TABLE 1a
Weight % of components in hydrogel precursors, based
on the total weight of hydrogel precursors.

| | | | | | Total | |
|---|---|---|---|---|---|---|
| Hydrogel | PVA | H₂SO₄ | Glutaraldehyde | BaSO₄ | Water | |
| Precursors | (wt %) | (wt %) | (wt %) | (wt %) | (wt %) | Total |
| Precursor of | ~26 | 1-2 | 0.2-0.4 | ~4.7 | ~68 | 100 wt % |
| Metagel-0.1 | (25.5-26.5) | | | (4.2-5.2) | (67.5-68.5) | |
| Precursor of | ~18 | 1-2 | 0.2-0.4 | ~20 | ~60 | 100 wt % |
| Metagel-0.5 | (17.5-18.5) | | | (19.5-20.5) | (59.5-60.5) | |
| Precursor of | ~20 | 0.5-1 | 0.1-0.2 | ~33 | ~47 | 100 wt % |
| Metagel-1 | (19.5-20.5) | | | (32.5-33.5) | (46.5-47.5) | |
| Precursor of | ~15 | 0.5-1 | 0.1-0.2 | ~50 | ~35 | 100 wt % |
| Metagel-2 | (14.5-15.5) | | | (49.5-50.5) | (34.5-35.5) | |
| Precursor of | ~10 | 0.5-1 | 0.1-0.2 | ~66 | ~23 | 100 wt % |
| Metagel-4 | (9.5-10.5) | | | (65.5-66.5) | (22.5-23.5) | |

### Example 2b: Hydrogel

Hydrogel (Metagel-0.1, Metagel-0.5, Metagel-1, Metagel-2, Metagel-4) were prepared using the method in Example 1 and the hydrogel precursors in Example 2a. Hydrogels were named/labelled according to the ratio of each component in the hydrogel precursor, particularly the barium sulfate (BaSO₄) component. For example, Metagel-2 indicates 2 g of barium sulfate in the precursor of Metagel-2. Metagel-4 indicates 4 g of barium sulfate in the precursor of Metagel-4.

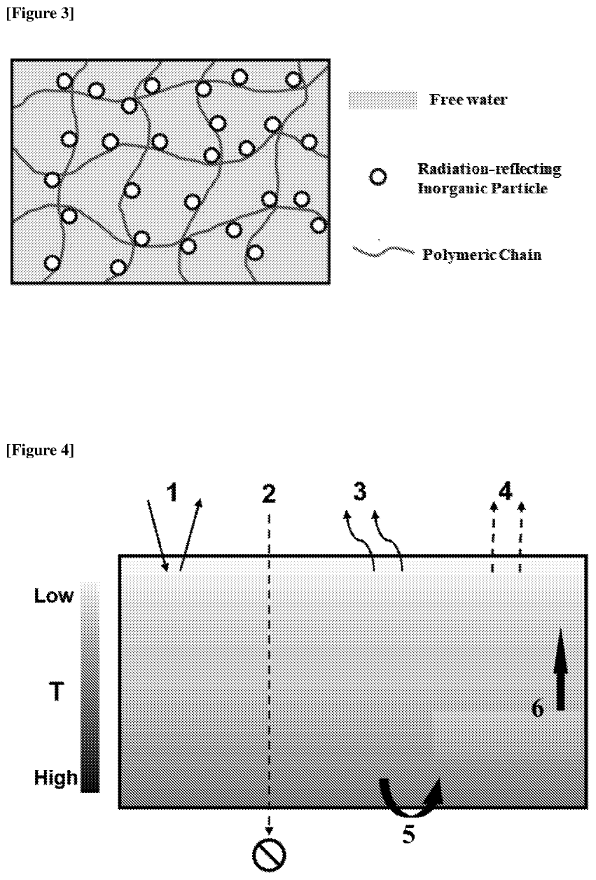

The structure and components of a hydrogel are illustrated in FIG. 3, where the grey section ( [symbol] ) represents free water, the circle (∘) represents a radiation-reflecting inorganic particle and the wavy lines ( [symbol] ) represents a polymeric chain of a water-soluble polymer.

### Example 3: Cooling Mechanisms

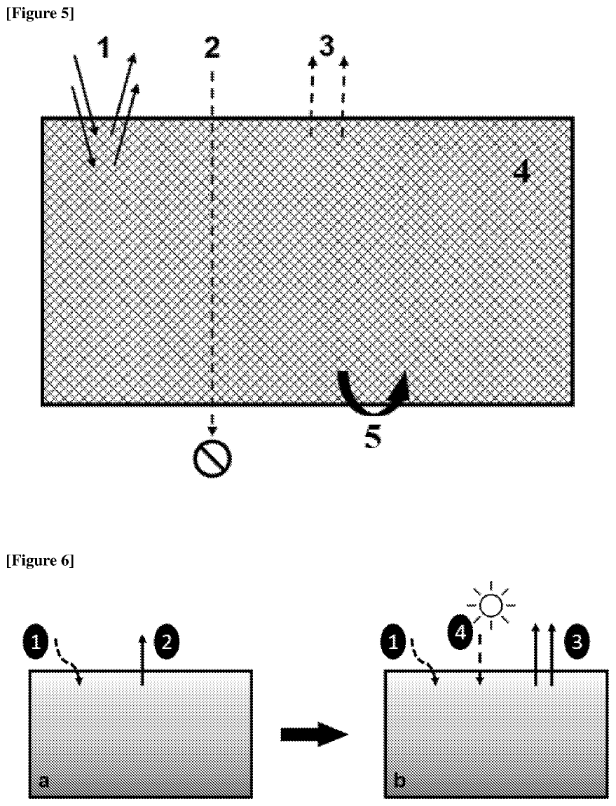

The hydrogel utilises both evaporative cooling and passive radiative cooling techniques for cooling. The hydrogel comprises an integrated structure which exhibits radiation-reflection (i.e. solar reflection), solar blocking, LWIR emission, and evaporation cooling functions (as shown in FIGS. 4 and 5).

The framework of the hydrogel is composed of crosslinked polymeric chains, with abundant porous structure. Embedded particles are homogeneously distributed in the polymeric matrix, stabilized by hydrogen bonds forming between particle surface and hydrated polymeric network. Free water occupies inner pore volume, acting as dynamic heat exchange medium through evaporation and transport behaviours. In the hydrogel, free water is stably confined by strong hydrogen bond interaction, leading to slow water loss. The uniform porous structure allows adequate water transport through capillary force, promising the continuous heat exchange with contacted surface (which may be a cooling target).

One such embodiment of a hydrogel is an integration of radiation-reflecting inorganic particles (i.e., solar reflector and LWIR radiator), water transport channel in a bulk hydrogel matrix. Two water dependent states, where the hydrogel may be under dry or moist states, determine different working mechanisms of hydrogel.

Water has negligible ultraviolet-visible-near infrared (UV-vis-NIR) light (of wavelength of about 300 nm to about 1300 nm) absorption, but significant short-wave infrared (IR) (of about 1300 nm to about 2500 nm) absorption in solar spectrum, which is beneficial for driving water evaporative cooling. Thus, the optical regulation in APC should allow partial backscattering rather than broad-band backscattering as in PRC. Besides, structural design should balance the water maintenance and light scattering, because the stored water leads to weakened light scattering due to reduced refractive index. To this end, the present embodiment which is a hydrogel consisting of a porous polymeric matrix that effectively regulates water evaporation through multi-state water bonding, is suitable for APC framework.

### Hydrogel—Under Moist State

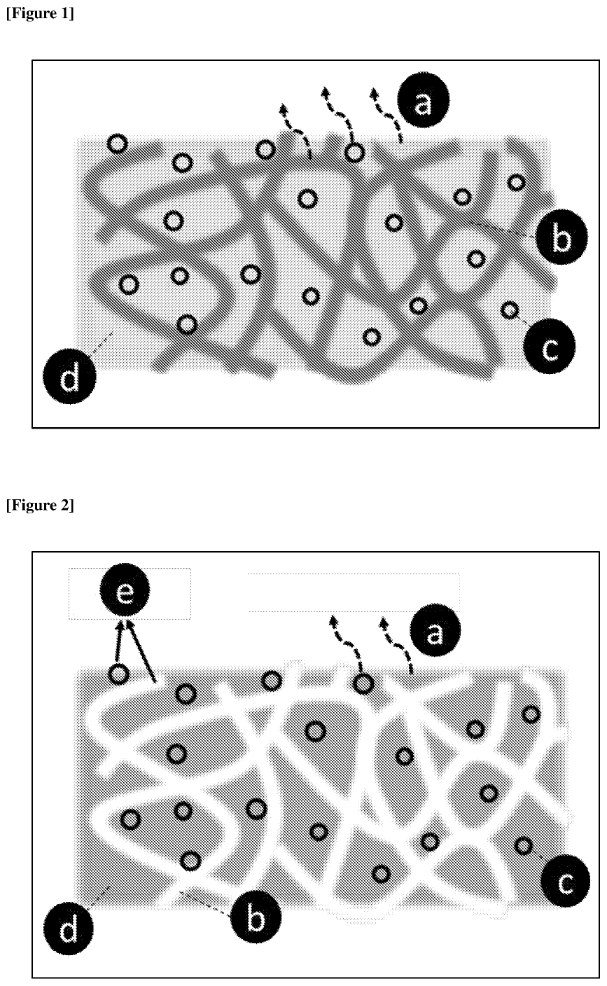

FIG. 1 illustrates the working principles of a moist state hydrogel of the present invention, where (a) represents LWIR emission, (b) represents water channel, (c) represents radiation-reflecting inorganic particles, and (d) represents polymer matrix.

Under moist state hydrogel, free water may be present in a water channel of the hydrogel of the present invention. A porous structure of a hydrogel serves as an inner water channel or transport channel to supply adequate evaporation water demand.

Under moist state hydrogel, an embedded radiation-reflecting inorganic particle with diameter ranging from 100 nm to 1 μm acts as main solar reflector to induce strong Mie scattering in solar wavelength (300 nm to 2500 nm). The radiation-reflecting inorganic particle may comprise BaSO₄, TiO₂, CaCO₃ etc., having hydrophilic surface to minimize the impedance of inner water transport as well as form hydrogen bond with polymeric chains.

Polymeric chain and water (e.g., free water) are both strong LWIR emitter within atmospheric window. As such, the radiation-reflecting inorganic particle (c) and the water channel (b) in the hydrogel may be able to emit LWIR as shown in FIG. 1 (a).

FIG. 4 shows the working principles of a hydrogel in moist state in accordance with the present invention, where (1) represents radiation reflection (e.g., solar reflection), (2) represents radiation blocking (e.g. solar blocking), (3) represents water evaporation, (4) represents LWIR emission, (5) represents heat exchange and (6) represents water transport.

### Hydrogel—Under Dry State

FIG. 2 illustrates the working principles of a dry state hydrogel of the present invention, where (a) represents LWIR emission, (b) represents pore-air interface, (c) represents radiation-reflecting inorganic particles, (d) represents polymer matrix, and (e) indicates the pore-air interface and radiation-reflecting inorganic particles are able to reflect radiation (e.g. radiation-reflecting).

A hydrogel under dry state has reduced free water content in the hydrogel.

Under dry state, both embedded radiation-reflecting inorganic particle (c) and porous structure provide strong Mie scattering to sunlight. Reduced free water leads to increased refractive index difference at a pore-air interface (b), which contributes the scattering of sunlight (e). Overall, solar reflectance obviously rises along the evaporation of water because of dynamic scattering mechanism.

In a dry state hydrogel, once free water content becomes negligible within the hydrogel, polymeric chain and embedded radiation-reflecting inorganic particles dominate LWIR radiation (a) through atmospheric window.

FIG. 5 shows the working principles of a hydrogel in dry state in accordance with the present invention, where (1) represents radiation reflection (e.g. solar reflection), (2) represents radiation blocking (e.g. solar blocking), (3) represents LWIR emission, (4) represents porous structure of the hydrogel coating, and (5) represents heat exchange.

Differences between Moist and Dry States of Hydrogel

Referring to FIGS. 1-2 and 4-6, the differences between the moist and dry states of hydrogel of the present invention may be:
Under moist state, the hydrogel may be undergoing evaporative cooling (as shown in FIG. 6); While under dry state, the hydrogel may not undergo evaporative cooling.
Under dry state, the hydrogel may have higher radiation reflection compared to the wet state hydrogel, as the dry state hydrogel gives rise to reduced free water, and increased refractive index at a pore-air interface, which eventually contributes to increased radiation reflection or scattering.

As shown in FIG. 6, solar energy (i.e., sunlight) as cooling enhancement may be utilized in moist hydrogel, where (a) shows the hydrogel without solar energy input with parasitic heat transfer (1) and water evaporation (2); and (b) shows the hydrogel with solar energy input (4) with parasitic heat transfer (1) and enhanced water evaporation (3).

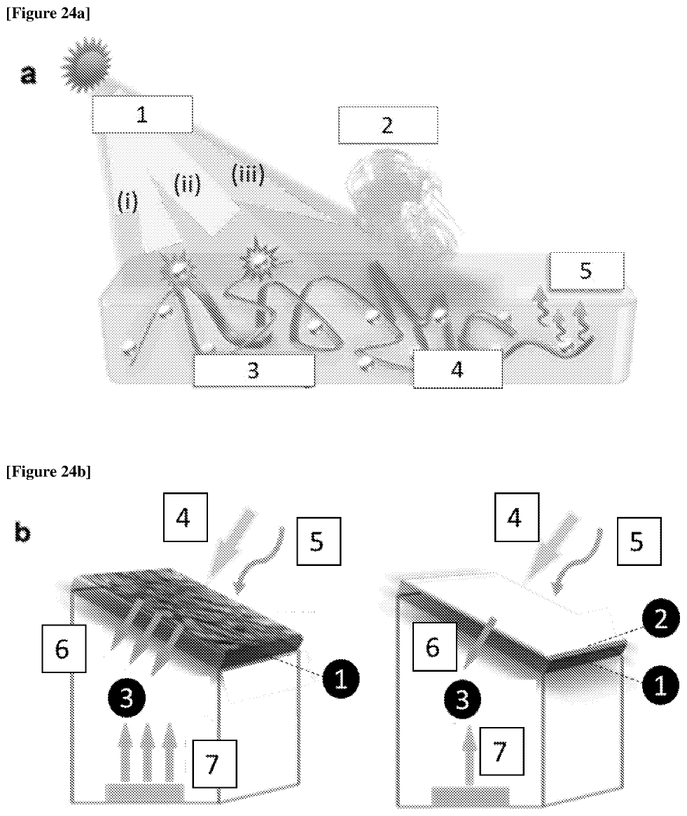

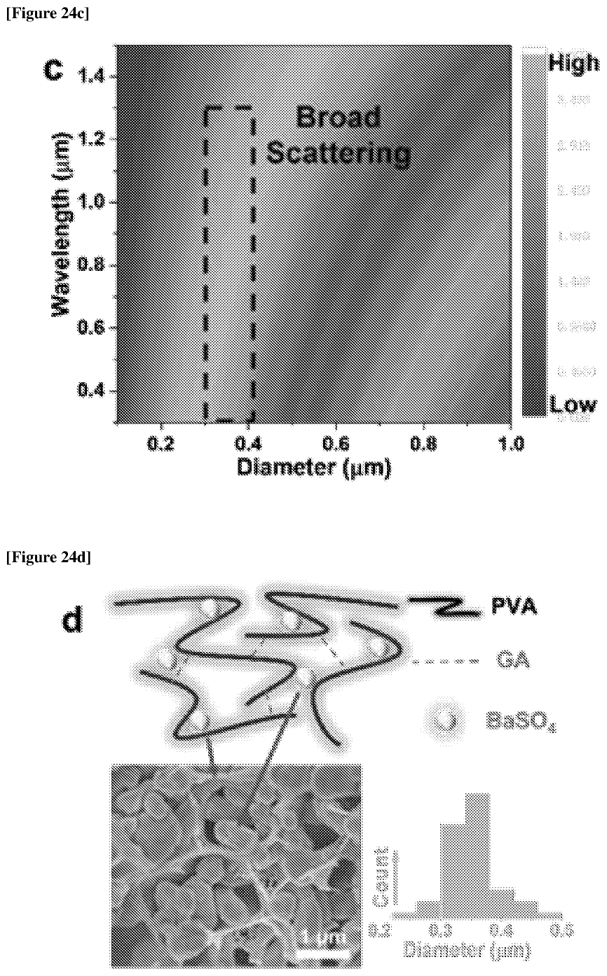

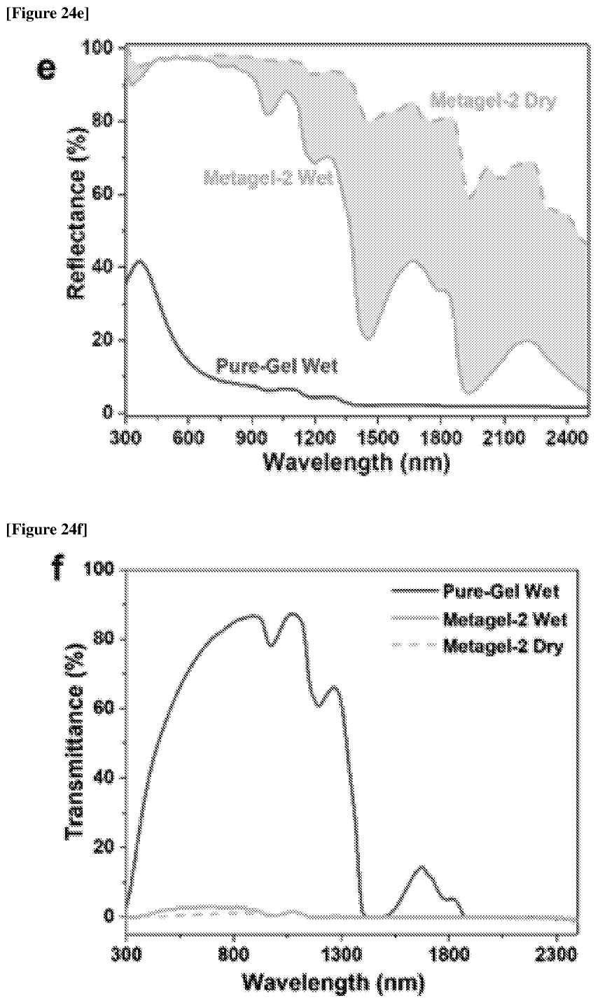

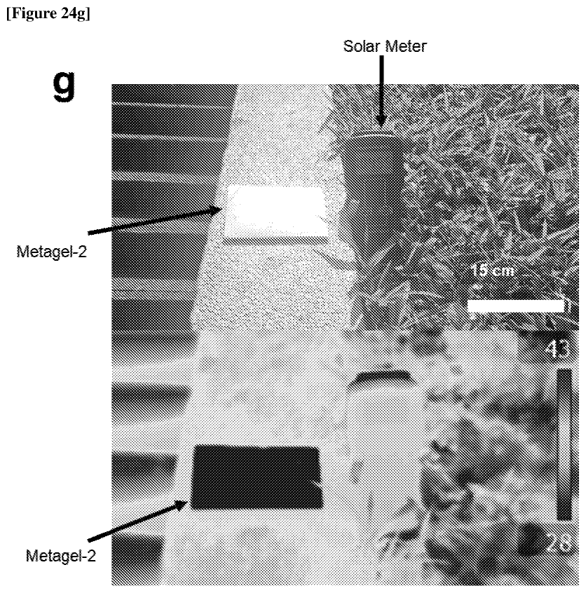

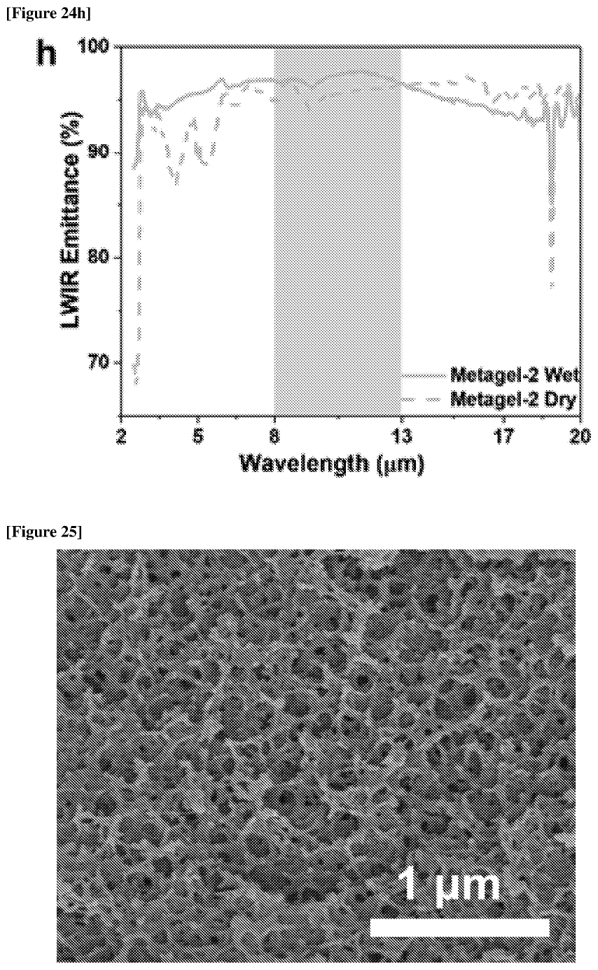

FIG. 24a illustrates the working principles of hydrogel in evaporative cooling and radiative cooling. As shown in FIG. 24a, the sun (1) emits ultraviolet radiation (i), visible light (ii), and near infrared radiation (iii). Further, processes such as water evaporation (2), ultraviolet visible light (UV-Vis) back scattering (3), near-infrared (NIR) scattering (4) and long-wave infrared (LWIR) emission (5) illustrates the mechanisms of cooling of an adaptive passive cooler (APC). PVA polymeric chains (grey) tightly stabilize water (light blue) through hydrogen bonding, where BSPs (white) within polymeric network backscatter UV-vis-NIR light (300-1300 nm, 87.5% of solar energy) selectively, leaving partial of remaining NIR light (1300-2500 nm) to be absorbed through hydrogen-bond stretching to drive water evaporation. Simultaneously, OH bending (water and PVA) and SO₄ vibration endow hydrogel high IR emissivity to facilitate radiative cooling.

### Example 4: Characterization of Hydrogels

### Instruments And Analytical Techniques for Hydrogel Characterizations

Scanning electron microscopic (SEM) images were obtained by a field-emission scanning electron microscopy (JEOL 7600). Infrared (IR) images were taken by a portable IR camera (FLIR E60). Solar range optical properties were characterized by a UV-vis-NIR spectrometer (PerkinElmer Lambda 950) coupled with an internal integrating sphere (150 mm InGaAs). Differential scanning calorimetry (DSC) test was conducted with two modes: water evaporation enthalpy test was conducted with DSC Q200 (TA Instrument), and water melting behaviour test was conducted with DSC Q10 (TA Instrument). Raman signal was collected by a Raman spectrometer (WITEC alpha 300 R confocal Raman system) with a customized sample stage. Before testing, the system was calibrated with Si peak at 520 cm⁻¹ to keep the measurement consistent. IR emittance spectrum and attenuated total reflectance (ATR) test was obtained through recording IR reflectance spectrum by a Fourier transform infrared spectroscopy (FTIR, PerkinElmer Spectrum Frontiers) equipped with a gold integrating sphere (PerkinElmer Mid-IR Integrating Sphere, with 8-degree incident angle). The thermal conductivity was measured by a Hot Disk 2500S based on bulk type mode. Rheological properties were evaluated through a dynamic mechanical analysis system (DMA Q800, TA Instrument). The solar simulator for indoor illumination test was a Newport LCS-100 setup.

### Sample Preparation for Hydrogel Characterizations

Dried hydrogels were used for optical measurement and characterization, where the hydrogel was treated with freeze drying method under −40° C. for two days, in which the porous structure was kept maintained for light scattering characterizations.

Dried hydrogels for thermal conductivity measurement were treated under high temperature (60° C.) in an oven for 2 days to collapse the pores. By doing so, this minimizes the influence of air within pores on the measured thermal conductivity.

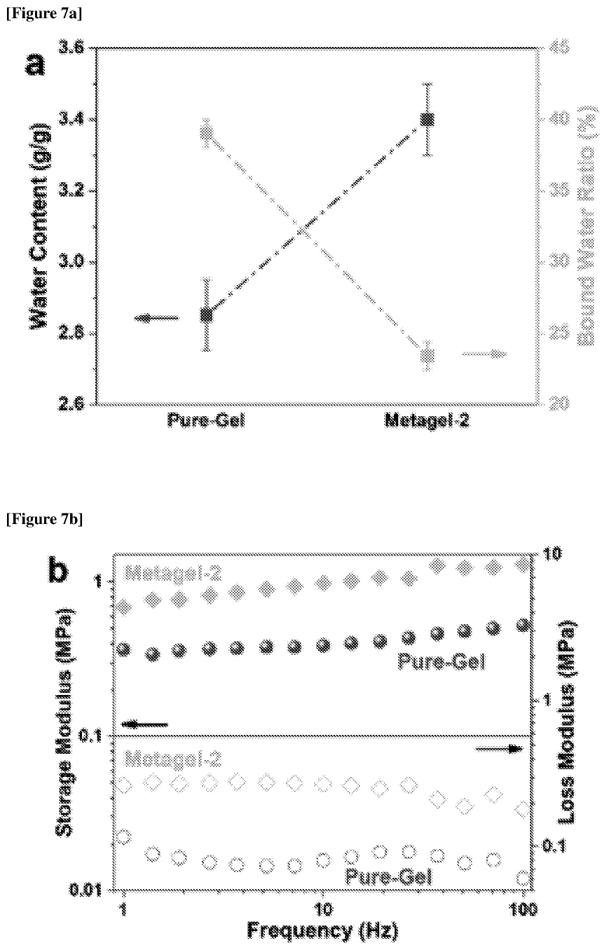

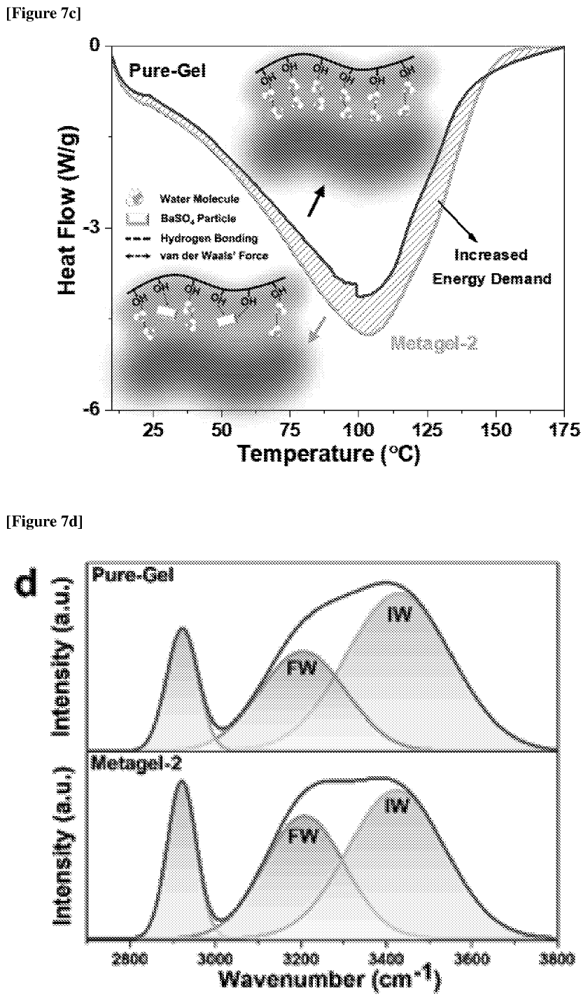

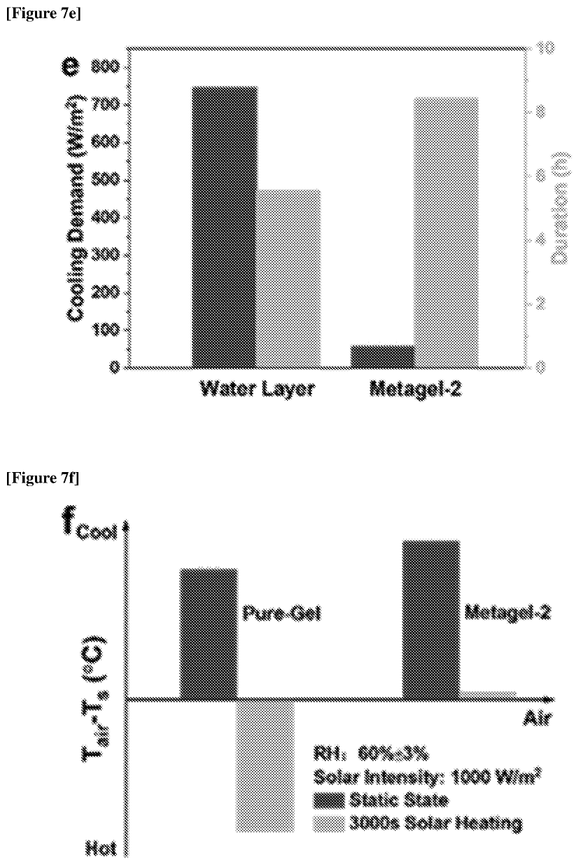

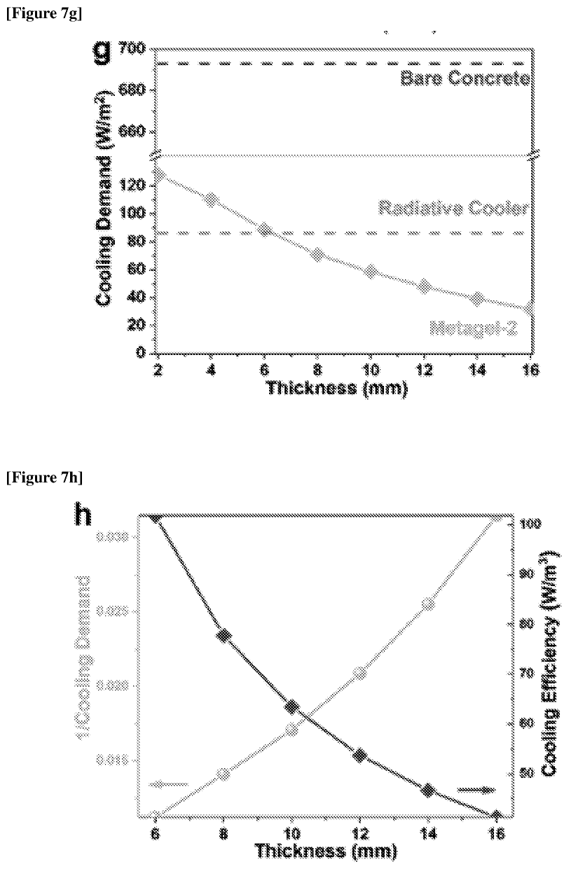

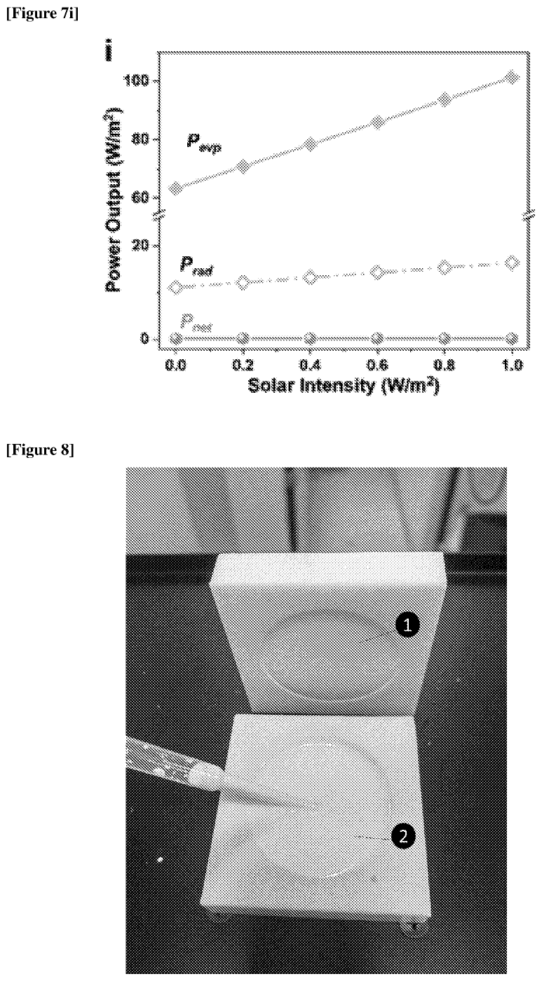

Sections below and FIG. 7a to FIG. 7i shows the results for hydrogel characterization.

### Electrostatic Interaction Between Barium Sulfate Particles and Polymer Chain

As a radiation-reflecting inorganic particle or a radiation scattering agent, barium sulfate BaSO₄ nanoparticles should be stabilized in the porous polymer framework for long-term usage. ATR-FTIR test was conducted to reveal the interaction between BaSO₄ nanoparticles and polymer framework within dried hydrogel samples.

FIG. 12 is a graph showing an ATR-FTIR spectrum of Pure-Gel and water-free Metagel-2, where left panel represents OH stretching mode and right panel represents OH bending mode.

According to FIG. 12, it is observed that the electrostatic interaction between BaSO₄ and polymer chain restrains the vibration of hydroxyl group, leading to a red shift in stretching mode (left panel), and suggesting a stronger intermolecular interaction of hydrogen bonding. Meanwhile, the blue shift of bending mode of hydroxyl group reveals a restrained intramolecular vibration, indicating the presence of external electrostatic force. It is shown that introducing intermolecular interaction by addition of radiation-reflecting inorganic particle within polymeric structure leads to stronger mechanical property, which further proves the strong interaction between a radiation-reflecting inorganic particle (BaSO₄ nanoparticle) and polymer chain of the framework. Hence, the addition of radiation-reflecting inorganic particle in the hydrogel leads to stronger mechanical property of the hydrogel.

### Bound Water Content

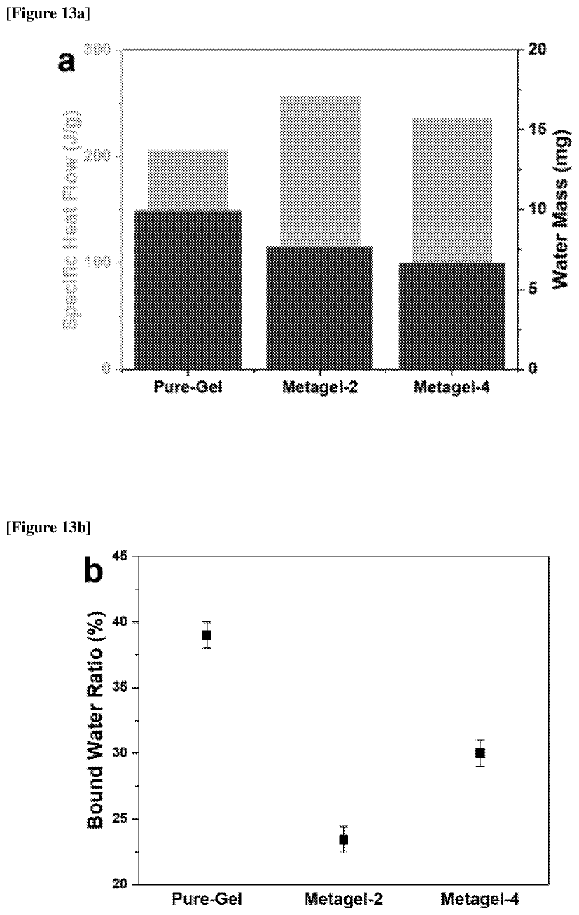

Bound water, which is strongly bonded onto polymeric chains, is the final water layer that may not be evaporated out. Evaporable water may refer to free water and intermediate water. For evaporative cooling application, lower content of bound water is favourable for a longer cyclic cooling duration (with similar total water content). Bound water content in hydrogel can be evaluated through characterizing melting behaviour by DSC due to its non-freezable characteristics (FIG. 13a). FIG. 13a is a bar chart showing the specific heat flow from a low temperature of −30° C. to 30° C. (left y-axis) and water mass (right y-axis) of different hydrogels from the measurements of Differential Scanning Calorimetry (DSC).

Bound water content (Q_{B}) can be calculated through equation:

$${Q}_{B} = ( W - \frac{Δ {Q}_{I - F}}{Δ H ( T )} ) / {W}_{d}$$

where ΔQ_{I-F} is the absorbed heat calculated from DSC measurement attributing to the melting behaviour of ice. The melting enthalpy of supercooled water (ΔH(T)) is taken as a classic value of 334 J/g. W and W_{d} are the weight of water in the hydrogels and the weight of fully-dried hydrogels, respectively. The specific heat flow from a low temperature of −30° C. to 30° C. and water mass of different gels from the measurements of Differential Scanning Calorimetry (DSC) as shown in FIG. 13a is tabulated in Table 2.

TABLE 2
Tabulation of the specific heat flow from a low temperature of
−30° C. to 30° C. and water mass of different hydrogels
from the measurements of Differential Scanning Calorimetry (DSC).

| Type of Hydrated | | |
|---|---|---|
| Hydrogels | Specific Heat Flow (J/g) | Water Mass (mg) |
| Pure-Gel | 205 | 9.9 |
| Metagel-2 | 256 | 7.7 |
| Metagel-4 | 235 | 6.7 |

DSC results (FIG. 13b) show that Metagel-2 possesses the lowest bound water content attribute to the following factors. Compared to Pure-Gel, addition of BaSO₄ nanoparticles occupies bonding sites on polymeric chains, leading to a reduction of bound water (FIG. 7a). However, overloaded BaSO₄ nanoparticle (as shown in Metagel-4) occupies a large pore volume and further decreases water stabilizing ability (less IW and FW), leading to a relative increase of bound water ratio.

### Water State In Hydrogel Revealed By Raman Spectroscopy

Water state (i.e. dry or moist state) in a hydrogel partially determines the evaporative cooling performance. In hydrated/moist polymer, water is usually stabilized in three states within porous structure, i.e., bound water, intermediate water (IW), and free water (FW). Bound water, which is non-freezable and hard to evaporate under normal temperature, affects the utilizable water content when hydrogel is used for cooling under normal temperature condition. Thus, the behaviours of IW and FW are crucial for evaporation controlling. It is well regarded that molecule vibrations of water are Raman active, where the stretching mode is the most sensitive and representable one.

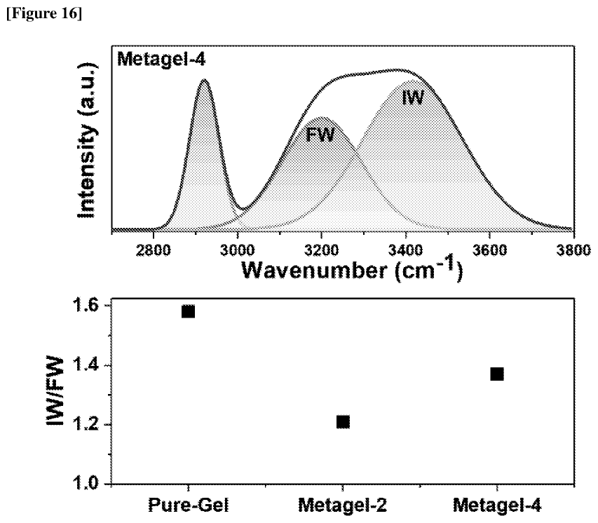

FIG. 7d and FIG. 16 clearly show obvious changes of vibration modes upon addition of radiation-reflecting inorganic particles, BaSO₄ particles. The broad peak was deconvoluted into two sub-peaks (details as shown in Table 3) according to classic Gaussian method, which represent IW (higher wavenumber) and FW (lower wavenumber), respectively. A significant red shift occurs on IW peak as the amount of BaSO₄ particle increases, indicating the formation of stronger hydrogen bonding network with the introduced electrostatic interaction. Notably, Metagel-2 possesses lower intensity ratio of IW to FW peak than that of Pure-Gel, indicating higher overall evaporation enthalpy. These observations agree well with the DSC results (FIG. 7c), which shows that evaporation is hindered by addition of BaSO₄, leading to higher evaporation enthalpy. However, bound water and IW/FW are both higher within Metagel-4 due to too much spatial occupation of pore volume by BaSO₄ particles, leading to less evaporable water and thus less sustainable cooling.

TABLE 3
Raman signal fitting parameters.

| | | Position | FWHM | Intensity | Intensity |
|---|---|---|---|---|---|
| | | (cm⁻¹) | (cm⁻¹) | (a.u.) | IW/FW |
| Pure-Gel | FW | 3203.288 | 237.29249 | 396.8561 | 1.58 |
| | IW | 3428.244 | 290.19604 | 626.98774 | |
| Metagel-2 | FW | 3207.982 | 221.75005 | 77.73929 | 1.21 |
| | IW | 3423.770 | 267.8878 | 94.18662 | |
| Metagel-4 | FW | 3199.800 | 222.63587 | 222.63587 | 1.32 |
| | IW | 3416.190 | 280.77164 | 280.77164 | |

### Dynamic Mechanical Analysis (DMA)

Through dynamic mechanical analysis, hydrogel rheological property can be characterized for evaluating compositional effect. Energy storage and dissipation features are expected for such viscoelastic material, which are mainly characterized by storage modulus and loss modulus, respectively. The storage modulus of hydrogel is larger than its loss modulus ascribing to the porous structure (FIG. 7b). Upon the addition of BaSO₄ particles, these two moduli are greatly enhanced due to the strong electrostatic interaction enhancing the mechanical properties. Moreover, steric hinderance effect (SHE) is further verified by the increased loss modulus.

### Thermal Conductivity

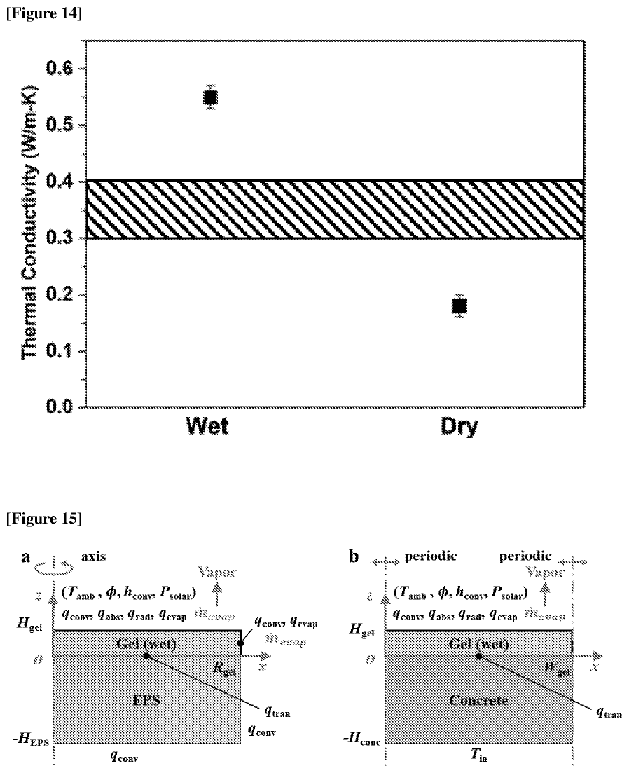

As depicted in FIG. 14, the thermal conductivity of Metagel-2 decreases in dry state. Poor thermal conductivity is favoured for external cooling application due to excellent heat isolation that effectively prevent incoming atmospheric thermal energy.

Compared to the saturated pure PVA hydrogel (Pure-Gel), saturated Metagel-2 exhibits lower thermal conductivity, which is even slightly lower than pure water, indicating excellent heat isolation. Besides, both saturated and dried Metagel-2 exhibit lower thermal conductivity than those of pure PVA hydrogel (Pure-Gel). Intermolecular interactions by hydrogen bonding (bound water molecules on polymer chain) are proven to enhance the thermal conductivity of hydrated polymer. Interpenetrated BaSO₄ particles spatially (steric hindrance effect) minimizes the formation of hydrogen bonding interactions between separate polymer chains, further lowering the thermal conductivity.

### Example 5: Radiation-Reflecting Inorganic Particles in Hydrogel

### Example 5a: Scattering Efficiency of Radiation-Reflecting Inorganic Particles

Scattering effect on BaSO₄ nanoparticle boundary was evaluated by Finite-Difference Time-Domin (FDTD) simulations. Typical refractive index of air and BaSO₄ (1 and 1.63, respectively) were used in the analysis. Scattering cross section of a single nanoparticle was calculated and considered to be the scattering efficiency after division of cross-section length with total-field scattered-field (TFSF) and perfect matching layer (PML) boundary conditions. Sweeping analysis (FIG. 7c) was conducted for comprehensive evaluation of UV-vis-NIR range scattering upon various particle sizes (from 0.1 to 1.0 μm).

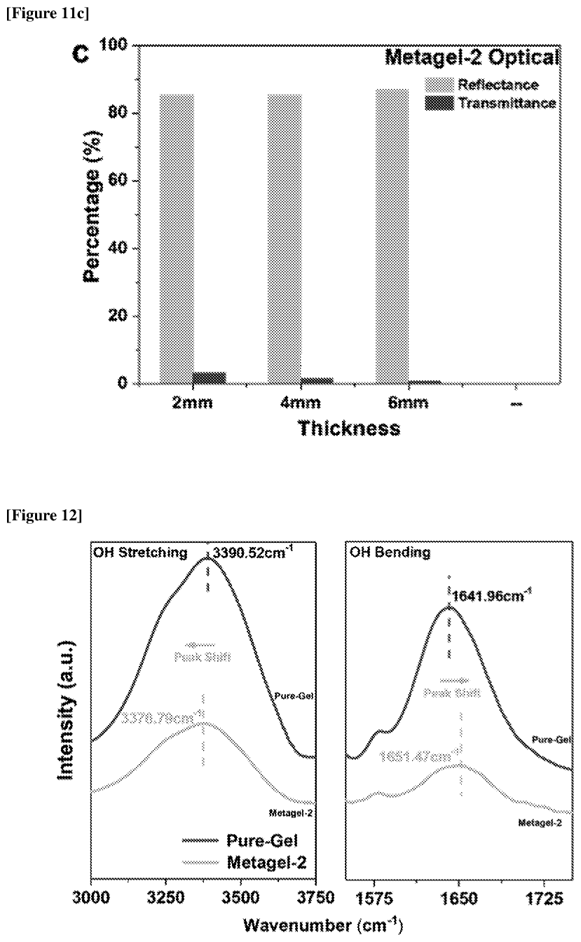

Calculated result indicates that particles with diameters from 200 to 400 nm broadly scatter UV-vis-NIR light, which mainly comes from the comparable size with wavelength, also known as Mie scattering. Correspondingly, particles with average size of 350 nm were applied as light scatter agents in hydrogel (as shown FIG. 7d), where the UV-vis reflection outcome upon particle addition was proved to be efficient (FIG. 11a to FIG. 11c). FIG. 11a to FIG. 11c show an optical performance of Metagel-2. Also shown in FIG. 11c, the results of the comparison of solar reflectance and transmittance of Metagel-2 with different thicknesses is shown in Table 4.

TABLE 4
Comparison of solar reflectance and transmittance
of Metagel-2 with different thicknesses.

| Thickness of Metagel-2/mm | Reflectance (%) | Transmittance (%) |
|---|---|---|
| 2 | 85.3 | 3.2 |
| 4 | 85.5 | 1.64 |
| 6 | 86.8 | 0.7 |

### Example 5b: Cost-Efficiency of Hydrogels

The cost of the hydrogel precursor components was estimated and compared in this section. According to the cost estimation as shown in Table 5 below, radiation-reflecting particle BaSO₄ nanoparticles account for a large portion of the total cost, indicating that Metagel-2 has the most cost-effective BaSO₄ content to achieve desired optical performance.

Moreover, Raman signal (in Table 3, FIG. 7d and FIG. 16) reveals that Metagel-2 exhibits the lowest IW/FW ratio of 1.21 and DSC test proves the lowest bound water content in Metagel-2, both being favourable for evaporative cooling. Thus, it is determined that Metagel-2 has the optimized BaSO₄ content for integrated passive cooling. The following theoretical model and field tests are all based on this ratio, unless otherwise specified.

TABLE 5
Cost estimation of hydrogel precursor components.

| | Price | | | |
|---|---|---|---|---|
| | Average | Unit Price of | Specific | |
| | Content | Product | Expense | Total Expense |
| Components | (g/cm³) | (SGD/kg) | (SGD/cm³) | (SGD/m²*mm) |
| PVA-1799 | ~0.117 | ~1.44 | 1.684 × 10⁻⁴ | Metagel-1: ~ 0.465 |
| BaSO₄ | Metagel-1: ~0.196 | ~0.814 | Metagel-1: ~1.591 × 10⁻⁴ | Metagel-2: ~ 0.624 |
| (Superfine) | Metagel-2:~0.391 | | Metagel-2: ~3.182 × 10⁻⁴ | Metagel-4: ~ 0.942 |
| | Metagel-4: ~0.782 | | Metagel-4: ~6.364 × 10⁻⁴ | |
| 50% | ~0.037 | ~3.2 | ~1.184*10⁻⁴ | |
| Glutaraldehyde | | | | |
| Solution | | | | |
| Sulfuric Acid | ~0.107 | ~0.18 | ~0.192*10⁻⁴ | |

### Example 6: Biocompatibility Test of Hydrogels

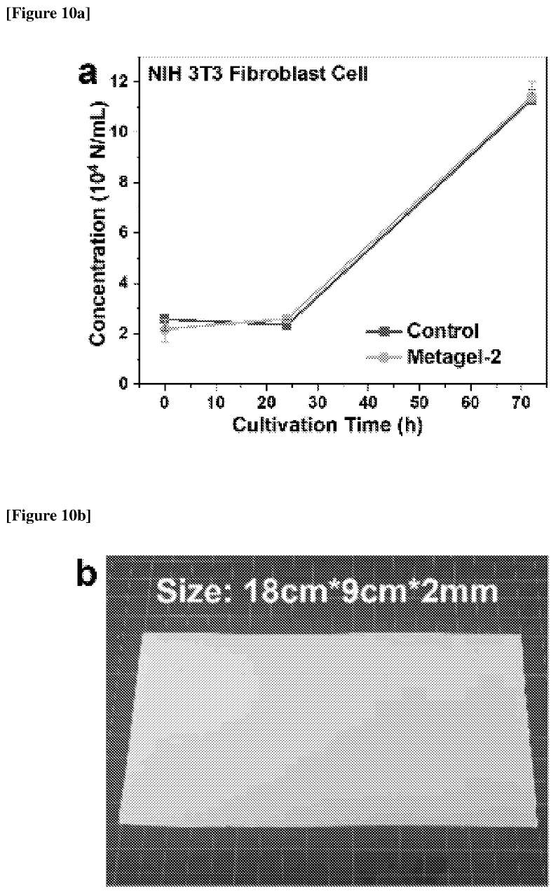

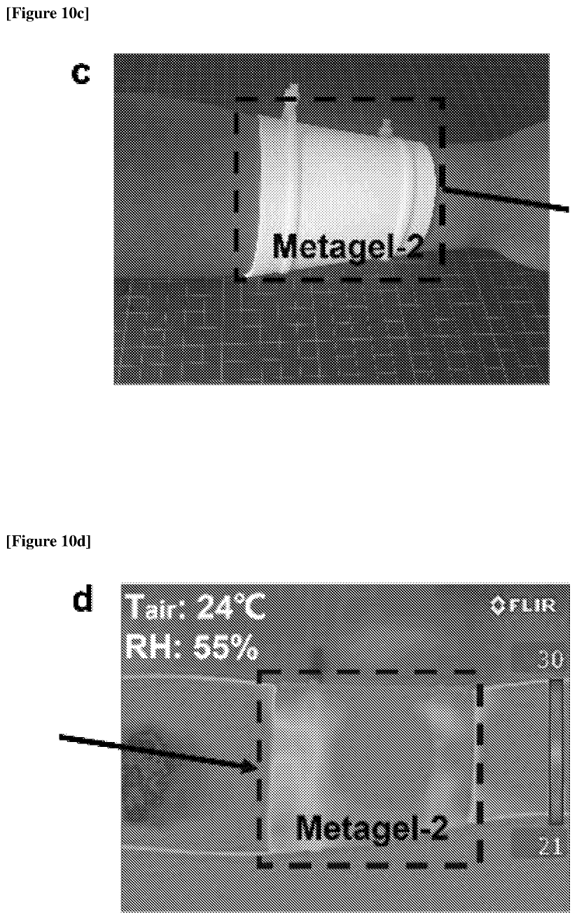

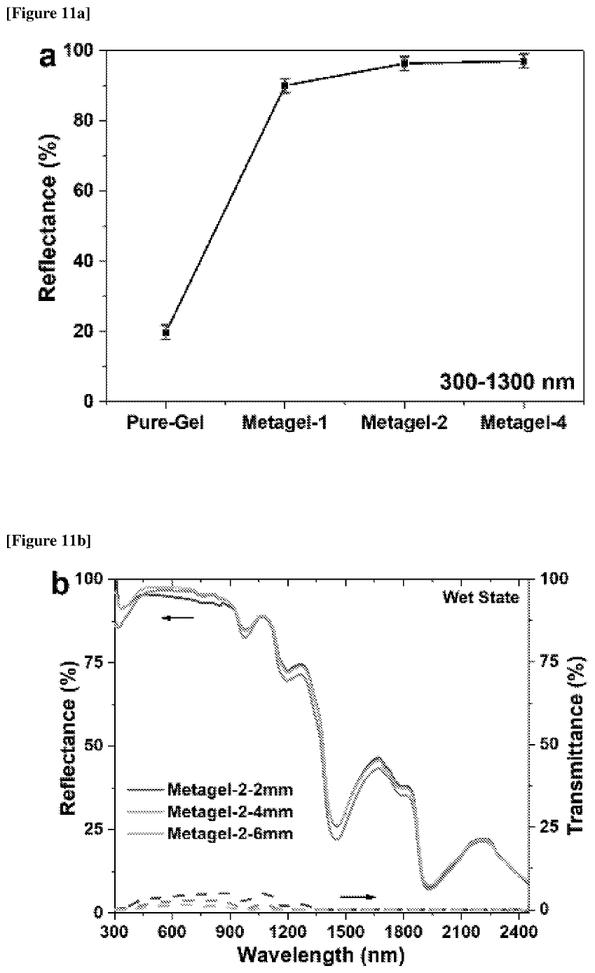

Biocompatibility test is conducted to determine the toxicity, and biocompatibility of the hydrogels. This biocompatibility test is important to assess and determine whether the hydrogels are suitable for safe use and applications. FIG. 10a to FIG. 10d show the biocompatibility and use of skin cooling using Metagel-2.

For bio-compatibility test (FIG. 10a), the Metagel-2 was immersed in the standard culture medium overnight in the 60×15 mm Petri dishes (Sigma-Aldrich). Fibroblast (NIH/3T3, ATCC-CRL-1658) cells were seeded and cultured on the surface of Metagel-2. The cells were trypsinized in time steps of 0, 24, and 72-hour to check viability with trypan blue (CAT:15250061, Thermo Fisher Scientific) in the cell counter (Countess, Thermo Fisher Scientific).

FIG. 10a shows that the concentration of NIH-3T3 fibroblast cell of Metagel-2 is similar to the control and that the cells concentration increases over time. This indicates that the Metagel-2 is a non-hazardous, biocompatible and non-toxic material for skin.

### Example 7: Thermal Analysis of Hydrogels

To rationalize the inventors' experimental observations, a 2D axisymmetric model is firstly adopted based on the experimental set-up, as shown in FIG. 15 (a). The rectangular domain has a radius of R_{gel} and a height of H_{gel}+H_{EPS}, where EPS represents expanded polystyrene. The volume fraction of each phase is 0 and they fulfill the following constraint, i.e.,

$${θ}_{S} + {θ}_{L} + {θ}_{G} = 1 \qquad ( 1 )$$

where the index S, L, and G are used for the solid, liquid, and gaseous phases, i.e., the Metagel-2 containing particles, water, and air in this model, respectively.

### Water Transport

Since the liquid water flows very slowly inside the porous Metagel-2 during evaporation, its transport process under capillary force is simplified as mass diffusion, and thus the time-dependent evolution of water volume fraction in the Metagel-2 can be written as

$$\frac{\partial {θ}_{L}}{\partial t} = ∇ \cdot ( {D}_{L} ∇ {θ}_{L} ) \qquad ( 2 )$$

in which the diffusion coefficient D_{L} is defined as

$${D}_{L} = \{ \begin{matrix}{10}^{- 8} exp ( - 2.8 + \frac{2 {ρ}_{L} {θ}_{L}}{{ρ}_{S} {θ}_{S}} ) & , {θ}_{L} \geq {θ}_{L}^{*} \\ 0 & , {θ}_{L} < {θ}_{L}^{*}\end{matrix} \qquad ( 3 )$$

where ρ_{L} and ρ_{S} are the water and Metagel-2 densities, and θ_{L}* is the residual saturation.

### Heat Transfer

The equation for heat transfer in Metagel-2 and EPS is written as a function of temperature (T), i.e.,

$${ρ}_{eff} {c}_{p , eff} \frac{\partial T}{\partial t} = ∇ \cdot ( {k}_{eff} ∇ T ) + {q}_{tran} {\vert}_{z = 0} \qquad ( 4 )$$

where ρ_{eff}, c_{p, eff}, and k_{eff} are the effective density, heat capacity, and thermal conductivity, respectively.

In Metagel-2, they are calculated by

$${ρ}_{eff} = {ρ}_{dry} + ( {ρ}_{wet} - {ρ}_{dry} ) / {θ}_{L , 0} \qquad ( 5 )$$

$${c}_{p , eff} = {c}_{p , dry} + ( {c}_{p , wet} - {c}_{p , dry} ) / {θ}_{L , 0} \qquad ( 6 )$$

$${k}_{eff} = {k}_{dry} + ( {k}_{wet} - {k}_{dry} ) / {θ}_{L , 0} \qquad ( 7 )$$

Here, ρ_{dry}, cₚ, dry, and k_{dry} are the density, heat capacity, and thermal conductivity, respectively, experimentally measured using dry Metagel-2, and ρ_{wet}, cₚ, wet, and k_{wet} are the corresponding values of wet Metagel-2. BL, θ_{L, 0} is the initial water volume fraction or the porosity of the Metagel-2. In Eq. (4), qₜᵣₐₙ|x=0 is the heat source in the Metagel-2/EPS interface (z=0) induced by the transmitted solar energy and thus obtained by

$${q}_{tran} = {φ}_{tran} {P}_{solar} \qquad ( 8 )$$

in which φₜᵣₐₙ is the transmissivity of Metagel-2 and Pₛₒₗₐᵣ is the solar power density.

### Boundary Conditions

In the experiments, water mainly evaporates on the top and side surfaces of the Metagel-2. Thus, for the Metagel-2 domain, the water transport equation [Eq. (1)] satisfies the following boundaries, i.e.,

$$- {D}_{L} \frac{\partial {θ}_{L}}{\partial z} {\vert}_{z = {H}_{gel}} = \frac{{\dot{m}}_{evp}}{{ρ}_{L}} \qquad ( 9 )$$

$$- {D}_{L} \frac{\partial {θ}_{L}}{\partial x} {\vert}_{x = {R}_{gel}} = \frac{{\dot{m}}_{evp}}{{ρ}_{L}} \qquad ( 10 )$$

and the bottom surface of Metagel-2 is prescribed no flux condition, that is

$$- {D}_{L} \frac{\partial {θ}_{L}}{\partial z} {\vert}_{z = 0} = 0 \qquad ( 11 )$$

Here, \dot{m}ₑᵥₚ is the evaporation rate, obtained from

$${\dot{m}}_{evp} = {h}_{m} ( {X}_{sat} - {X}_{amb} ) \qquad ( 12 )$$

where hₘ is the mass transfer coefficient and associated with the heat transfer coefficient (h_{conv}=8.3+2.5V where V is the air velocity), expressed as

$${h}_{m} = \frac{{h}_{conv}}{{c}_{p , G} {Le}^{2 / 3}} \qquad ( 13 )$$

in which Le is the Lewis number about 0.85 for temperatures of 0-40° C. Xₛₐₜ and X_{amb} are the saturated moisture content near the surface [pₛₐₜ(T_{S})] and that at the ambient vapor pressure [pᵥₐₚ(T_{amb})], written as

$${X}_{sat} = \frac{0.622 {p}_{sat} ( {T}_{S} )}{{p}_{0} - {p}_{sat} ( {T}_{S} )} , {X}_{amb} = \frac{0.622 {p}_{vap} ( {T}_{amb} )}{{p}_{0} - {p}_{vap} ( {T}_{amb} )} = \frac{0.622 ϕ {p}_{sat} ( {T}_{amb} )}{{p}_{0} - ϕ {p}_{sat} ( {T}_{amb} )} \qquad ( 14 )$$

Here, p₀ and ϕ are the ambient pressure and relative humidity. pₛₐₜ(T_{S}) and pₛₐₜ(T_{amb}) are the saturated vapor pressures at the surface (T_{S}) and ambient (T_{amb}) temperatures, respectively, which can be calculated using Antoine's equation, i.e.,

$${p}_{sat} ( {T}_{S} ) = {10}^{A - B / ( C + {T}_{S} )} , {p}_{sat} ( {T}_{amb} ) = {10}^{A - B / ( C + {T}_{amb} )} \qquad ( 15 )$$

in which A=10.196, B=1730.63, and C=−39.724 are all constants.

The boundary conditions for the heat transfer equation [Eq. (4)] are

$$- {k}_{eff} \frac{\partial T}{\partial z} {\vert}_{z = {H}_{gel}} = {q}_{conv} - {q}_{abs} + {q}_{rad} + {q}_{evp} \qquad ( 16 )$$

$$- {k}_{eff} \frac{\partial T}{\partial x} {\vert}_{x = {R}_{gel} , z > 0} = {q}_{conv} + {q}_{evp} \qquad ( 17 )$$

$$- {k}_{eff} \frac{\partial T}{\partial x} {\vert}_{x = {R}_{gel} , z < 0} = {q}_{conv} \qquad ( 18 )$$

$$- {k}_{eff} \frac{\partial T}{\partial z} {\vert}_{z = - {H}_{EPS}} = {q}_{conv} \qquad ( 19 )$$

Here, q_{conv}=h_{conv}(T_{S}−T_{amb}) is the convection heat transfer, q_{abs}=φ_{abs}Pₛₒₗₐᵣ is the absorbed solar energy (φ_{abs} is absorptivity), gₑᵥₚ=\dot{m}ₑᵥₚΔHᵥₐₚ is the heat loss caused by water evaporation (ΔHᵥₐₚ is the latent heat of vaporization measured by experiments), and q_{rad} is the net radiation, acquired by

$${q}_{rad} = {q}_{rad , out} ( {T}_{S} ) - {q}_{rad , in} ( {T}_{amb} ) \qquad ( 20 )$$

in which q_{rad, out}(T_{S}) and grad, in (T_{amb}) are, respectively, the outgoing power emitted out by the Metagel-2 surface and the incoming power from the downwelling atmospheric radiation, calculated by

$${q}_{rad , out} ( {T}_{S} ) = 2 π {\int }_{0}^{π / 2} sin θcosθ {\int }_{0}^{∞} {I}_{B} ( {T}_{S} , λ ) ε ( λ , θ ) d θ d λ \qquad ( 21 )$$

$${q}_{rad , in} ( {T}_{amb} ) = 2 π {\int }_{0}^{π / 2} sin θcosθ {\int }_{0}^{∞} {I}_{B} ( {T}_{amb} , λ ) {ε}_{amb} ( λ , θ ) d θ d λ \qquad ( 22 )$$

Here, I_{B} (T, λ) represents the spectral radiance by Planck's law, expressed as

$${I}_{B} ( T , λ ) = \frac{2 {hc}^{2}}{{λ}^{5}} \frac{1}{{e}^{hc / λ {k}_{B} T} - 1} \qquad ( 23 )$$

where λ, c, h, and k_{B} are the wavelength, velocity of light, Planck's constant, and Boltzmann constant, respectively. ε(λ, θ) is the experimentally measured spectral emissivity of Metagel-2. ε_{amb}(λ, θ) is the atmospheric emissivity, which can be simulated by the atmospheric transmissivity [φₜᵣₐₙ(λ)] using

$${ε}_{amb} ( λ , θ ) = 1 - {{φ}_{tran} ( λ )}^{1 / cos θ} \qquad ( 24 )$$

Here, φₜᵣₐₙ(λ) can be modeled from MODTRAN®.

Note that all the above boundary conditions are given for the physical model according to the inventors' experiments (FIG. 15a). After validating the model, the inventors further considered the application cases and built a 2D periodic model (FIG. 15 (b)) which ignores the edge effect to analyse the evaporation performance. In this model, the EPS base is replaced by a concrete and the bottom surface of the concrete is set to a constant indoor temperature (25° C.). The corresponding boundary conditions for the water transport equation [Eq. (1)] are described as,

$$- {D}_{L} \frac{\partial {θ}_{L}}{\partial z} {\vert}_{z = {H}_{gel}} = \frac{{m}_{evp}}{{ρ}_{L}} \qquad ( 25 )$$

$$- {D}_{L} \frac{\partial {θ}_{L}}{\partial x} {\vert}_{x = {R}_{gel}} = 0 \qquad ( 26 )$$

$$- {D}_{L} \frac{\partial {θ}_{L}}{\partial z} {\vert}_{z = 0} = 0 \qquad ( 27 )$$

and the heat transfer equation [Eq. (4)] is simplified as

$$- {k}_{eff} \frac{\partial T}{\partial z} {\vert}_{z = {H}_{gel}} = {q}_{conv} - {q}_{abs} + {q}_{rad} + {q}_{evp} \qquad ( 28 )$$

$$T {\vert}_{z = - {H}_{EPS}} = {T}_{in} \qquad ( 29 )$$

### Numerical Methods

Both the water transport and heat transfer equations are solved in the commercial software COMSOL Multiphysics 5.6. After checking mesh independence, a 0.1 mm×0.1 mm grid is adopted in all calculations. The time step is smaller than 10 s and the residuals are all set to be 10⁻⁶. The properties of water, air, EPS, and con are extracted from the COMSOL material library while those of the Metagel-2 are obtained by experimental measurements.

### Extended Simulations

Thermal analysis of bare concrete and conventional radiative cooling (FIGS. 7g and 7i) are based on model b (FIG. 15 (b)). The property of radiative cooling is set to 98% solar reflectance and 98% broadband LWIR emittance (ideal PRC which has not been achieved experimentally so far) with a thickness of 0.5 mm (physical property based on poly(methyl methacrylate) (PMMA)), superior to the best radiative cooler reported so far.

In FIG. 7e and Table 6, cooling demand of water layer and Metagel-2 are compared through a quantity controlling method based on model b. For certain surface area covered with 10-mm-thick Metagel-2, water consumed within a single cyclic cooling is considered as a pure water evaporation layer to cool down the same surface area, where the water layer is around 1.5 mm. With the same water consumption, Metagel-2 saves 92% active cooling demand and extends more than 50% cyclic cooling time.

TABLE 6
Comparison data on cooling performance (ACD and
cooling cycle duration) with controlled water
quantity exhibited by a 10-mm-thick Metagel-2.

| | Active Cooling Demand | Cooling Cycle Duration |
|---|---|---|
| Type of Sample | (W/m²) | (hours) |
| Water Layer | 746.4 | 5.56 |
| Metagel-2 | 58.5 | 8.45 |
| (10-mm-thick) | | |

Atmospheric conditions in all simulation results are based on average tropical climate tested in Singapore (typical sunny day), where the solar intensity is ˜1000 W/m², RH is ˜60%, and the wind speed is ˜1.5 m/s.

### Example 8: Evaluation of Cooling Performances of Hydrogels

### Example 8a: Atmospheric Condition in Tropical Area

Conventional passive radiative cooling has attracted ever-increasing attention where sub-ambient surficial cooling can be achieved through designed passive radiative cooler (PRC) with high solar reflectance and LWIR emittance. Two criteria are essential for successful sub-ambient cooling outcome, i.e., the prevention of solar heat gain and thermal output through the atmospheric window. Tropical areas, where the ambient temperature remains high throughout the year, have high demand for passive cooling technologies. However, as theoretically simulated, a near-ideal PRC with 98% solar reflectance and 98% (broad band) LWIR emittance only achieves 12.42 W/m² cooling power density (output power density by LWIR radiation at near steady state) in the model discussed in the earlier sections.

High humidity narrows the atmospheric window (8-13 μm), further minimizes the effective thermal radiation. The undesirable effect is reflected by the high spherical downwelling atmospheric radiation (DLR). The inventors monitored the DLR at the experimental location (exact place of setup) and compared with conventional results which clearly states the experimental setup location.

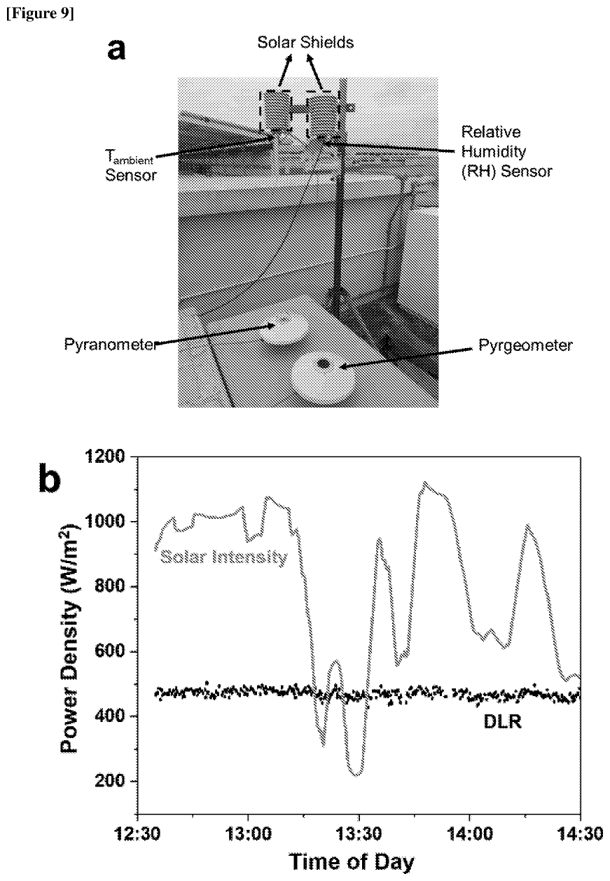

FIG. 9 shows the outdoor climate condition monitoring during a typical sunny day in Singapore. Temperature and atmospheric conditions were recorded based on automatic datalogging system, as shown in FIG. 9. K-type self-adhesive thermocouples (SA3-K-120, Omega) connected with data logger (NI DAQ module) were applied to sense real-time interfacial temperature. All temperatures were calibrated with standard error of K-type thermocouple. Solar intensity was recorded by a secondary standard pyranometer (LP PYRA 10, Delta Ohm) during test, while atmospheric radiation was recorded by a pyrgeometer (LP PYRG 01, Delta Ohm). Humidity and real-time air temperature were recorded through a professional weather station (Solar shield: Delta Ohm).

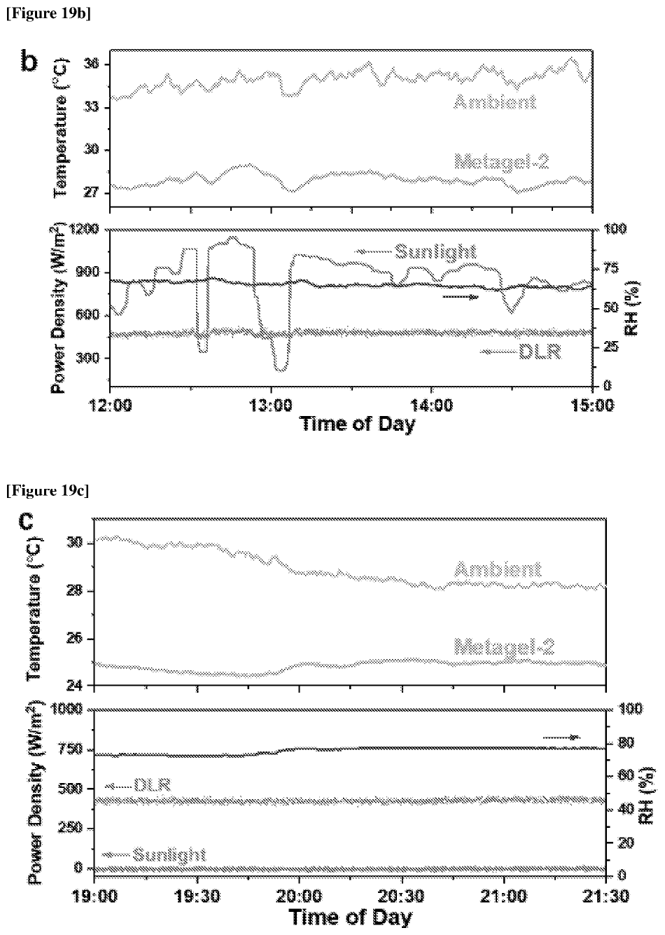

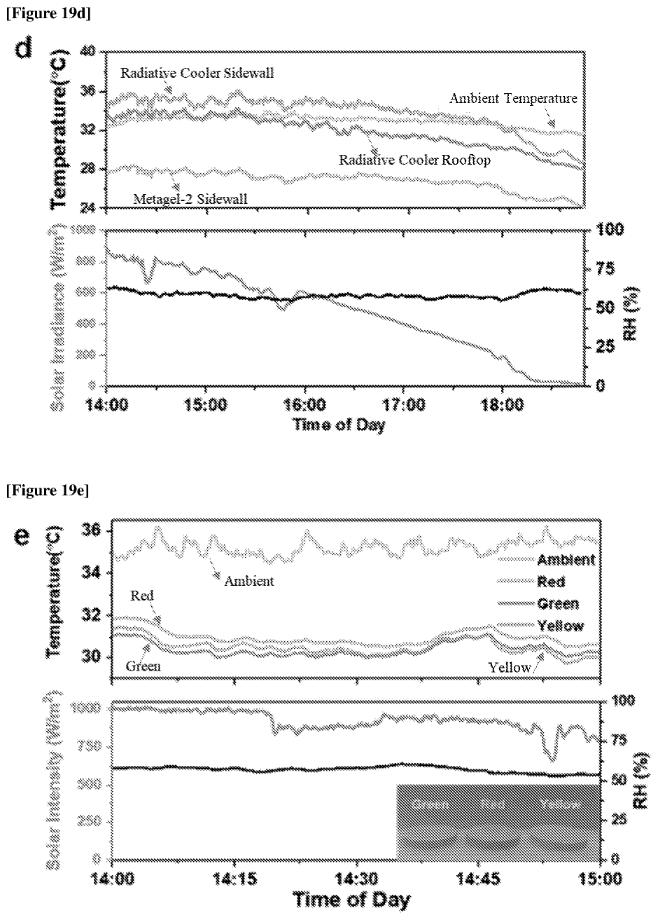

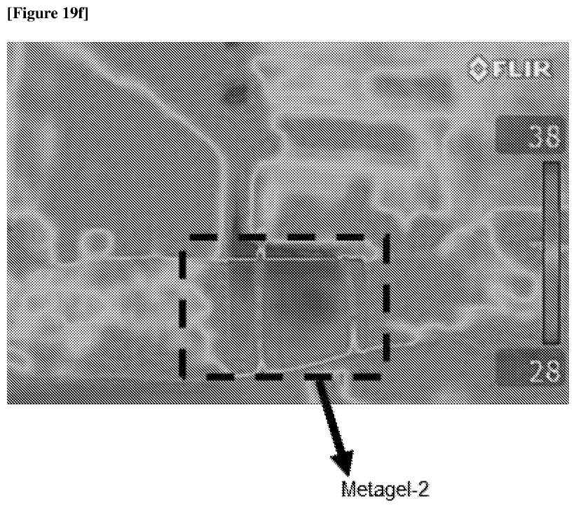

Under a typical sunny day in Singapore, DLR reached an average value of 470 W/m² independent of the solar intensity (FIG. 9). Meanwhile, the reported average DLR from mid-latitude area ranges from 300-400 W/m², indicating a broader atmospheric window than that of Singapore. Thus, with such atmospheric conditions, a conventional PRC can only achieve a near or above ambient temperature after cooling. With the narrowed atmospheric window, even very high LWIR emittance (90-100%) has negligible effect on cooling performance. As shown by a PRC on sidewall in FIG. 19d, the overall cooling effect is negligible despite the LWIR emittance of 91%.

### Example 8b: Cooling Performance

A material or structural media that is water maintainable for evaporative cooling, thermal isolative, solar reflective, and LWIR emissive for radiative cooling could be used for adaptive passive cooling or act an adaptive passive cooler (APC). The introduction of surficial water phase change for evaporative cooling would amend the optical criteria of the cooler from those of a passive radiative cooler (PRC).

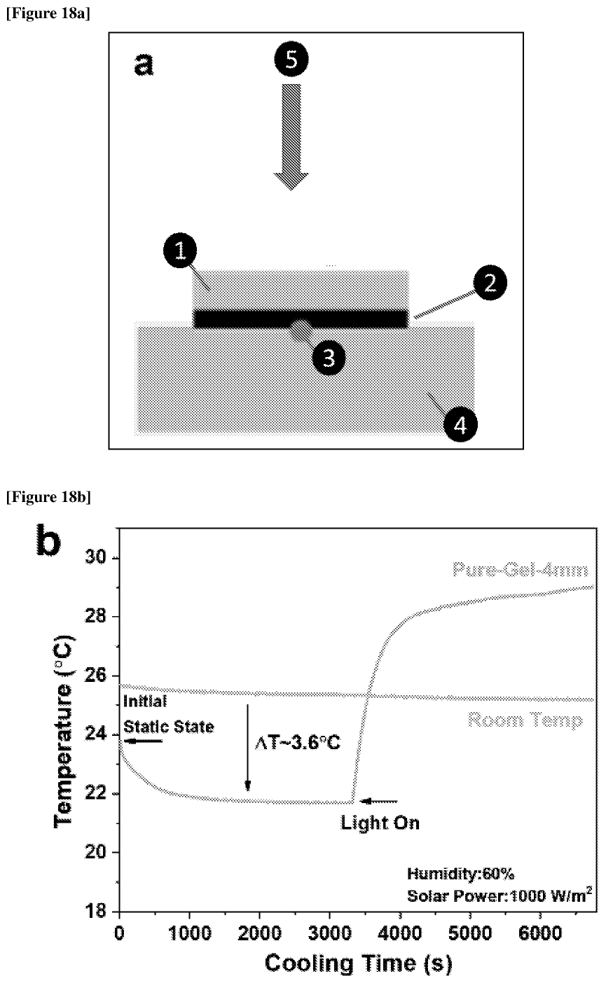

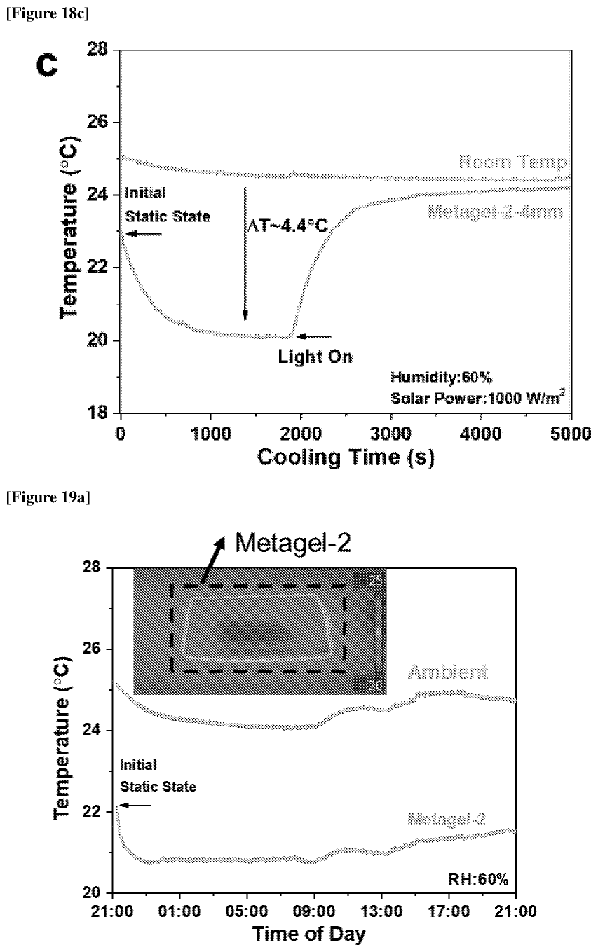

Evaluation of cooling performances of hydrogel was conducted using passive cooling tests. Passive cooling test was conducted by temperature recording using automatic datalogging system and calibrated K-type thermocouples as shown in FIG. 18a. The same setup in FIG. 18a was also applied for outdoor temperature recording. FIG. 18a to 18c shows the indoor evaporative cooling test setup and results.

High quality expanded polystyrene (EPS) foam with ultralow thermal conductivity (k˜about 0.03 W/m-K) was applied as thermal isolator at the bottom. A 0.4-mm-thick aluminium (Al) foil was used as the cooling target with a K-type self-adhesive thermocouple attached. The thermocouple was connected to data logger for real-time temperature recording. Samples were placed above the Al foil for cooling under both indoor and outdoor conditions. Illumination for indoor test was achieved by a solar simulator with 1.0 Sun. The solar intensity recorded for outdoor test was from natural sunlight. FIGS. 18b and 18c show the temperature recording during indoor evaporative cooling test of (b) Pure-Gel (4 mm) and (c) Metagel-2 (4 mm), where the introduction of solar illumination (1000 W/m²) proves the effectiveness of sub-ambient passive cooling in Metagel-2.

Furthermore, cooling performance of Metagel-2 was investigated for a 24-hour indoor and outdoor cooling. FIG. 19a to FIG. 19f illustrate the results for an all-condition cooling performance of Metagel-2. FIG. 19a demonstrated that 24-h indoor cooling (of about 3° C. below ambient temperature) was achieved with 4-mm-thick Metagel-2, which is not achievable for PRC.

Strikingly, outdoor cooling of about 6° C. below ambient temperature in early afternoon of a sunny day (solar irradiance up to 1140 W/m² at RH>60%), is apparent in contrast to the near-ambient temperature of the state-of-the-art PRC under similar ambient conditions (FIG. 19b and FIG. 9). Moreover, the temperature of the cooled hydrogel remains very stable at 28 t 0.5° C., effectively avoiding the drastic temperature variation caused by fluctuating solar heat gain. Night-time sub-ambient (of about 3-5° C.) cooling was also achieved despite the high RH of about 80% (FIG. 19c).

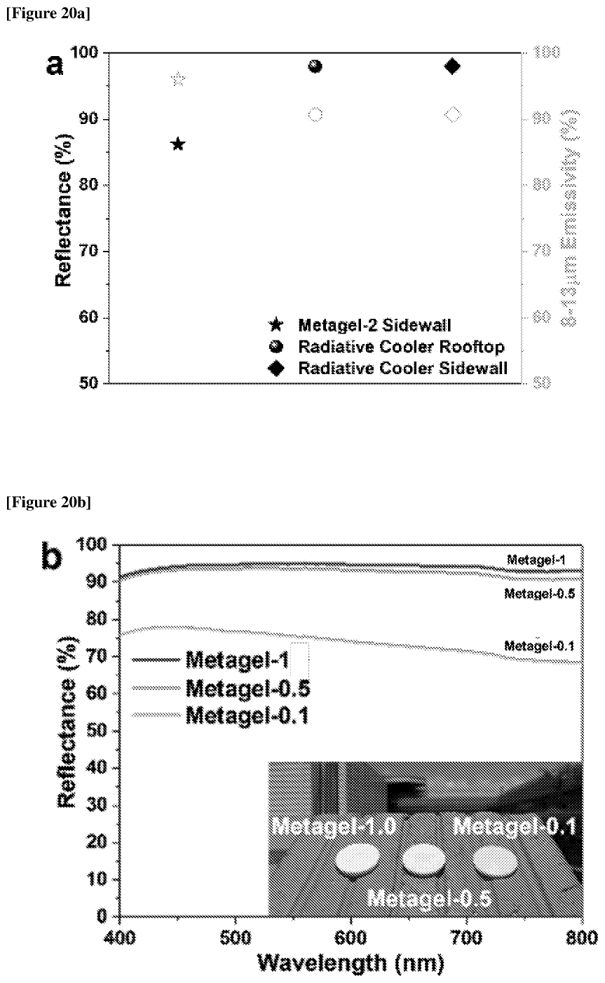

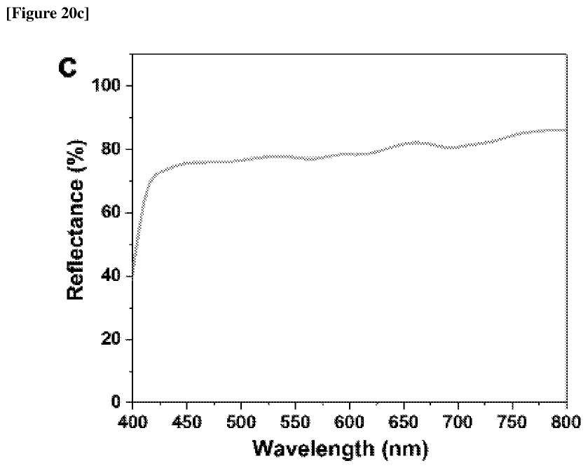

A typical PRC shows 2° C. higher temperature on sidewall than that on rooftop, which is near ambient temperature (FIG. 19d and FIG. 20a) due to the tilted radiation angle. In contrast, Metagel-2 shows about 4° C. sub-ambient temperature on both sidewall and rooftop. Notably, the reflectance of the hydrogel can be decreased to reduce glare/light pollution without compromising the cooling performance (FIG. 20b and FIG. 20c).

### Example 8c: Cooling Performance of Coloured Metagel-2

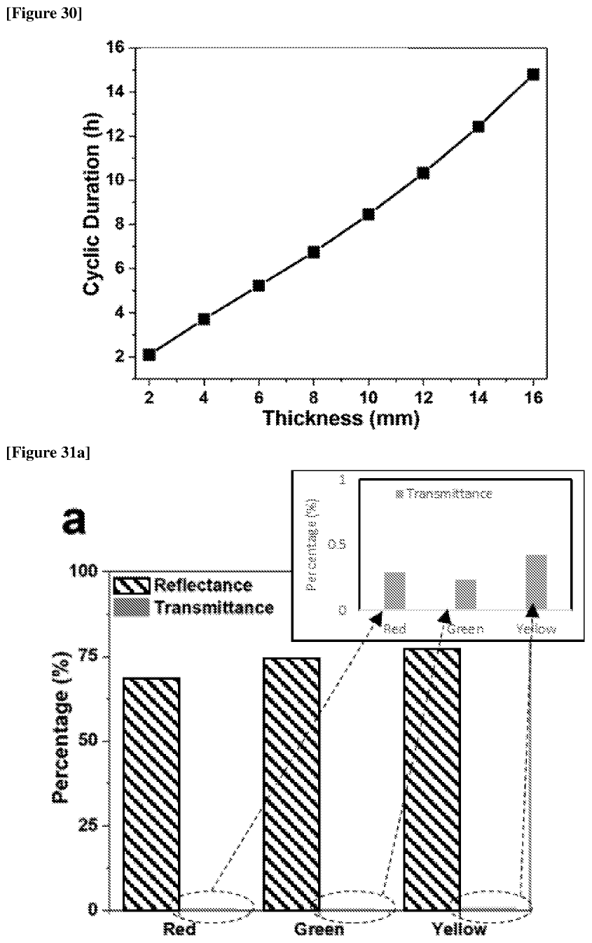

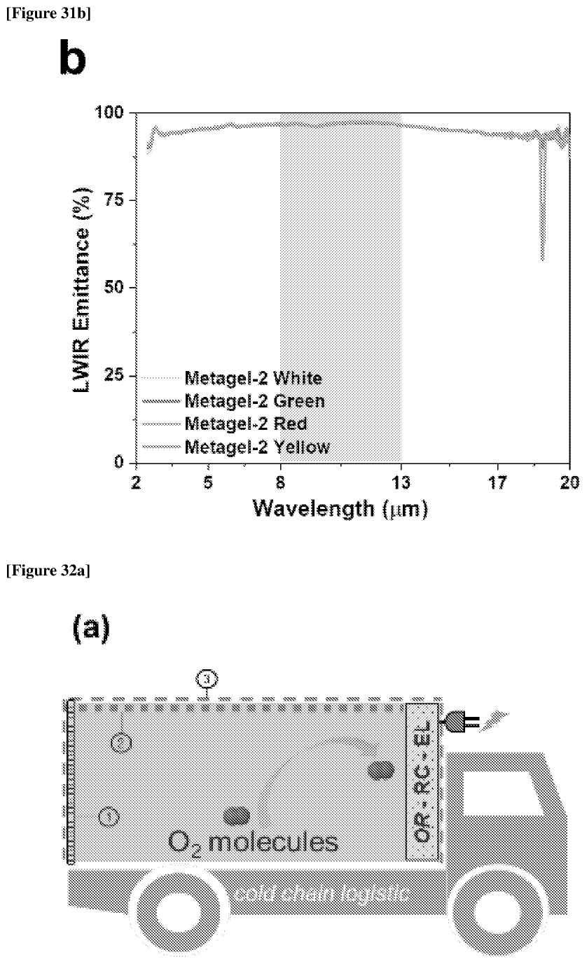

PRCs typically appear white to reflect all visible solar spectrum, thus coloured PRCs that have broader applications inevitable have increased solar heat gain, leading to above-ambient temperature. FIGS. 31a and 31b show the optical performance of coloured Metagel-2 (white, green, red, and yellow). In contrast, coloured Metagel-2 still shows sub-ambient (about 2.5° C., FIG. 19e and FIGS. 31a and 31b, Table 7) cooling performance under ˜1000 W/m² due to the rationally integrated cooling strategies.

TABLE 7
Tabulation of solar reflectance and
transmittance of coloured Metagel-2.

| Colour of Metagel-2 | Reflectance (%) | Transmittance (%) |
|---|---|---|
| Red | 68.9 | 0.29 |
| Green | 74.7 | 0.23 |
| Yellow | 77.0 | 0.42 |

Herein, optical properties of a typical hydrogel framework are designed to obtain a hydrogel that is solar reflective, heat isolative, LWIR emissive and water evaporative. Passive cooling of 4° C. to 6° C. below ambient temperature may be obtained in all conditions of a tropical climate (for example in Singapore, 1.3477N 103.6816E) including sunny, cloudy, and rainy days (both indoor and outdoor). Interestingly, APC maintains a stable temperature regardless of the fluctuating ambient conditions thanks to APC's adaptive nature, attributed the rational integration of various cooling strategies including solar reflection, heat isolation, LWIR emission, and water evaporation.

It is demonstrated that stable sub-ambient (4° C. to 6° C.) passive cooling in all tropic climate conditions in sunny, cloudy, and rainy days (both outdoor and indoor) by a rational integration of various passive cooling strategies in a hydrogel. The hydrogel cooler adaptively adjusts the contributions of the integrated passive cooling strategies according to ambient conditions, resulting in a stable sub-ambient temperature regardless of the fluctuating ambient conditions.

### Example 9: Cooling Applications

Hydrogel may be applied, coated, mixed or integrated onto a surface or object such as concrete or walls for use in adaptive passive cooling. FIG. 24b shows a setup and comparison of the active cooling demand (ACD) maintaining at comfortable indoor temperature between bare concrete (left) and hydrogel-covered concrete (right), where (1) represents concrete; (2) represents hydrogel; (3) represents comfortable temperature; (4) represents sunlight; (5) represents parasitic heat; (6) represents heat transfer; and (7) represents cooling demand. It can be observed that for the hydrogel-covered concrete (right), the heat transfer and cooling demand is lesser than that of the bare concrete (left). Comparing with the bare concrete (FIG. 24b), hydrogel-coated concrete surface can effectively minimize incoming solar heat gain and parasitic heat transfer, further decreases the active cooling demand (ACD) offered by active cooling systems (e.g., air conditioner) for maintaining comfortable temperatures. Similar strategies could be extended from evaporative cooling roof to evaporative cooling walls, and to downdraft evaporative cooling in buildings and constructions.

For adaptive passive cooling, through theoretical light scattering analysis, UV-vis-NIR energy is strongly scattered by BSPs with diameters of 0.3-0.4 μm, resulting in selective optical regulation in APC (FIG. 24c). Glutaraldehyde crosslinks polymer chains through acetal reaction while electrostatic force between —SO₄ and —OH anchors the interpenetrated BSPs with diameters of 0.3-0.4 μm, as guided by theoretical analysis (FIG. 24d and FIG. 12). BSPs introduce strong Mie scattering to UV-vis light (FIG. 24e, FIG. 11a-11c), leaving negligible transmission (FIG. 24f) through Metagel-2, where 2 denotes the ratio of added BSPs to other components. The presence of water obviously leads to NIR absorption (FIG. 24e, grey), driving evaporative cooling. The strong visible-light backscattering leads to the white appearance (FIG. 24g, upper panel). Moreover, Metagel-2 exhibits high LWIR emissivity (˜94%, FIG. 24h) in dry state (freeze drying), attributing to the intrinsic vibration of OH and SO₄ bonds. Notably, LWIR emittance increases with the enrichment of water [˜0.94 (dry) vs ˜0.97 (wet)], which is highly LWIR emissive. Notably, 97% LWIR emittance benchmarks that of the state-of-the-art PRC. Due to these superior parameters favouring passive cooling, Metagel-2 shows 5-6° C. sub-ambient temperature even under intensive sunlight (˜1045 W/m²) with RH˜60%, as revealed by the IR image in FIG. 24g (lower panel).

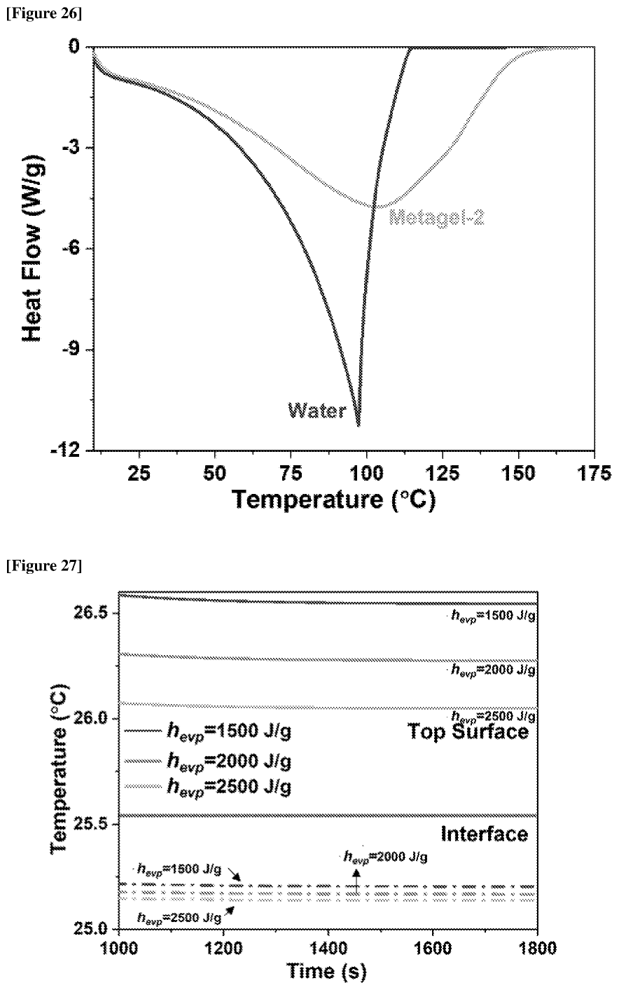

Compared to pure hydrogel (Pure-Gel), Metagel-2 exhibits 19% higher water content with 40% less bound water, providing 51% more evaporable water (FIG. 7a and FIG. 13a-13b). Evaporable water refers to free water and intermediate water. Though the hydroxyl groups on polymeric chains are partially occupied by electrostatic force for BSP binding (FIG. 12), the expanded porous matrix owing to steric hindrance effect (SHE) arising from BSPs enhances intermediate/free water storage compared to Pure-Gel (FIG. 25). Dynamic mechanical analysis reveals that hydrogel possesses stronger mechanical strength (storage modulus) benefiting from the interpenetrated BSPs, and the increased loss modulus suggests significant SHE (FIG. 7b). The decreased connection among polymeric chains arising from SHE further impedes inner heat transfer, leading to lowered thermal conductivity at both saturated and dry states. (FIG. 14). Endothermic curve (FIG. 26) indicates distinct evaporative behaviours in Metagel-2 compared to pure water, where the drastically broadened peak suggests the presence of bound and intermediate water with stronger hydrogen bonding interaction. Thermal analysis (FIG. 27) clearly reveals that higher evaporative enthalpy (FIG. 7c) in hydrogel is more favoured for better cooling than Pure-Gel.

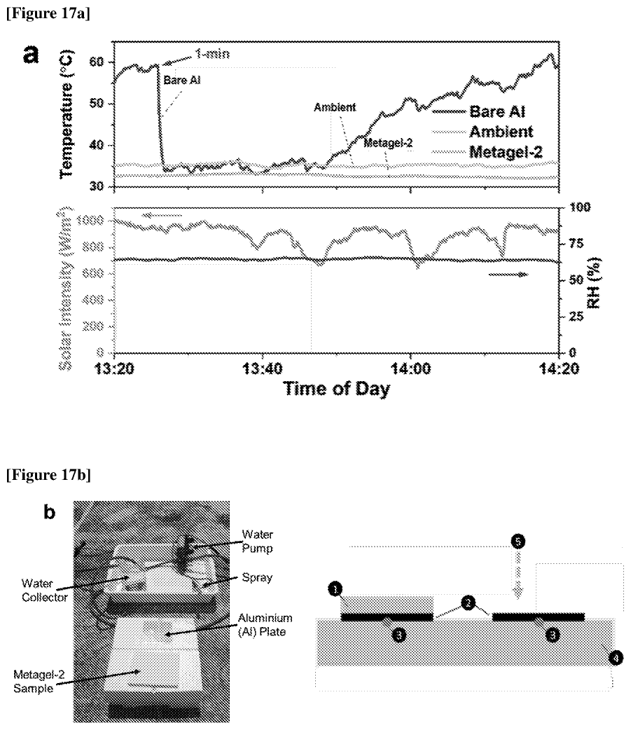

The Raman OH stretching mode shows a lower intermediate/free water (IW/FW) ratio in Metagel-2 than Pure-Gel (FIG. 7d and FIG. 16), suggesting less intermediated water content that leads to the higher evaporative enthalpy in hydrogel (FIG. 7c). The distinct water states fundamentally differentiate the evaporation behaviour of water in hydrogel from that of normal water, which leads to fine control of evaporation behaviour dynamically, resulting in the drastically increased evaporative cooling efficiency. Specifically, with the same amount of evaporated water, Metagel-2 saves 92% ACD in sunny day (solar intensity: 1000 W/m²; RH: 60%; wind speed: ˜1.5 m/s). Moreover, Metagel-2 shows 50% longer cooling cycle than normal water, indicating much more sustainable cooling effect (FIG. 7e). Cooling performances are compared between APC and conventional spray cooling in FIG. 17a and FIG. 17b. Though surficial temperature of bare aluminium (Al) decreased by 25° C. under continuous water spray (13.8 ml/m²-s), its temperature is still about 2° C. above that of Metagel-2 under strong sunshine (800-1000 W/m²). Moreover, the fluctuating Al temperature is in obvious contrast to the stable temperature of hydrogel. Importantly, the water consumption is more than 200 times higher than that of Metagel-2 (˜of about 0.05 ml/m²-s). It is worth noting that the surface temperature rose immediately as most water evaporates, suggesting non-sustainable cooling for spray cooling.

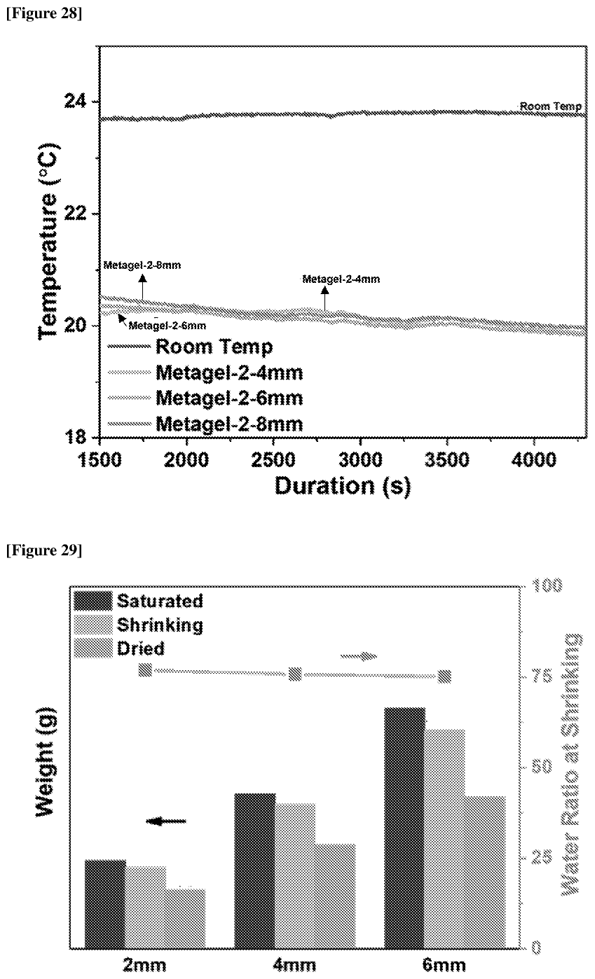

The lower indoor (to exclude radiative cooling) temperature of Metagel-2 than that of Pure-Gel (FIG. 7f, Table 8, and FIGS. 18b and 18c) proves the enhanced evaporative cooling. Moreover, 3000-s solar illumination (1000 W/m²) heated up Pure-Gel to 3.68° C. above ambient temperature. In contrast, Metagel-2 remained sub-ambient temperature. Notably, the thickness of hydrogel plays a negligible role in lowing temperature (FIG. 28) but only in increasing the cooling cycle length (FIG. 29-30, Table 9).

TABLE 8
Data on indoor evaporative cooling comparison and temperature rising comparison
(under solar illumination) between Pure-Gel and Metagel-2, measured at a relative
humidity of 60% ± 3% and solar intensity of 1000 W/m².

| | Difference in Temperature of the Air | Difference in Temperature of the Air to |
|---|---|---|
| Type of | to Temperature of Sample (° C.) at | Temperature of Sample (° C.) at 3000 s Solar |
| Sample | Static State | Heating State |
| Pure Gel | 3.6 | −3.68 |
| Metagel-2 | 4.4 | 0.21 |

TABLE 9
Water weight of different types of Metagel-2 (saturated, shrinking
and dried) with various thickness of 2 mm, 4 mm and 6 mm.

| Thickness of | Water Weight (g) of Metagel-2 At Various Conditions | | |
|---|---|---|---|
| Metagel-2/mm | Saturated | Shrinking | Dried |
| 2 | 19.5 | 18 | 13 |
| 4 | 34.6 | 31.8 | 23 |
| 6 | 53.2 | 48.3 | 33.5 |

Near-steady-state thermal analysis derived net power density (sunlight and environment) shows Metagel-2 coating significantly reduces ACD of rooftop by more than 81.5% for maintaining a comfortable indoor temperature (25° C.) (FIG. 7g). Compared to the state-of-the-art PRC, Metagel-2 leads to lower ACD when it is thicker than 6 mm. Heat isolation enhances when hydrogel thickness increases, leading to more effective rejection of incoming atmospheric thermal energy. Though ACD is reduced effectively, cooling efficiency (the ratio of compensated power density to thickness) starts to decrease because thickness plays a negligible role in decreasing solar heat gain (FIG. 7h). The intersection of cooling efficiency and reciprocal of ACD indicates 10 mm as an appropriate thickness for outdoor cooling (under ambient conditions in FIG. 7e) with acceptable ACD without compromising cooling efficiency apparently.

Under weak sunshine, radiative cooling could be sufficient while the weak solar energy absorption suppresses evaporative cooling. In contrast, under strong sunshine, radiative cooling becomes insufficient while the increased solar energy absorption accelerates evaporative cooling. The absorbed solar energy varies with solar irradiance throughout a day and in turn adjusts the evaporative cooling to compensate the needed ACD that is not able to be provided by radiative cooling (FIG. 7i). Consequently, the overall ACD remains stable regardless of the solar irradiance. As such, the hydrogel automatically tunes the contributions of various passive cooling strategies to maintain a stable ACD, leading to adaptive passive cooling in all-conditions regardless of the varying weather or indoor/outdoor conditions.

The hydrogel advantageously demonstrates superior cooling performance under harsh tropical weather conditions, for example in high relative humidity and strong solar radiation of about 1000 W/m² solar irradiance in tropic climate (Rₛₒₐᵣ=97%, E_{LWIR}=96%).

The hydrogel can achieve below ambient temperature of more than 6° C. during noon time in tropical area like Singapore with a solar density of up to 1100 W/m², which is the best passive cooling performance obtained.

### Example 10: Fabric-Supported Hydrogel

A hydrogel may be combined, mixed, incorporated or integrated with other materials such as a fabric or surface in order to further enhance its stability and mechanical properties.

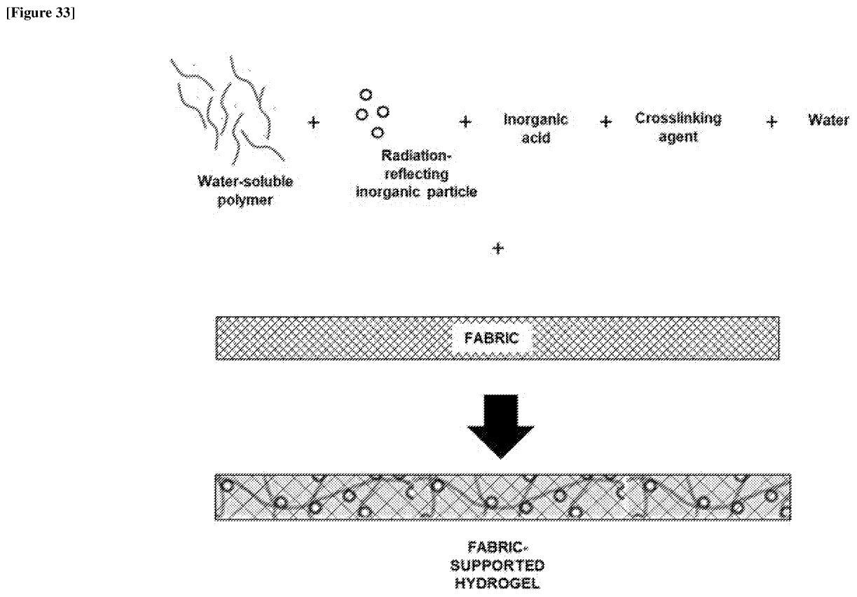

FIG. 33 shows a fabric-supported hydrogel comprising a fabric and the hydrogel of the present invention where the hydrogel components and fabric are mixed and integrated to form a fabric-supported hydrogel as shown in FIG. 33.

The fabric-supported hydrogel may also demonstrate enhanced mechanical stability in terms of durability, foldability, flexibility, and puncture-resistance. Furthermore, the hydrogel is easy to apply and may be used in various applications, materials and surfaces for cooling.

### Example 11: Application of Hydrogels in Food and Beverage

One of the potential applications of the hydrogel of the present invention is in the food and beverage such as a smart food and beverage storage system.

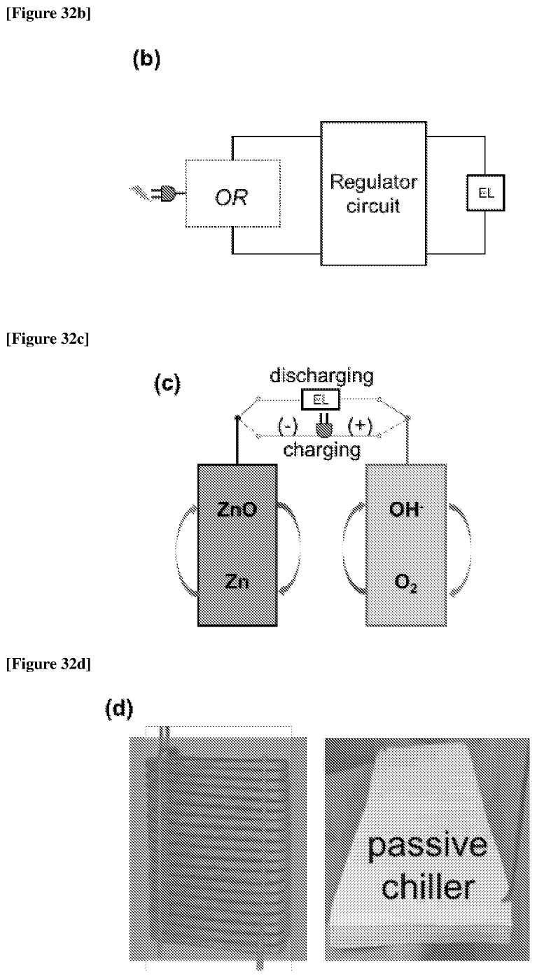

Proper food and beverage (F&B) packaging is crucial for avoiding F&B degradation during transportation and storage, and for extending shelf life of F&B, and thus avoiding F&B spoilage that is a major cause of F&B wastage. The hydrogel disclosed in accordance with the present invention can be used for passive cooling and can have significant impacts on F&B storage system, as illustrated by the example of a smart cold chain truck in FIG. 32a to 32d. FIG. 32a shows an oxygen removal (OR)-regulator circuit (RC)-electrical load (EL) unit attached to the cover; where (1) is a flexible and/or movable door/parts for maintaining the pressure inside the container when oxygen molecules are removed by the OR component; (2) is a hydrogel coating to maintain the moisture level inside the container; and (3) is a reflective hydrogel for both indoor and outdoor cooling

There are three features for the container on the smart truck: (1) the oxygen removal (OR)-regulator circuit (RC)-electrical load (EL) unit; (2) the flexible/movable door/parts (1); and (3) the hydrogel on the walls (2 and 3). The OR component removes the oxygen inside the container while generating electricity, which can be regulated by a RC component to an appropriate electrical signal to drive EL units (FIG. 32b). The EL unit could be a sensor, a display, a communication device, a LED, etc., or a combination of them, which are responsible for the Internet of Things (IoT) features. For instance, EL can display the oxygen level inside the container and the lifetime of OR component or send message/alert to control/management station. When oxygen is removed from the container, the flexible connector (part 1) on the wall allows deformation of the container to reduce the volume to prevent pressure drop during oxygen removal.

The hydrogel of part 2 is responsible for supplying moisture to the atmosphere inside the container, which is very critical for fresh vegetables and fruits. Part 2 also has passive cooling function (evaporative cooling). The reflective hydrogel of part 3 is responsible for passive cooling when the food container is placed outdoor or under sunshine. Notably, parts 2 and 3 can cover the container partially or fully; can also cover interior, exterior or both, depending on the applications.

The working principle of OR component is illustrated in FIG. 32c. The OR component comprises a metal-oxygen electrochemical cell, with an active element having a zinc (Zn) layer arranged as a porous electrode. Atmospheric oxygen (O₂) oxidizes the Zn metal, and thus is converted from gaseous state to solid state. An electrolyte, e.g., a solid hydrogel form of polyvinyl alcohol (PVA) containing potassium hydroxide (KOH) or aqueous solution of KOH. PVA is a water-soluble synthetic polymer with a backbone composed only of carbon atoms and is biodegradable under both aerobic and anaerobic conditions. PVA is widely used as a moisture barrier film for foods and food supplement tablets, and thus is completely safe even in case of food contact due to leakage. The overall reaction during oxygen removal is Zn+0.5O₂↔ZnO on the Zn electrode while O₂ is reduced to OH⁻ on the oxygen electrode. When the OR component is fully discharged, one can charge it for reuse. Hydroxide ions (OH⁻) transport across the electrolyte and get oxidized (on oxygen electrode) to release gaseous oxygen (O₂). The reverse reaction: ZnO+H₂O+2e⁻↔Zn+2OH⁻ occurs during charging. Notably, the Zn-air battery is a commercial power source for assistive hearing devices, thus having proven scalability, economic viability, and safety. Other metals such as iron may also be used with proper packaging of the OR component. Other alkaline such as sodium hydroxide could also be used as active component of electrolyte.

It is worth noting that the example and the concept of a cold chain truck in FIG. 32a to FIG. 32d may be applied to large-scale storage system, e.g., the food storage warehouse for supermarket and farm, or small-scale system, e.g., a food container. The detailed configurations of different components of the storage device/equipment, and other parameters such as dimensions and shapes may depend on the application scenario. Additionally, the application of hydrogel could be extended beyond storage of F&B. It could be used to store other things that needs to avoid oxygen and/or adjustable moisture level and/or sub-ambient temperature.

### Example 12: Other Uses of Hydrogels

### Controlling Of Visible Reflectance for Sidewall Application

A hydrogel may be used for passive radiative cooling. When the hydrogel is considered for cooling building, high visible solar reflectance would lead to glare or light pollution. FIG. 20b clearly reveals successful controlling of visible reflectance through tuning BaSO₄ particle addition. Specifically, Metagel-0.1 exhibits ˜75% visible reflectance, closing to that of commercial solar reflective paint (NIPPON SOLAREFLECT Si, FIG. 20c). The optical image (FIG. 20b) shows a darker appearance of Metagel-0.1 than those with higher BSP content. Hence, the hydrogel disclosed in the present invention is suitable for use in buildings and walls.

### Fire Retardant Test and Application of Hydrogel

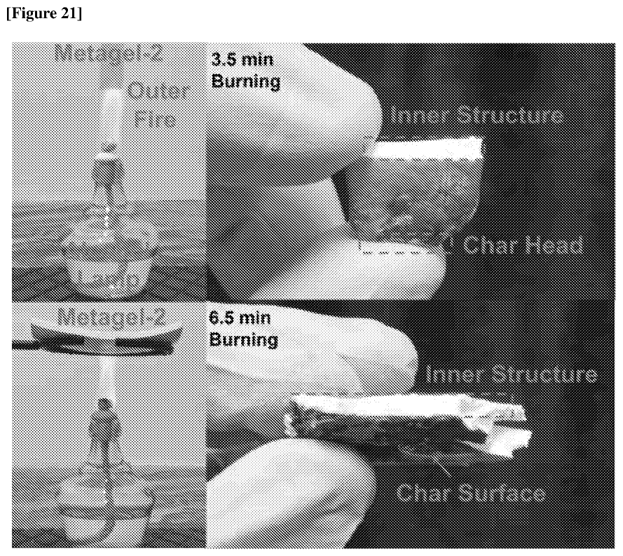

Since fire safety is a critical concern of building coating, a fire-retardant test was conducted (FIG. 21) to evaluate the use of hydrogel in buildings. Two directional burnings with an alcohol lamp were recorded, and the burned area was accessed.

Hydrogel maintained a stable inner structure after being burnt, where the cross-sectional area remained highly visible reflective (optically white), indicating excellent fire-retardant property that is attributed to the water contained in the hydrogel and presence of the radiation-reflecting inorganic particles, BaSO₄ particles.

These features suggest the promise for cooling buildings. The embedded radiation-reflecting inorganic particles endow the hydrogel's strong Mie scattering to reflect more than 85% of incident solar energy, preventing the direct surface heating underneath. Parasitic heat transfer from surrounding and intrinsic near infrared (NIR) absorbance of water act as evaporation trigger, resulting in water concentration gradient inside the hydrogel and thus further accelerates the heat exchange at cooler-building/construction (from building/construction to cooler) interface. Meanwhile, water evaporation efficiently converts bulk thermal energy into water potential energy, leading to decreased cooler temperature with formation of temperature gradient, which strengthens the heat exchange at cooler-building/construction interface. Besides the evaporative cooling process, LWIR radiation is dominated by intrinsic bond vibrations within polymeric chain and water, realizing the continuous radiative cooling process. Since the hydrogel comprises super hydrophilic polymeric matrix, rain is favoured and acts as water replenishment. In summary, the hydrogel in accordance with the present invention possesses high solar reflectance (negligible transmittance), significant evaporative cooling effect, and continuous radiative cooling contribution.

Additionally, hydrogel holds promise as cooling pads thanks to its non-hazardous nature (FIG. 10a) and excellent mechanical flexibility and strength. 2-mm-thick Metagel-2 can be conformally attached to skin (FIG. 19f and FIG. 10b to FIG. 10d), resulting in about 28° C. skin temperature despite the high ambient temperature (about 33° C.) under 1 Sun. APC opens a route for adaptive passive cooling under all conditions in tropic climates and beyond.

### Other Potential Applications

Apart from F&B and fire-retardant applications discussed above, the hydrogel in accordance with the present invention may be used in fields and applications as follows:
Buildings and Constructions (for continuous cooling of surfaces, building and construction such as rooftop and sidewall; The building/construction could be residential or industrial or commercial buildings);
Passive chiller (FIG. 32d) that can cool down water passing through in an energy-saving manner;
Cooling of Surfaces (e.g. to cool portable surfaces for both outdoor and indoor conditions, such as energy storage device (e.g., lithium-ion batteries and capacitors) and energy conversion devices (e.g., PV device and thermoelectric device));
Cooling of integrated circuit chips/circuits and electronic systems;
Water maintain layer for plant cultivation in smart/advance farm, above which the reflected sunlight can be re-utilized by leaves;
Cooling gel sheets for kids with fever or for personal cooling in summer; and
Cooling for wearable tools and equipment for outdoor job or activities such as helmet of construction workers and cab of excavator, digger, etc..

### Comparative Example 1: Use of Sulfuric Acid in Forming Hydrogels

The use of sulfuric acid in the invention is crucial. FIG. 8 shows the comparison of (1) hydrogel which is crosslinked with sulfuric acid and (2) hydrogel which is crosslinked without sulfuric acid, after an hour (one hour) of adding crosslinking agent. Apart from the use of sulfuric acid, the same components are used. From the figure, the hydrogel (1) which is crosslinked with sulfuric acid is crosslinked and solidified within five minutes. The use of sulfuric acid increases crosslinking density and allows a faster crosslinking reaction. The hydrogel obtained from the crosslinking with sulfuric acid has an improved mechanical strength and stability and is able to free-stand as shown in FIG. 8. Further shown in FIG. 8, without the use of sulfuric acid in the hydrogel precursor as shown in Table 1a, the hydrogel obtained within the same duration (five minute here) may not be self-standing and the crosslinking reaction is much slower.

The hydrogel of the present invention is a free-standing hydrogel matrix with integrated optical and thermal properties, in which the structural and composition can be tuned based on various applications.

### Comparative Example 2: Comparison Between Chemical-Crosslinked Metagel, Physical-Crosslinked Metagel and Multi-Crosslinked Metagel Supported by a Fabric

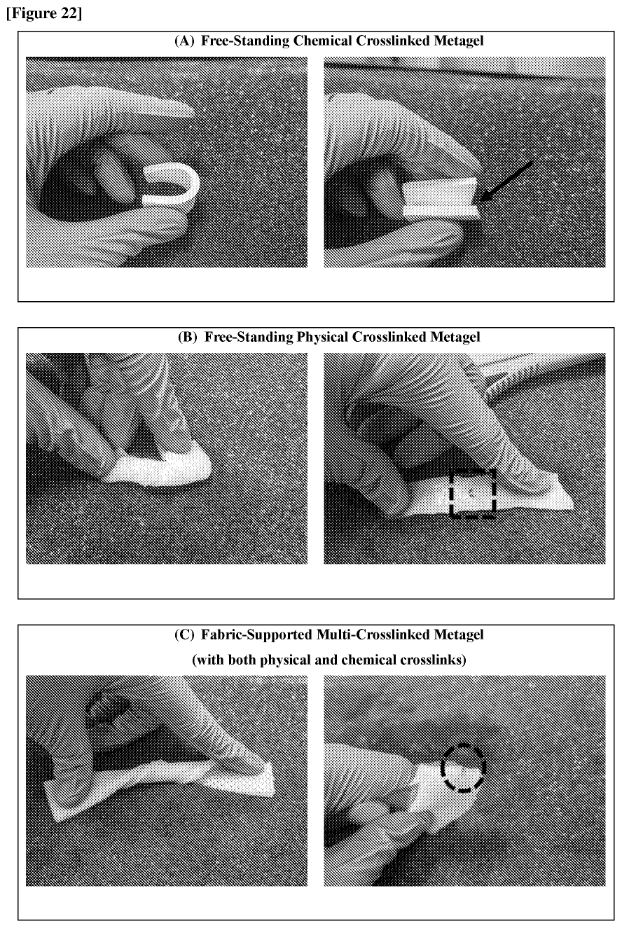

The fabric-supported multi-crosslinked hydrogel in accordance with the present invention shows enhanced mechanical stability in terms of durability, foldability, flexibility, puncture-resistance and more (FIG. 22). A comparison of the mechanical strength and flexibility of free-standing chemical crosslinked metagel, free-standing physical crosslinked metagel, and fabric-supported multi-crosslinked metagel is illustrated in FIG. 22. The left photograph in FIG. 22 (A) shows a soft and slightly bent chemical crosslinked hydrogel. However, the hydrogel cracks under strong bending as shown in the right photograph in FIG. 22 (A). For a hydrogel with physical crosslinking, the hydrogel is foldable as shown in left photograph of FIG. 22 (B). However, after undergoing a puncture test, the hydrogel with physical crosslinking is broken under puncture as shown in dotted square in right photograph in FIG. 22 (B). With a combination of both physical and chemical crosslinking, a multi-crosslinked fabric-supported hydrogel is foldable and puncture resistant as shown in FIG. 22 (C).

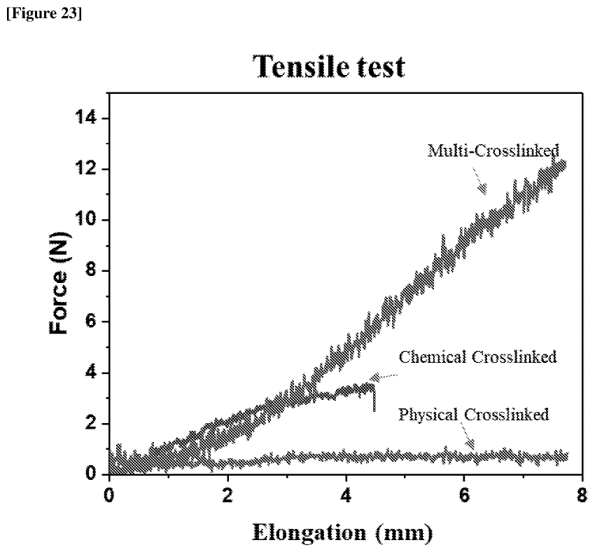

Further, the tensile strength of the chemical crosslinked, physical crosslinked and multi-crosslinked fabric-supported hydrogel is measured and compared (FIG. 23). FIG. 23 shows the PVA based hydrogel with different crosslinking method: Chemical crosslinked with GA as crosslinking agent; Physical crosslinked with freeze thawing method; and Multi crosslinked with both method and fabric bones. It shows that it has the highest maximum amount of stress a material can bear before failure (tensile strength), which means that it is more durable, and malleable.

### Comparative Example 3: Comparison Between Hydrogel Cooling and Conventional Spray Cooling

A comparison between a hydrogel of the present invention and conventional spray cooling is conducted. Referring to FIG. 17b, (1) represents the hydrogel, (2) represents the aluminium (Al) plate, (3) represents the thermocouple, (4) represents the expanded polystyrene (EPS) foam and (5) represents the water spray. The water spray is operated using a pump of effective power of 3 W and at an effective rate of about 0.2 mL/s. The temperature of the water is about 30° C.

To compare the hydrogel cooling with the conventional spray cooling technique, the inventors compared the surficial temperature at different condition. To get an accurate temperature response and to prevent direct heating of thermocouple, aluminium (Al) plate is taken as the cooling target.

FIG. 17a and FIG. 17b show the cooling performance between Metagel-2 and conventional spray cooling. As indicated by FIG. 17b, two Al plates were attached to a thermal isolator (an expanded polystyrene foam (EPS foam)), with only one covered by Metagel-2. Commercial water spray system is applied for surface spray cooling. The effective spray rate is estimated by the ratio of sample area to spray area at controlled distance (of about 20 cm). The sprayed water was stabilized outdoor with an average temperature around 30° C. Effective power consumption of pump is estimated by the total pump power divided by the number of the maximum enabled sprayer. Both the spray-cooled and hydrogel-cooled Al plate temperatures were recorded simultaneously, followed by 1-min water spray to cool down the bare Al surface. After water spray stops, the evaporation of the sprayed surficial water maintained a low surficial temperature, which mainly attributes to the low solar absorbance and small heat capacity of Al plate.

Compared to hydrogel cooling, conventional spray cooling not only has significantly higher water consumption, but also higher energy consumption in order to continuously maintain a low surficial temperature. Despite the superior water and energy-saving features, hydrogel has even lower and more stable cooling temperature, showing the advantages of the optimized water evaporation cooling efficiency in hydrogel.

### Comparative Example 4: Radiation-Reflecting Particle in Hydrogel

Integrated passive cooling of a hydrogel requires rational design on both evaporative and radiative cooling performances, as well as the coordination between their roles. For radiative cooling function, prevention of as much solar heat gain as possible is critical for the cooling outcome. However, water, an IR absorber, allows the penetration of UV-vis-NIR (300-1300 nm) light that may further leads to solar heating. Thus, pure hydrogel (Pure-Gel) is not able to achieve sub-ambient passive cooling under intense sunlight, necessitating the addition of a radiation-reflecting particle such as BaSO₄ nanoparticle that reflect UV-vis-NIR light.

Addition of BaSO₄ not only affects optical performance, but also the water evaporative behaviour in hydrogel as described in the earlier sections. From optical aspects, the overall reflectance within 300-1300 nm increases with larger particle content, while the reflectance starts to level off from Metagel-2 onwards.

### INDUSTRIAL APPLICABILITY

Thus, it can be seen from the present disclosure that a hydrogel with both physical and chemical crosslinking has been disclosed. The hydrogel is stable and has good mechanical properties (durability, foldability, flexibility, and puncture-resistance). This may provide a hydrogel with a longer lifetime, higher integrity and gives an effective use and cost-efficiency. The hydrogel also has an efficient heat isolation layer through high solar reflection and low thermal conductivity and is able to cool temperature under harsh tropical weather conditions. The hydrogel is able to be combined or integrated with other materials in order to further enhance its stability and mechanical properties. In addition, the hydrogel with enhanced mechanical stability which successfully, simultaneously, advantageously address the problems and challenges of passive cooling technologies. Furthermore, the disclosed method of preparing the said hydrogel is a cost-effective, simple, environmentally friendly and scalable manufacturing process for mass production.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A method of preparing a hydrogel, comprising:
(i) preparing a mixture of water-soluble polymer, inorganic acid, and radiation-reflecting inorganic particles;
(ii) adding a crosslinking agent to the mixture to form a hydrogel precursor;
(iii) freezing and thawing the hydrogel precursor thereby forming a hydrogel,
wherein the hydrogel precursor comprises:
about 5 wt % to about 30 wt % of water-soluble polymer;
about 0.3 wt % to about 2.5 wt % of inorganic acid;
about 0.05 wt % to about 0.5 wt % of crosslinking agent; and
about 3 wt % to about 70 wt % of a radiation-reflecting inorganic particle,
wherein the wt % is based on the total weight of the hydrogel precursor.

2. The method of claim 1, wherein the hydrogel precursor comprises:
about 5 wt % to about 25 wt % of water-soluble polymer;
about 0.3 wt % to about 1.2 wt % of inorganic acid;
about 0.05 wt % to about 0.25 wt % of crosslinking agent; and
about 30 wt % to about 70 wt % of a radiation-reflecting inorganic particle,
wherein the wt % is based on the total weight of the hydrogel precursor

3. The method of claim 1, wherein step (iii) is repeated at least once.

4. The method of claim 1, wherein chemical crosslinks within the hydrogel are formed in step (ii); and/or wherein physical crosslinks within the hydrogel are formed in step (iii).

5. (canceled)

6. The method of claim 1, wherein the hydrogel comprises a framework comprising crosslinked polymeric chains that form a polymeric matrix, radiation-reflecting inorganic particles homogenously distributed in the polymeric matrix, and hydrogen bonds between the radiation-reflecting inorganic particles, and the polymeric matrix.

7. The method of claim 1, wherein step (i) is performed at a pH of 1 or lower.

8. The method of claim 1, wherein step (i) comprises:
(ia) preparing a mixture of inorganic acid and radiation-reflecting inorganic particles to form a dispersion;
(ib) mixing the dispersion with water-soluble polymer.

9. The method of claim 1, wherein step (iii) comprises freezing the mixture at a temperature of about −40° C. to about −20° C. for a duration of about 6 hours to about 12 hours; wherein step (iii) comprises thawing the mixture at a temperature of about 20° C. to about 30° C. for a duration of about 0.5 hours to about 3.5 hours.

10. (canceled)

11. The method of claim 1, wherein the molecular weight (MW) of the water-soluble polymer is about 70,000 to about 100,000 and/or at least about 97.5% to about 99.5% hydrolyzed; and/or wherein the water-soluble polymer is selected from the group consisting of poly(vinyl alcohol) (PVA), sodium alginate, gelatin, polyacrylic acid, chitosan, cellulose and polyacrylamide.

12. (canceled)

13. The method of claim 1, wherein the inorganic acid is selected from the group consisting of hydrochloric acid, chloric acid, sulfuric acid, phosphoric acid, and nitric acid.

14. The method of claim 1, wherein the crosslinking agent is selected from the group consisting of glutaraldehyde, calcium chloride (CaCl₂)), sodium triphosphate, N—N′-methylenebisacrylamide (C₇H₁₀N₂O₂), acetic acid, cucurbit[7]uril (C₄₂H₄₂N₂₈O₁₄), and combinations thereof.

15. The method of claim 1, wherein the radiation-reflecting inorganic particle is selected from the group consisting of barium sulfate, titanium dioxide, calcium carbonate, alumina, zirconia, calcium silicate, silicon dioxide, zinc oxide, zirconium silicate, zinc aluminate, magnesium hydroxide, aluminum hydroxide, zinc stannate, aluminum silicate, zinc silicate, calcium molybdate, magnesium carbonate, zinc carbonate, potassium titanate, sodium aluminum silicate, calcium phosphate, aluminum phosphate, zinc phosphate, magnesium phosphate, magnesium oxide, and combinations thereof; and/or wherein the radiation-reflecting inorganic particle has an average diameter of about 0.1 μm to about 1 μm.

16. (canceled)

17. A hydrogel obtained by the method of claim 1.

18. The hydrogel of claim 17, wherein the hydrogel comprises chemical and physical crosslinks.

19. The hydrogel of claim 17, wherein the hydrogel comprises a framework comprising crosslinked polymeric chains that form a polymeric matrix, radiation-reflecting inorganic particles homogenously distributed in the polymeric matrix, and hydrogen bonds between the radiation-reflecting inorganic particles, and the polymeric matrix.

20. The hydrogel of claim 17, wherein the hydrogel comprises about 20 wt % to about 50 wt % of water based on the total weight of hydrogel; or wherein the hydrogel comprises at least about 15 wt % to about 45 wt % of free water and intermediate water based on the total weight of the hydrogel.

21. (canceled)

22. The hydrogel of claim 17, wherein the hydrogel comprises pores with an average pore diameter of about 1 m to about 10 m, or wherein the hydrogel has a thickness of about 1 mm to about 20 mm.

23. (canceled)

24. The hydrogel of claim 17, wherein the hydrogel comprises PVA, glutaraldehyde, and barium sulfate.

25. A hydrogel precursor for forming a hydrogel comprising:
about 5 wt % to about 30 wt % of water-soluble polymer;
about 0.3 wt % to about 2.5 wt % of inorganic acid;
about 0.05 wt % to about 0.5 wt % of crosslinking agent; and
about 3 wt % to about 70 wt % of a radiation-reflecting inorganic particle,
wherein the wt % is based on the total weight of the hydrogel precursor.

26. The hydrogel precursor of claim 25, wherein the hydrogel precursor comprises:
about 5 wt % to about 25 wt % of water-soluble polymer;
about 0.3 wt % to about 1.2 wt % of inorganic acid;
about 0.05 wt % to about 0.25 wt % of crosslinking agent; and
about 30 wt % to about 70 wt % of a radiation-reflecting inorganic particle,
wherein the wt % is based on the total weight of the hydrogel precursor

27-43. (canceled)
